(19) United States
(12) Patent Application Publication
(10) Pub. No.: US 2018/0255779 A1
(43) Pub. Date: Sep. 13, 2018

(54) TRIAZOLE FORMULATIONS

(71) Applicant: Vive Crop Protection Inc., Mississauga (CA)

(72) Inventors: Fugang Li, Richmond Hill (CA); Hung Hoang Pham, Brampton (CA); Rachel Gong, Mississauga (CA); Darren J. Anderson, Toronto (CA)

(21) Appl. No.: 15/916,492

(22) Filed: Mar. 9, 2018

Related U.S. Application Data
(63) Continuation of application No. 14/765,129, filed on Jul. 31, 2015, now abandoned.
(60) Provisional application No. 61/763,127, filed on Feb. 11, 2013.
(60) Provisional application No. 61/758,914, filed on Jan. 31, 2013.

(51) Int. Cl. A01N 43/653; A01N 37/36; A01N 25/14; A01N 25/10

(52) U.S. Cl. CPC A01N 43/653; A01N 37/36; A01N 25/10; A01N 25/14

(57) ABSTRACT

The present disclosure describes a formulation including a nanoparticle including a polymer-associated triazole compound with an average diameter of between about 1 nm and about 500 nm; wherein the polymer is a polyelectrolyte, and a dispersant or a wetting agent. The disclosure describes various formulations and formulating agents that can be included in the formulations. Additionally, the disclosure describes application to various plants and fungi as well as advantages of the disclosed formulations.

### RELATED APPLICATIONS

This application is a continuation of U.S. patent application Ser. No. 14/765,129, filed Jul. 31, 2015, which is a U.S. National Stage Application filed under 35 U.S.C. § 371 based on International Patent Application No. PCT/IB2014/058719, filed Jan. 31, 2014, which claims priority to U.S. Provisional Patent Application No. 61/758,914 filed Jan. 31, 2013 and to U.S. Provisional Patent Application No. 61/763,127 filed on Feb. 11, 2013, the entire contents of each of which are hereby incorporated by reference.

### BACKGROUND

Triazole fungicides are used on a wide variety of plants in agriculture including field crops, fruit trees, small fruit, vegetables and turf. Triazoles are used against a variety of fungi, including but not limited to powdery mildews, rusts and leaf-spotting fungi. Exemplary fungicides include but are not limited to difenoconazole, fenbuconazole, myclobutanil, propiconazole, tebuconazole, tetraconazole, triticonazole and epiconazole.

Triazoles are believed to inhibit enzymes used in the production of cell membranes and cells walls. Their use results in abnormal fungi growth and death. Each triazole functions in a different part of the cell membrane/wall formation process; therefore, there is wide variability in the activity spectra amongst triazoles and target fungi.

Triazoles can be applied as a preventative fungicide and also as a curative fungicide. In curative treatments, the fungicide is traditionally best applied before spore formation as triazoles are not effective in inhibiting spore formation. Triazole pesticides exhibit some systemic activity (e.g., within a leaf) and this activity varies across the class of compounds. Some triazoles are systemic within local structures, and are not transported from one part of a plant to another, while other triazole compounds are more widely transported through the plant.

Triazoles are currently formulated into various usable forms such as emulsifiable concentrates (ECs), liquid concentrates (SL), and other forms that use petroleum or non-petroleum based solvents along with anionic or non-ionic emulsifiers and stabilizers to compensate for low water solubility, low soil motility and other drawbacks of triazoles based on their chemical properties. Furthermore, triazoles also vary in their photolytic stability under natural environmental conditions; therefore formulations often developed to compensate and reduce the susceptibility to chemical degradation before and after the formulation has been applied to a crop. There remains a need for improved formulations that reduce the dependence on additives and formulants, yet also prove as effective as current formulations.

Furthermore, because triazoles have a very specific mode of action, targeted fungi can become resistant. Different formulation techniques have therefore been developed in an attempt to address these deficiencies. An ideal formulation would have adequate loading of the active ingredient, be non-odorous, non-caking, non-foaming, stable under extreme conditions for extended periods of time, disperse rapidly upon addition to a spray tank, be compatible with a range of secondary additives and other agricultural products (fertilizer, pesticide, herbicide and other formulations) added to a spray tank, pourable or flowable, and, for solid formulations, be non-dusty (for solid formulations), and have sufficient/superior rainfast properties after application.

### SUMMARY OF THE INVENTION

The present disclosure provides formulations of triazole compounds including nanoparticles of polymer-associated triazole compounds with various formulating agents. The present disclosure also provides methods of producing and using these formulations.

In various embodiments, the present disclosure presents formulations including a nanoparticle including a polymer-associated triazole compound with an average diameter of between about 1 nm and about 500 nm; and the polymer is a polyelectrolyte and a dispersant or a wetting agent.

In some embodiments, the nanoparticle has a diameter of between about 1 nm and about 100 nm. In some embodiments, the nanoparticle has a diameter of between about 1 nm and about 20 nm.

In some embodiments, the formulation includes a plurality of nanoparticles, wherein the nanoparticles are in an aggregate and the aggregate has a diameter of between about 10 nm and about 5000 nm. In some embodiments, the formulation includes a plurality of nanoparticles, wherein the nanoparticles are in an aggregate and the aggregate has a diameter of between about 100 nm and about 2500 nm. In some embodiments, the formulation includes a plurality of nanoparticles, wherein the nanoparticles are in an aggregate and the aggregate has a diameter of between about 100 nm and about 1000 nm. In some embodiments, the formulation includes a plurality of nanoparticles, wherein the nanoparticles are in an aggregate and the aggregate has a diameter of between about 100 nm and about 300 nm.

In some embodiments, the ratio of triazole compound to polymer within the nanoparticles is between about 10:1 and about 1:10. In some embodiments, the ratio of triazole compound to polymer within the nanoparticles is between about 5:1 and about 1:5. In some embodiments, the ratio of triazole compound to polymer within the nanoparticles is between about 2:1 and about 1:2. In some embodiments, the ratio of triazole compound to polymer within the nanoparticles is about 1:3. In some embodiments, the ratio of triazole compound to polymer within the nanoparticles is about 3:2. In some embodiments, the ratio of triazole compound to polymer within the nanoparticles is about 4:1. In some embodiments, the ratio of triazole compound to polymer within the nanoparticles is about 2:1. In some embodiments, the ratio of triazole compound to polymer within the nanoparticles is about 1:1. In some embodiments, the triazole compound is difenoconazole.

In some embodiments, the polymer is selected from the group consisting of poly(methacrylic acid co-ethyl acrylate); poly(methacrylic acid-co-styrene); poly(methacrylic acid-co-butylmethacrylate); poly[acrylic acid-co-poly(ethylene glycol) methyl ether methacrylate]; poly(n-butylmethacrylcate-co-methacrylic acid) and poly(acrylic acid-co-styrene. In some embodiments, the polymer is a homopolymer. In some embodiments, the polymer is a copolymer. In some embodiments, the polymer is a random copolymer.

In some embodiments, the dispersant and/or wetting agent is selected from the group consisting of lignosulfonates, organosilicones, methylated or ethylated seed oils, ethoxylates, sulfonates, sulfates and combinations thereof. In some embodiments, the dispersant and/or wetting agent is sodium lignosulfonate. In some embodiments, the dispersant and/or wetting agent is a tristyrylphenol ethoxylate. In some embodiments, the wetting agent and the dispersant are the same compound. In some embodiments, the wetting agent and the dispersant are different compounds.

In some embodiments, the formulation excludes any wetting agent. In some embodiments, the formulation excludes any dispersant. In some embodiments, the wetting agent is less than about 30 weight % of the formulation. In some embodiments, the wetting agent is less than about 5 weight % of the formulation. In some embodiments, the dispersant is less than about 30 weight % of the formulation. In some embodiments, the dispersant is less than about 5 weight % of the formulation. In some embodiments, the formulation is in the form of a high solids liquid suspension or a suspension concentrate.

In some embodiments, the formulation includes between about 0.05 weight % and about 5 weight % of a thickener. In some embodiments, the thickener is less than about 1 weight % of the formulation. In some embodiments, the thickener is less than about 0.5 weight % of the formulation. In some embodiments, the thickener is less than about 0.1 weight % of the formulation. In some embodiments, the thickener is selected from the group consisting of guar gum; locust bean gum; xanthan gum; carrageenan; alginates; methyl cellulose; sodium carboxymethyl cellulose; hydroxyethyl cellulose; modified starches; polysaccharides and other modified polysaccharides; polyvinyl alcohol; glycerol alkyd, fumed silica and combinations thereof.

In some embodiments, the formulation includes between about 0.01 weight % and about 0.2 weight % of a preservative. In some embodiments, the preservative is less than about 0.1 weight % of the formulation. In some embodiments, the preservative is less than about 0.05 weight % of the formulation. In some embodiments, the preservative is selected from the group consisting of tocopherol, ascorbyl palmitate, propyl gallate, butylated hydroxyanisole (BHA), butylated hydroxytoluene (BHT), propionic acid and its sodium salt; sorbic acid and its sodium or potassium salts; benzoic acid and its sodium salt; p-hydroxy benzoic acid sodium salt; methyl p-hydroxy benzoate; 1,2-benzisothiazalin-3-one, and combinations thereof.

In some embodiments, the formulation includes between about 0.05 weight % and about 10 weight % of an anti-freezing agent. In some embodiments, the anti-freezing agent is less than about 5 weight % of the formulation. In some embodiments, the anti-freezing agent is less than about 1 weight % of the formulation. In some embodiments, the anti-freezing agent is selected from the group consisting of ethylene glycol; propylene glycol; urea and combinations thereof.

In some embodiments, the polymer-associated triazole compound is less than about 80 weight % of the formulation. In some embodiments, the polymer-associated triazole compound is between about 20 weight % and about 80 weight % of the formulation. In some embodiments, the polymer-associated triazole compound is between about 20 weight % and about 50 weight % of the formulation. In some embodiments, the polymer-associated triazole compound is between about 5 weight % and about 40 weight % of the formulation.

In some embodiments, the triazole compound is selected from the groups consisting of difenoconazole, fenbuconazole, myclobutanil, propiconazole, tebuconazole, tetraconazole, triticonazole and epiconazole.

In some embodiments, the formulation includes an inert filler. In some embodiments, the inert filler makes up less than about 90 weight % of the formulation. In some embodiments, the inert filler makes up less than about 40 weight % of the formulation. In some embodiments, the inert filler makes up less than about 5 weight % of the formulation. In some embodiments, the inert filler is selected from the group consisting of saccharides, celluloses, starches, carbohydrates, vegetable oils, protein inert fillers, polymers and combinations thereof.

In some embodiments, the formulation includes between about 1 weight % and about 20 weight % of a disintegrant. In some embodiments, the formulation includes between about 0.05 weight % and about 3 weight % of an anti-caking agent. In some embodiments, the anti-caking agent is less than about 1 weight % of the formulation. In some embodiments, the formulation includes between about 0.05 weight % and about 5 weight % of an anti-foaming agent. In some embodiments, the anti-foaming agent is less than about 1 weight % of the formulation.

In some embodiments, the formulation includes between about 1 weight % and about 20 weight % of a non-ionic surfactant. In some embodiments, the non-ionic surfactant is less than about 1 weight % of the formulation.

In some embodiments, the formulation is diluted so that the concentration of the polymer-associated triazole compound is between about 0.1 to about 1000 ppm. In some embodiments, the formulation is diluted so that the concentration of the polymer-associated triazole compound is between about 10 to about 500 ppm. In some embodiments, the formulation also includes a strobilurin fungicide.

In various aspects, the present disclosure describes a method of using any of the formulations described herein by applying the formulation to a plant. In some embodiments, the formulation is applied to one part of a plant and the triazole translocates to an unapplied part of the plant. In some embodiments, the unapplied part of the plant comprises new plant growth since the application.

In various aspects, the present disclosure describes a method of inoculating a plant with a triazole against fungi by applying any of the formulations described herein. In various aspects, the present disclosure provides a method of treating a fungal infection of a plant with a triazole by applying any of the formulations described herein, to the plant. In various aspects, the present disclosure describes a method of increasing a plant's fungus resistance by applying any of the formulations described herein, to the plant.

In some embodiments, the plant to which the formulation is applied is selected from the classes fabaceaae, brassicaceae, rosaceae, solanaceae, convolvulaceae, poaceae, amaranthaceae, laminaceae and apiaceae. In some embodiments, the plant to which the formulation is applied is selected from oil crops, cereals, pasture, turf, ornamentals, fruit, legume vegetables, bulb vegetables, cole crops, tobacco, soybeans, cotton, sweet corn, field corn, potatoes and greenhouse crops. In some embodiments, the fungi targeted is selected from the classes ascomycota, basidiomycota, deuteromycota, blastocladiomycota, chytridiomycota, glomeromycota and combinations thereof.

In various aspects, the present invention is a formulation including a nanoparticle comprising a polymer-associated triazole compound with an average diameter of between about 1 nm and about 500 nm; wherein the polymer is a polyelectrolyte, a taurate dispersant, a polycarboxylate salt wetting agent, an anti-foaming agent, a preservative, and water.

In some embodiments, the triazole compound constitutes between about 5 and about 30 percent by weight of the formulation. In some embodiments, the ratio of the weight percent of the triazole compound to the weight percent of the nanoparticles is between about 1:1 to 6:1. In some embodiments, the formulation also includes a thickener.

In some embodiments, the formulation also includes an anti-freeze agent. In some embodiments, the formulation also includes an olefin sulfonate salt surfactant. In some embodiments, the formulation also includes a block copolymer surfactant. In some embodiments, the formulation also includes an additional pesticidal compound. In some embodiments, the additional pesticidal compound is a fungicide. In some embodiments, the fungicide is a strobilurin. In some embodiments, the polyelectrolyte polymer is a poly(methacrylic acid-co-styrene) polymer.

In some embodiments, the taurate dispersant constitutes between about 0.5 weight percent and about 5 weight percent of the formulation. In some embodiments, the polycarboxylate salt wetting agent constitutes between about 0.5 weight percent and about 5 weight percent of the formulation. In some embodiments, the anti-foaming agent constitutes between about 0.1 weight percent and about 1 weight percent of the formulation. In some embodiments the preservative constitutes between about 0.01 weight percent and about 0.1 weight percent of the formulation. In some embodiments, the thickener constitutes between about 0.05 weight percent and about 2 weight percent of the formulation.

In some embodiments, the anti-freeze agent constitutes between about 1 weight percent and about 10 weight percent of the formulation. In some embodiments, the olefin sulfonate salt surfactant constitutes between about 0.5 weight percent and about 5 weight percent of the formulation. In some embodiments, the block copolymer surfactant constitutes between about 0.5 weight percent and about 5 weight percent of the formulation. In some embodiments, the additional pesticide constitutes between about 5 weight percent and about 30 weight percent of the formulation.

### BRIEF DESCRIPTION OF THE DRAWINGS

FIG. 1 is a graph illustrating the percent of disease controlled on a disease incidence basis over the course of several applications for two fungicide formulations, Inspire™, a commercially available formulation, and a nanoparticle formulation as described in Example 1. The disease is Black Spot on cabbages as described in Example 3 and the disease control figures are over the course of second and third applications of the formulations.

FIG. 2 is a graph illustrating the percent of disease controlled (based on disease incidence) over the course of two applications of two different fungicide formulations, a commercially available formulation and a formulation as described below in Example 1. Rates of control were averaged for three different application rates. The disease is powdery mildew (pathogen: Golovinomyces cichoracearu) on cantaloupe plants, as described in Example 4.

FIG. 3 is a graph illustrating percent of disease controlled (based on disease incidence) for different application rates of two fungicide formulations at different application rates of active ingredient 18 days after a third treatment. The disease, crop treated and application protocol are all described in Example 4.

FIG. 4 is a graph illustrating the percent of disease (based on disease severity) controlled 14 days after application of two different fungicide formulations, a commercially available formulation and a formulation as described below in Example 1. Three different application rates for each formulation were evaluated. The disease is powdery mildew (pathogen: Podosphaera xanthii) on squash plants, as also described in Example 4.

FIG. 5A and FIG. 5B illustrate rates of disease control, based on disease incidence and severity, respectively, for treatment of powdery mildew on squash plants as described in Example 4. Evaluations in these figures were performed 12 days after a second application.

FIG. 6 illustrate rates of disease control for two different formulations at various application rates and with an additional non-ionic surfactant added in dilution step. The disease is Peanut Leaf Spot on peanut plant as described in Example 5.

FIG. 7 is a graph illustrating expected yield of peanut plants infected with Peanut Leaf Spot for various treatments.

FIG. 8 is a graph illustrating percent of disease controlled (based on disease incidence) for different application rates of two fungicide formulations (Inspire™ and the formulation described in Example 1) at different application rates of active ingredient 14 days after treatment. The disease was Frog-Eye Leaf Spot on soybean plants as described in Example 6.

FIG. 9 is a graph illustrating different yields based on different treatments of soybean plants infected with Frog-Eye Leaf Spot as described in Example 6.

FIG. 10 is a graph illustrating percent of disease controlled (based on disease severity) for different application rates of two fungicide formulations (Inspire™ and the formulation described in Example 1) at different application rates of active ingredient 6 days after treatment. The disease was Early Blight on tomato plants as described in Example 7.

FIG. 11 is a graph illustrating percent of disease controlled (based on disease severity) for different application rates (averaged together) of two fungicide formulations (Inspire™ and the formulation described in Example 2) at different points in a treatment regime. The disease was powdery mildew on zucchini plants as described in Example 8.

FIG. 12 is a graph illustrating percent of disease controlled (based on disease severity) for different application rates (averaged together) of two fungicide formulations (Inspire™ and the formulation described in Example 2) at different points in a treatment regimen. The disease was powdery mildew on zucchini as described in Example 8.

FIG. 13 is a graph illustrating disease index at various time points during a treatment regimen for three different fungicide formulations applied to the plants (bananas) at a rate of 667 ppm (a commercial emulsifiable concentrate (labelled “Syngenta EC”)), the formulation described in Example 2 (“VCP-05”), and a proprietary oil-in-water formulation (“Hainan Zheng Ye EW”)) at different points in a treatment regimen. The disease was Sigatoka Leaf Spot on banana plants. The treatment program and evaluation methods are described in Example 9.

FIG. 14 is a graph illustrating percent of disease controlled (based on disease index shown in FIG. 13) for different application rates (250 ppm, 417 ppm and 667 ppm) of the three fungicide formulations described above in FIG. 13 upon completion of the treatment program. The disease, crop treated, treatment program, and evaluation methods are all described in Example 9.

FIG. 15 is a graph illustrating percent of disease level for two different difenoconazole formulations (Inspire™, and a formulation prepared according to Example 2). Disease level for an untreated control is also shown on FIG. 15. Disease level for each formulation was averaged between two different application rates (75 g active ingredient/ha and 125 g active ingredient/ha). Full details of the field test are described in Example 10.

FIG. 16 is a graph illustrating percent of disease level for two different fungicide formulations (Muscle™, a commercially available emulsifiable concentrate of tebuconazole, and a formulation prepared according to Example 2). The difenoconazole formulation of Example 2 was applied at two different application rates (75 g a.i./ha and 125 g a.i./ha). Full details of the field test are described in Example 10.

FIG. 17 shows peanut yield rates for an entire growing season in which test plots were treated with various fungicides (e.g, difenoconazole (VCP-05), chlorothalonil (Echo™), chlorothalonil mixed with prothioconazole (Echo™/Provost™)) and different tank-mix, non-ionic surfactants (Silwet™ L-77 & Induce™). Field test methods are described in Example 10.

FIG. 18 is a graph showing disease level (measured by percent of row feet of crop infected) for two difenoconazole formulations a various application rates and, in the case of the VCP-05 formulation, with different tank-mixed non-ionic-surfactants. The disease targeted was white mold on peanuts and the field trial is described in Example 11.

FIG. 19 shows a graph of peanut yield rates for an entire growing season in which test plots were treated with various fungicides (e.g, difenoconazole (VCP-05), chlorothalonil (Bravo™), chlorothalonil mixed with prothioconazole (Bravo™/Provost™)) and different tank-mix, non-ionic surfactants (Silwet™ L-77 & Induce™). Field test methods are described in Example 11.

FIG. 20 is a graph showing disease control rates for a difenoconazole formulation, VCP-05, applied to treat dollar spot on creeping bentgrass. The disease control rates for three different application rates (0.25, 0.5 and 1.0 fluid oz. of formulation per 1000 ft² treated area). Field test procedures and evaluation methods are described in Example 12.

FIG. 21 is a graph showing disease control rates for two difenoconazole/azoxystrobin mixture formulations. The first mixture was VCP-05 was mixed with Heritage™, a commercially available azoxystrobin formulation. The second mixture was Briskway™, a commercially available formulation containing difenoconazole and azoxystrobin. The formulations were applied to treat dollar spot on creeping bentgrass. Field test procedures and evaluation methods are described in Example 13.

FIG. 22 is a graph showing disease control rates for a difenoconazole formulation, VCP-05, applied to treat anthracnose on annual bluegrass. The disease control rates for three different application rates (0.25, 0.5 and 1.0 fluid oz. of formulation per 1000 ft² treated area). Field test procedures and evaluation methods are described in Example 14.

### DEFINITIONS

As used herein, the term “inoculation” refers to a method used to administer or apply a formulation of the present disclosure to a target area of a plant or fungus. The inoculation method can be, but is not limited to, aerosol spray, pressure spray, direct watering, and dipping. Target areas of a plant could include, but are not limited to, the leaves, roots, stems, buds, flowers, fruit, and seed. Target areas of the fungus could include, but are not limited to, the hyphae and mycelium, inoculating reproductive spores (conidia or ascospores) and the haustoria. Inoculation can include a method wherein a plant is treated in one area (e.g., the root zone or foliage) and another area of the plant becomes protected (e.g., foliage when applied in the root zone or new growth when applied to foliage). Inoculation can also include a method wherein a plant is treated in one area (e.g., the foliar surface) and fungal infection in the interior of the plant is cured.

As used herein, the term “wettable granule” also referred to herein as “WG”, and “soluble granule” refers to a solid granular formulation that is prepared by a granulation process and that contains nanoparticles of polymer-associated active ingredient, (includes potentially aggregates of the same), a wetting agent and/or a dispersant, and optionally an inert filler. Wettable granules can be stored as a formulation, and can be provided to the market and/or end user without further processing. In some embodiments, they can be placed in a water-soluble bag for ease of use by the end user. In most practical applications, wettable granules are prepared for application by the end user. The wettable granules are mixed with water in the end user's spray tank to the proper dilution for the particular application. Dilution can vary by crop, fungus, time of year, geography, local regulations, and intensity of infestation among other factors. Once properly diluted, the solution can be applied by e.g., spraying.

As used herein, the term “wettable powder” also referred to herein as “WP”, “water dispersible powder” and “soluble powder”, refers to a solid powdered formulation that contains nanoparticles of polymer-associated active ingredient (includes potentially aggregates of the same), and optionally one or more of a dispersant, a wetting agent, and an inert filler. Wettable powders can be stored as a formulation, and can be provided to the market and/or end user without further processing. In some embodiments, they can be placed in a water-soluble bag for ease of use by the end user. In practical applications, a wettable powder is prepared for application by the end user. The wettable powder is mixed with water in the end user's spray tank to the proper dilution for the particular application. Dilution can vary by crop, fungus, time of year, geography, local regulations, and intensity of infestation among other factors. Once properly diluted, the solution can be applied by e.g., spraying.

As used herein, the term “high solids liquid suspension” also referred to herein as “HSLS” refers to a liquid formulation, similar to a suspension concentrate, that contains nanoparticles of polymer nanoparticles associated with active ingredient (includes potentially aggregates of the same), a wetting agent and/or a dispersant, an anti-freezing agent, optionally an anti-settling agent or thickener, optionally a preservative, and water. High solids liquid suspensions can be stored as a formulation, and can be provided to the market and/or end user without further processing. In most practical applications, high solids liquid suspensions are prepared for application by the end user. The high solids liquid suspensions are mixed with water in the end user's spray tank to the proper dilution for the particular application. Dilution can vary by crop, fungus, time of year, geography, local regulations, and intensity of infestation among other factors. Once properly diluted, the solution can be applied by e.g., spraying.

Description of Various Embodiments of the Invention

Triazoles represent a very important class of fungicide globally. Triazoles are used in agriculture to protect crops such as cereals, field crops, fruits, tree nuts, vegetables, turfgrass and ornamentals because of their broad spectrum activity as well as (to varying degrees) their activity against all three major groups of plant pathogenic fungi: Ascomycetes, Basidiomycetes, and Deuteromycetes. Triazoles also have found use outside agricultural applications, such as human and veterinary antifungal formulations.

### Solubility

Triazoles as a class are typically poorly soluble in water, generally with solubilities in the parts per million range, or lower. Triazole solubilities are generally higher in organic solvents (e.g., hexane, ethanol, dichloromethane). See Table 1 below for a list of typical triazoles, their solubilities in several solvents, octanol-water partition coefficients and their melting points. (Data via the Pesticide Properties Database)

TABLE 1
Solubility of exemplary triazoles in common solvents,
octanol-water partition coefficients and melting points

| | | | Melting |
|---|---|---|---|
| Triazole | Solubility mg/L (solvent & conditions) | Kow | Point (° C.) |
| Difenoconazole | 15.0 mg/L (water at 20° C.) | log P: 4.36 | 82.5 |
| | 3400 mg/L (hexane at 20° C.) | | |
| | 330000 mg/L (ethanol at 20° C.) | | |
| Epoxiconazole | 7.1 mg/L (water at 20° C.) | log P: 3.3 | 136.7 |
| | 28800 mg/L (ethanol at 20° C.) | | |
| Tebuconazole | 36 mg/L (water at 20° C.) | log P: 3.7 | 105 |
| | 80 mg/L (hexane at 20° C.) | | (decomposes |
| | 2000000 mg/L (dichloromethane at 20° C.) | | at 350) |
| Triticonazole | 9.3 mg/L (water at 20° C.) | log P: 3.29 | 137 |
| | 120 mg/L (hexane at 20° C.) | | |
| | 18200 mg/L (methanol at 20° C.) | | |
| Propiconazole | 150 mg/L (water at 20° C.) | log P: 3.72 | −23 |
| | 1585 mg/L (heptane at 20° C.) | | (decomposes |
| | | | at 355) |
| Myclobutanil | 132 mg/L (water at 20° C.) | log P: 2.89 | 70.9 |
| | 1020 mg/L (heptane at 20° C.) | | |
| | 250000 mg/L (methanol and acetone, both at 20° C.) | | |
| Cyproconazole | 93 mg/L (water at 20° C.) | log P: 3.09 | 106.5 |
| | 1300 mg/L (hexane at 20° C.) | | |
| Tetrazonazole | 156.6 mg/L (water at 20° C.) | log P: 3.56 | −29.2 |
| | 300000 mg/L (xylene, acetone, ethyl acetate, all | | (degrades at |
| | at ° C.) | | 235) |

Improvements in triazole solubility are desirable in order to improve formulation processes, simplify formulations, reduce the environmental consequences in fungicide application and improve fungicide efficacy.

### Photolysis/Stability

Triazoles vary in their degradation rates upon exposure to sunlight and demonstrate a range of half-lives as listed in Table 2.

TABLE 2
Photolytic stability of some Triazoles

| Triazole | Photolytic Stability |
|---|---|
| Difenoconazole | Stable at pH 7 |
| Epoxiconazole | DT50: 52 d (aqueous photolysis at pH 7) |
| Tebuconazole | Stable, no significant photolytic degradation |
| Triticonazole | DT50: 3.1 d (aqueous photolysis at pH 7) |
| Propiconazole | Stable at pH 7 |
| Myclobutanil | DT50: 15 d (aqueous photolysis at pH 7) |
| Cyproconazole | DT 50: 40 d (aqueous photolysis at pH 7) |
| Tetraconazole | DT50: 217 d (stable at pH 7) |

Due to the tendency of some triazoles to degrade upon exposure to sunlight, some crop protection formulations of triazoles employ a UV blocker such as zinc, tin or iron oxides as well as organic UV blockers (e.g., 1,2-dihydroxybenzophenone). The use of UV-blockers in formulation can present additional complications in formulating, application and use. For example, the UV-blocker is an additional component that needs to be soluble or at least dispersible in the media or matrix of the product. It is therefore desirable to produce formulations that do not require a UV-blocker.

### Fungicide Resistance

Triazoles are site specific fungicides and inhibit one specific enzyme, C14-demethylase, which participates in sterol synthesis. Sterols, (e.g., ergosterol in fungi) are part of cell walls and necessary for membrane structure and formation. Each triazole may vary in its action within the sterol-production pathway; however, the results are generally similar: abnormal fungal growth and death as a result of cell membrane deformities. Because the mode of action of triazole is highly specific, i.e., it targets only a single pathway in the fungus, there are instances where mutations can occur in certain fungal species that can make them resistant to triazoles, especially in fungi that reproduce rapidly such as rusts. If such a resistant strain occurs, repeated application of the triazole can lead to a buildup of a triazole-resistant subpopulation in an entire crop/plantation. There are two types of fungicide resistance: quantitative and qualitative. Quantitatively resistant pathogens are less sensitive to the fungicide compared to the wild type, but can still be controlled with a higher use rate and/or more frequent applications. On the other hand, qualitatively resistant strains are insensitive/unresponsive to the fungicide and can no longer be controlled at labeled field rates. To slow the rate of proliferation of resistant strains, it is useful to limit the consecutive applications of triazole fungicides to the earlier stages of fungal infection as well as applying a second type of fungicide that possesses another mode of action. It is therefore useful to provide triazole formulations that can easily be mixed with another type of fungicide (e.g., a strobilurin) that has a different mode of action to help reduce the risk of resistant strains. In addition, improved formulations that are more effective at lower rates, show longer-lasting activity, or can be applied less frequently due to improvements in systemic activity as well as decreasing the potential for the development of fungicide resistance.

### Plant Uptake and Weak Systemic Effect

Fungicides can either be contact, translaminar or systemic. Contact fungicides are not taken up into the plant tissue, and only protect the plant where the spray is deposited. Translaminar fungicides redistribute the fungicide from the upper, sprayed leaf surface to the lower, unsprayed surface of the same leaf. Systemic fungicides are taken up and redistributed through the xylem vessels to the upper parts of the plant. Systemic activity is necessary to provide curative performance for a fungicide. Further, some triazoles are somewhat translaminar (spreading through individual leaves) and to a certain extent, weakly systemic (e.g., curative) fungicides. Because of these traits Triazoles are known to have primary curative activity, but are disfavored in preventative application.

When the triazole is applied to the plant, most of the active ingredient is initially held on or within the plant surface. If the triazole is showing weak systemic activity, this is because the active ingredient penetrates into the underlying plant cells (translaminar movement) and also moves to local zones above the point of uptake (local systemization via the xylem in the leaf). The uptake of the triazole into the cells of the leaf following application is dependent on several factors: the formulation type, active ingredient particle size, the additives/adjuvants used in the formulation, the other active ingredients mixed in or with the formulation, the target crop (leaf type, surface, weathering and plant age) and environmental factors that influence the drying of the spray droplet.

Lack of, or low system effect can be problematic, as it means that any plant tissue that needs to be protected by the triazole formulation needs to be efficiently covered during the application process (typically spray). Unfortunately, aerial spray or foliar spray is often non-uniform and does not lead to complete coverage of the exterior of the plant (e.g., see Henriet and Baur, Bayer CropScience Journal 62(2):243, 2009). In addition, as plants grow they develop new foliar tissue that was not treated with the triazole and hence will not be protected from fungal infection until the next application. The degree of systemic activity can be demonstrated by evaluating the performance of the triazole for curative activity; improvements in curative activity can be correlated with improvements in systemization.

If a triazole could be made more systemic through improvements in formulation it would dramatically improve the impact of triazoles on target crops because of the potentially reduced application rates and enhanced efficacy (e.g., increase yields) of such formulations.

### Plant Health and Hidden Disease

Growers strive to obtain high yielding and high quality plants and crops. Toward this goal, agricultural strategies are utilized to maintain, optimize, and enhance plant health from the time of planting through to harvest. As a descriptive term, plant health refers to the overall condition of a plant, including its size, sturdiness, optimum maturity, consistency in growth pattern and reproductive activity. Growers often also define plant health in terms of measureable outputs, such as enhanced crop yield and economic return on production input.

As the effective control of fungal disease is of central importance in improving and optimizing plant health and crop yield, triazole fungicides are often applied as part of regimes directed towards achieving these results. Plant health applications of triazoles may include curative inoculations to control disease, inoculations for the purpose of combating hidden disease, inoculations under conditions that are favorable for the development of disease (e.g., favorable weather conditions), insurance applications, and other applications to improve crop yield and quality. Furthermore, environmental conditions are closely and constantly monitored by growers, and upon tending towards circumstances that are favorable for fungal infections, triazole applications are performed.

Of central importance to the improvement of plant health via the application of triazole fungicides is combating hidden or undiagnosed disease. Growers have implicated hidden diseases (i.e., cases in which the crop has below detection limit or non-obvious fungal infection) in reduced and variable crop yields. In response, triazole fungicides are often used in plant health applications such as insurance applications (e.g., applications that are made regardless of disease pressure), particularly on high potential crops frequently mixed with another fungicide with a different mode of action. In many cases these have been found to reverse or dampen the effects of hidden disease on crops and improve yield.

There are, however, persistent challenges related to the use of triazoles in improving plant health by combating hidden disease, the most problematic of which are related to correct timing of application and low or insufficient levels of curative activity. For example, prior to early triazole applications (e.g., the first application of the season), there is often a level of latent infection or hidden disease in the crop. In such cases, commercial formulations that demonstrate preventative activity but that suffer from low or less than adequate levels of curative activity would be ineffective at improving plant health by combating hidden disease and even fungicides with curative properties could be made more efficient. To compensate in part for their low or inefficient curative activity, commercial formulations are sometimes applied at increased rates. Furthermore, plant physiology and pathology are extremely complex, and there remain unanswered questions surrounding the optimal time points for application of fungicides to improve plant health and risks of fungicide resistance by combating hidden disease.

Related to the complexity of plant physiology and influencing plant health is the fact that triazoles can function as plant growth regulators. Briefly, plant growth regulators are man-made chemical compounds that effect the growth and development of plants in some way. Naturally synthesized compound, either from the plant itself or from another source within the plant's environment (e.g., bacteria) are typically called plant hormones. Plant growth regulators can manifest themselves in a wide variety of ways within a plant as the plant grows. Some of the effects can be beneficial or detrimental to the plant from a plant health perspective and the same triazole compound may produce a mix of beneficial and detrimental effects in a given plant. For example, some plant growth regulators reduce the size and weight of stems and leaves of a plant. Some other plant growth regulators produce higher cell density in a plant's leaves, or increased resistance to stress conditions (e.g., drought, chilling). The specific results and effects of a plant growth regulator depend on many factors including the particular regulator, the particular plant, the environmental conditions and the time of application.

Triazoles are known to act as plant growth regulators, in addition to their fungicidal uses. Various plant growth effects from triazoles have been described including increased cell density, increased chlorophyll density, increased leaf thickness and vibrancy, among other effects. Some triazoles have been shown to stunt the growth of some plants either stem and leaf length or weight. Primarily triazoles as plant growth regulators disrupt the gibberellin pathways. Because triazoles provide the additional benefits beyond fungicide applications they can have a more pronounced effect on overall plant health, as shown by increased yields. Triazoles' role as plant growth regulators can help combat hidden disease, stunt the growth of pest/competing plants, and trigger various biological effects within the plant to improve overall plant health in a variety of growth conditions. Improved triazole formulation can lead to enhanced plant growth regulator effects as well. Triazole formulations with improved water solubility, improved systemic effect or greater residual activity can have great regulator effects, leading to improved plant health. Improved plant health, in turn, can lead to higher product yields.

It would thus be desirable to develop triazole formulations that provide increased levels of curative activity for plant health applications, including the treatment of latent and hidden fungal disease. For example, it would be useful to produce triazole formulations that have increased levels of curative activity by imparting greater systemic properties to a triazole or improving the systemic properties of the fungicide. Such formulations would be more effective in plant health applications and could therefore be used at lower effective dose rates than currently available commercial formulations. Furthermore, it would be useful to provide triazole formulations that could in part mitigate the difficulties associated with correct timing of fungicide applications directed to improving plant health. For example, formulations that display enhanced residual activity would increase the window of opportunity for successful application timing. Lastly, it would be useful to provide triazole formulations that could improve plant health by having a plant growth regulator effect. Plant yields can be further improved by providing a formulation that could provide a number of the functions described above (e.g., improved translaminar activity, improved plant growth regulator effect, improved residual activity).

### Formulations—Generally

Several synthetic triazoles (including difenoconazole, fenbuconazole, myclobutanil, propiconazole, tebuconazole, tetraconazole, triticonazole and epiconazole) formulations are now available commercially, the bulk of which are used in agricultural applications. Despite a common mode of action, triazoles exhibit definite practical differences, e.g., different mobility in the plant.

The aforementioned limitations of triazoles, and their formulations, when used as fungicides manifest themselves in (a) how they are currently applied to plants and (b) how they are formulated by manufacturers. As an example, because triazoles are susceptible to degradation (either from photolysis or exposure of field conditions) end users (e.g., farmers or golf course maintenance managers) need to apply triazoles more often than if they were longer lasting. As another example, because some triazoles lack systemic activity, or have limited system activity (which would help protect new growth of crops), end users need to continually re-apply triazoles in order to protect crops from fungal infection. Furthermore, because of the inherent threat of forming triazole resistant strains, end users need triazole formulations that that can be easily mixed with other types of formulated fungicides as well as formulations that have improved residual activity (i.e., would need less applications). These limitations are compounded by increasing pressure on end users who are faced with increasing regulatory and consumer pressure to use fewer pesticides and/or fungicides and in lower quantities.

In order to address these limitations, a variety of complicated formulation techniques and formulation agents have been developed to counter to the UV instability, water insolubility, non-systemic nature, and other limitations of triazoles.

In order for a triazole to be efficiently applied to a plant or fungus, the triazole product needs to be dispersible in water. Two common formulation techniques to do this are to produce either an emulsifiable concentrate (EC) or a suspension concentrate (SC). An EC is a formulation where the active ingredient is dissolved in a suitable solvent in the presence of surfactants. When the EC is dispersed into the spray tank and agitated, the surfactants emulsify the solvent into water, and the active ingredient is delivered in the solvent phase to the plant or fungus. ECs frequently do not require, or are incompatible with, the addition of surfactant in the spray tank. Because ECs contain solvent and significant amounts of surfactant in the formulation, additional surfactant increases the formulations' phytotoxicity. Even without the increased danger to the plant itself, the formulation would not like exhibit an improvement in agrochemical performance.

A SC is a high-solids concentrate in water. The active ingredient is milled into particles that are 1-10 microns (Alan Knowles, Agrow Reports: New Developments in Crop Protection Product Formulation. London: Agrow Reports May 2005). These solid particles are then dispersed into water at high concentration using surfactants. After adding the SC into the spray tank, the surfactant-stabilized particles disperse into water and are applied (still as solid particles) to the leaf surface. Other common formulation techniques used for some crop protection active ingredients include microencapsulations (CS) and emulsions (EW or OW). Solid formulation techniques that are currently used include water-dispersible granules (WG) or powders (WP), where the active ingredient is absorbed to a dispersible carrier that is provided dry to the farmer. When mixed into the spray tank, the carrier disperses into the water, carrying the active ingredient with it. Particle sizes for these carriers can be anywhere in the range of 1-10 microns (Alan Knowles, Agrow Reports: New Developments in Crop Protection Product Formulation. London: Agrow Reports May 2005).

As an alternative to these approaches, we have developed new classes triazole formulations. As demonstrated in the Examples and as discussed below, in some embodiments these new triazole formulations are more dispersible in water and have enhanced stability (i.e., longer lasting). In some embodiments, these new triazole formulations have increased curative (systemic) and preventative performance as compared to existing formulations. Further, the new formulations are also compatible with other agricultural products (surfactants, leaf wetters, fertilizers, etc.), and are stable in non-ideal solution conditions such high salt, extreme pH, hard water, elevated temperatures, etc. These enhancements/improvements in the formulation can also help address the resistance of some fungi by being (1) compatible with a second fungicide, either tank-mixed or pre-mixed in the original formulation and (2) requiring less fungicide in each application as well as improved efficacy and reduced application rates. In general, these new triazole formulations comprise nanoparticles (optionally in aggregate form) of polymer-associated triazoles along with various formulating agents.

Additionally, because the instant formulations are based around nanoparticles of polymer-associated active ingredients, they are stable to relatively high salt conditions. Stability in high salt conditions is required especially when the formulation is to be mixed with other secondary agricultural products such as a concentrated fertilizer mix, exposed to high salt conditions (e.g., used in or with hard waters) mixed with other formulations (other pesticides, fungicides, and herbicides) or mixed with other tank-mix adjuvants. The ability to mix our formulations with other products can be beneficial to the end user because simultaneous agricultural products can be applied in a single application.

### Formulations—Components

In various aspects, the present disclosure provides formulations that comprise nanoparticles (optionally in aggregate form) of polymer-associated active ingredient along with various formulating agents.

### Active Ingredient

As used herein, the term “active ingredient” (“ai”, “AI”, “a.i.”, “A.I.”) refers to triazole compounds (i.e., triazoles). Structurally, the basic common feature in this family is the presence of triazole heterocyclic structure. Many triazoles include a triazole group:

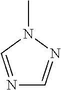

Often, though not always, in conjunction with a halogen substituted phenyl group. For example, difenoconazole, which structure is shown below, includes both groups.

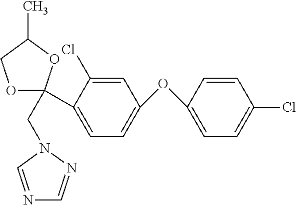 [SMILES: CC1COC(Cn2cncn2)(c2ccc(Oc3ccc(Cl)cc3)cc2Cl)O1]

Non-limiting examples of triazole fungicides include azaconazole (1-{[2-(2,4-dichlorophenyl)-1,3-dioxolan-2-yl]methyl}-1H-1,2,4-triazole), Bromuconazole (1-[(2RS,4RS;2RS,4SR)-4-bromo-2-(2,4-dichlorophenyl)tetrahydrofurfuryl]-1H-1,2,4-triazole), cyproconazole ((2RS,3RS;2RS,3SR)-2-(4-chlorophenyl)-3-cyclopropyl-1-(1H-1,2,4-triazol-1-yl)butan-2-ol), diclobutrazol ((2RS,3RS)-1-(2,4-dichlorophenyl)-4,4-dimethyl-2-(1H-1,2,4-triazol-1-yl)pentan-3-ol), difenoconazole (3-chloro-4-[(2RS,4RS;2RS,4SR)-4-methyl-2-(1H-1,2,4-triazol-1-ylmethyl)-1,3-dioxolan-2-yl]phenyl 4-chlorophenyl ether), diniconazole ((E)-(RS)-1-(2,4-dichlorophenyl)-4,4-dimethyl-2-(1H-1,2,4-triazol-1-yl)pent-1-en-3-ol), epoxiconazole ((2RS,3SR)-1-[3-(2-chlorophenyl)-2,3-epoxy-2-(4-fluorophenyl)propyl]-1H-1,2,4-triazole), etaconazole (1-[(2RS,4RS;2RS,4SR)-2-(2,4-dichlorophenyl)-4-ethyl-1,3-dioxolan-2-ylmethyl]-1H-1,2,4-triazole), fenbuconazole ((RS)-4-(4-chlorophenyl)-2-phenyl-2-(1H-1,2,4-triazol-1-ylmethyl)butyronitrile), fluquinconazole (3-(2,4-dichlorophenyl)-6-fluoro-2-(1H-1,2,4-triazol-1-yl)quinazolin-4(3H)-one), flusilazole (bis(4-fluorophenyl)(methyl)(1H-1,2,4-triazol-1-ylmethyl)silane or 1-{[bis(4-fluorophenyl)(methyl)silyl]methyl}-1H-1,2,4-triazole), flutriafol ((RS)-2,4′-difluoro-α-(1H-1,2,4-triazol-1-ylmethyl)benzhydryl alcohol), furconazole ((2RS,5RS;2RS,5SR)-5-(2,4-dichlorophenyl)tetrahydro-5-(1H-1,2,4-triazol-1-ylmethyl)-2-furyl 2,2,2-trifluoroethyl ether), hexaconazole ((RS)-2-(2,4-dichlorophenyl)-1-(1H-1,2,4-triazol-1-yl)hexan-2-ol), imibenconazole (4-chlorobenzyl (EZ)-N-(2,4-dichlorophenyI)-2-(1H-1,2,4-triazol-1-yl)thioacetamidate), ipconazole ((1RS,2SR,5RS;1RS,2SR,5SR)-2-(4-chlorobenzyl)-5-isopropyl-1-(1H-1,2,4-triazol-1-ylmethyl)cyclopentanol), metconazole ((1RS,5RS;1RS,5SR)-5-(4-chlorobenzyl)-2,2-dimethyl-1-(1H-1,2,4-triazol-1-ylmethyl)cyclopentanol), myclobutanil ((RS)-2-(4-chlorophenyl)-2-(1H-1,2,4-triazol-1-ylmethyl)hexanenitrile), penconazole ((RS)-1-[2-(2,4-dichlorophenyl)pentyl]-1H-1,2,4-triazole), propiconazole ((2RS,4RS;2RS,4SR)-1-[2-(2,4-dichlorophenyl)-4-propyl-1,3-dioxolan-2-ylmethyl]-1H-1,2,4-triazole), prothioconazole ((RS)-2-[2-(1-chlorocyclopropyl)-3-(2-chlorophenyl)-2-hydroxypropyl]-2,4-dihydro-1,2,4-triazole-3-thione), quinconazole (3-(2,4-dichlorophenyl)-2-(1H-1,2,4-triazol-1-yl)-quinazolin-4(3H)-one), simeconazole ((RS)-2-(4-fluorophenyl)-1-(1H-1,2,4-triazol-1-yl)-3-(trimethylsilyl)propan-2-ol), tebuconazole ((RS)-1-p-chlorophenyl-4,4-dimethyl-3-(1H-1,2,4-triazol-1-ylmethyl)pentan-3-ol), tetraconazole ((RS)-2-(2,4-dichlorophenyl)-3-(1H-1,2,4-triazol-1-yl)propyl 1,1,2,2-tetrafluoroethyl ether), triadimenfon ((RS)-1-(4-chlorophenoxy)-3,3-dimethyl-1-(1H-1,2,4-triazol-1-yl)butan-2-one), triadimenol ((1RS,2RS;1RS,2SR)-1-(4-chlorophenoxy)-3,3-dimethyl-1-(1H-1,2,4-triazol-1-yl)butan-2-ol), triticonazole ((RS)-(E)-5-(4-chlorobenzylidene)-2,2-dimethyl-1-(1H-1,2,4-triazol-1-ylmethyl)cyclopentanol), uniconazole ((E)-(RS)-1-(4-chlorophenyl)-4,4-dimethyl-2-(1H-1,2,4-triazol-1-yl)pent-1-en-3-ol).

In some embodiments, triazole formulations are applied in combination with one or more other pesticides (e.g., insecticides, herbicides, fungicides). For example, the triazole formulations can be applied with other fungicides with a different mode of action as compared to the triazole (e.g., strobilurin). Such mixed applications are typically used to mitigate the potential development of fungicide resistance to a particular fungicide in the targeted fungi. Exemplary strobilurins include, but are not limited to, azoxystrobin, picoxystrobin, pyraclostrobin, orysastrobin, metominostrobin and trifloxystrobin. The second fungicide may be a completely separate formulation, mixed with a triazole formulation by the grower in the application tank. In some embodiments, the triazole and second fungicide (e.g., a triazole) are mixed together in a single formulation, which is applied (or diluted and applied) by a user.

For example, the additional pesticide (e.g., fungicide) can make up between about 0.5 and about 20 weight %, about 0.5 and about 10 weight %, between about 0.5 and about 5 weight %, between about 0.5 and about 3 weight %, between about 1 and about 30 weight %, between about 1 and about 20 weight %, between about 1 and about 10 weight %, between about 1 and about 5 weight %, between about 2 and about 30 weight %, between about 2 and about 20 weight %, between about 2 and about 10 weight %, between about 2 and about 5 weight %, between about 3 and about 30 weight %, between about 3 and about 20 weight %, between about 3 and about 10 weight %, between about 3 and about 5 weight %, between about 5 and about 30 weight %, between about 5 and about 20 weight %, between about 5 and about 10 weight % of the formulation. In some embodiments, the additional pesticide (e.g., fungicide) can make up between about 0.1 and 1 weight % of the formulation, between about 0.1 and 2 weight % of the formulation between about 0.1 and 3 weight % of the formulation between about 0.1 and 5 weight % of the formulation, between about 0.1 and 10 weight % of the formulation.

### Nanoparticles of Polymer-Associated Active Ingredient

As used herein, the terms “nanoparticles of polymer-associated active ingredient”, “nanoparticles of polymer-associated triazole compound” or “active ingredient associated with polymer nanoparticles” refer to nanoparticles comprising one or more collapsed polymers that are associated with the active ingredient. In some embodiments the collapsed polymers are cross-linked. As discussed below, in some embodiments, our formulations may include aggregates of nanoparticles. Exemplary polymers and methods of preparing nanoparticles of polymer-associated active ingredient are described more fully below.

In some embodiments, the active ingredient is associated with preformed polymer nanoparticles. The associating step may involve dispersing the polymer nanoparticles in a first solvent and then dispersing the active ingredient in a second solvent that is miscible or partially miscible with the first solvent, mixing the two dispersions and then either removing the second or first solvent from the final mixture. In some embodiments, all the solvent is removed by vacuum evaporation, freeze drying or spray drying. The associating step may also involve dispersing both the preformed polymer nanoparticles and active ingredients in a common solvent and removing all or a portion of the common solvent from the final mixture.

In some embodiments, the associating step may involve milling the active ingredient in the presence of pre-formed polymer nanoparticles. It is surprising that if the active ingredient alone is milled under these conditions; the resulting particle size is significantly larger than if it is milled in the presence of pre-formed polymer nanoparticles. In general, size reduction processes such as milling do not enable the production of particle sizes that are produced via milling in the presence of nanoparticles of the current disclosure. Without wishing to be bound by any theory, it is thought that interaction between the active ingredient and the nanoparticles during the milling process facilitates the production of smaller particles than would be formed via milling in the absence of the nanoparticles.

Non-limiting examples of milling methods that may be used for the association step can be found in U.S. Pat. No. 6,6046,98 and include ball milling, bead milling, jet milling, media milling, and homogenization, as well as other milling methods known to those of skill in the art. Non-limiting examples of mills that can be for the association step include attritor mills, ball mills, colloid mills, high pressure homogenizers, horizontal mills, jet mills, swinging mills, and vibratory mills. In some embodiments, the associating step may involve milling the active ingredient in the presence of pre-formed polymer nanoparticles and an aqueous phase. In some embodiments, the associating step may involve wet or dry milling of the active ingredient in the presence of pre-formed nanoparticles. In some embodiments, the association step may involve milling the active ingredient and pre-formed polymer nanoparticles in the presence of one or more formulating agents.

In general and without limitation, the active ingredient may be associated with regions of the polymer nanoparticle that elicit a chemical or physical interaction with the active ingredient. Chemical interactions can include hydrophobic interactions, affinity pair interactions, H-bonding, and van der Waals forces. Physical interactions can include entanglement in polymer chains and/or inclusion within the polymer nanoparticle structure. In some embodiments, the active ingredient can be associated in the interior of the polymer nanoparticle, on the surface of the polymer nanoparticle, or both the surface and the interior of the polymer nanoparticle. Furthermore, the type of association interactions between the active ingredient and the polymer nanoparticle can be probed using spectroscopic techniques such as NMR, IR, UV-vis, and emission spectroscopies. For example, in cases where the triazole active ingredient is normally crystalline when not associated with the polymer nanoparticles, the nanoparticles of polymer-associated triazole compounds typically do not show the endothermic melting peak or show a reduced endothermic melting peak of the pure crystalline active ingredient as seen in differential thermal analysis (DTA) or differential scanning calorimetry (DSC) measurements

Nanoparticles of polymer-associated active ingredients can be prepared with a range of average diameters, e.g., between about 1 nm and about 500 nm. The size of the nanoparticles can be adjusted in part by varying the size and number of polymers that are included in the nanoparticles. In some embodiments, the average diameter ranges from about 1 nm to about 10 nm, from about 1 nm to about 20 nm, from about 1 nm to about 30 nm, from about 1 nm to about 50 nm, from about 10 nm to about 50 nm, from about 10 nm to about 100 nm, from about 20 nm to about 100 nm, from about 20 nm to about 100 nm, from about 50 nm to about 200 nm, from about 50 nm to about 250 nm, from about 50 nm to about 300 nm, from about 100 nm to about 250 nm, from about 100 nm to about 300 nm, from about 200 nm to about 300 nm, from about 200 nm to about 500 nm, from about 250 nm to about 500 nm, and from about 300 nm to about 500 nm. These and other average diameters described herein are based on volume average particle sizes that were measured in solution by dynamic light scattering on a Malvern Zetasizer ZS in CIPAC D water, 0.1M NaCl, or in deionized water at 200 ppm active concentration. Various forms of microscopies can also be used to visualize the sizes of the nanoparticles such as atomic force microscopy (AFM), transmission electron microscopy (TEM), scanning electron microscopy (SEM) and optical microscopy.

In some embodiments, the aggregates of nanoparticles of polymer-associated active ingredients have an average particle size between about 10 nm and about 5,000 nm when dispersed in water under suitable conditions. In some embodiments, the aggregates have an average particle size between about 10 nm and about 1,000 nm. In some embodiments, the aggregates have an average particle size between about 10 nm and about 500 nm. In some embodiments, the aggregates have an average particle size between about 10 nm and about 300 nm. In some embodiments, the aggregates have an average particle size between about 10 nm and about 200 nm. In some embodiments, the aggregates have an average particle size between about 50 nm and about 5,000 nm. In some embodiments, the aggregates have an average particle size between about 50 nm and about 1,000 nm. In some embodiments, the aggregates have an average particle size between about 50 nm and about 500 nm. In some embodiments, the aggregates have an average particle size between about 50 nm and about 300 nm. In some embodiments, the aggregates have an average particle size between about 50 nm and about 200 nm. In some embodiments, the aggregates have an average particle size between about 100 nm and about 5,000 nm. In some embodiments, the aggregates have an average particle size between about 100 nm and about 1,000 nm. In some embodiments, the aggregates have an average particle size between about 100 nm and about 500 nm. In some embodiments, the aggregates have an average particle size between about 100 nm and about 300 nm. In some embodiments, the aggregates have an average particle size between about 100 nm and about 200 nm. In some embodiments, the aggregates have an average particle size between about 500 nm and about 5000 nm. In some embodiments, the aggregates have an average particle size between about 500 nm and about 1000 nm. In some embodiments, the aggregates have an average particle size between about 1000 nm and about 5000 nm. Particle size can be measured by the techniques described above.

As described in detail in the examples, in some embodiments, pre-formed polymer nanoparticles that have been associated with active ingredient to generate nanoparticles or aggregates of nanoparticles of polymer-associated active ingredients (associated nanoparticles) can be recovered after extraction of the active ingredient. In some embodiments, the active ingredient can be extracted from nanoparticles or aggregates of nanoparticles of polymer-associated active ingredient by dispersing the associated nanoparticles in a solvent that dissolves the active ingredient but that is known to disperse the un-associated, preformed nanoparticles poorly or not at all. In some embodiments, after extraction and separation, the insoluble nanoparticles that are recovered have a size that is smaller than the nanoparticles or aggregates of nanoparticles of polymer-associated active ingredients as measured by DLS. In some embodiments, after extraction and separation, the insoluble nanoparticles that are recovered have a size that is similar or substantially the same as the size of original pre-formed polymer nanoparticles (prior to association) as measured by DLS. In some embodiments, the nanoparticles are prepared from poly(methacrylic acid-co-ethyl acrylate). In some embodiments, the active ingredient is difenoconazole. In some embodiments, the extraction solvent is acetonitrile.

It should be understood that the association step to generate nanoparticles of polymer associated active ingredient need not necessarily lead to association of the entire fraction the active ingredient in the sample with pre-formed polymer nanoparticles (not all molecules of the active ingredient in the sample must be associated with polymer nanoparticles after the association step). Likewise, the association step need not necessarily lead to the association of the entire fraction of the pre-formed nanoparticles in the sample with active ingredient (not all nanoparticle molecules in the sample must be associated with the active ingredient after the association step).

Similarly, in formulations comprising nanoparticles of polymer-associated active, the entire fraction of active ingredient in the formulation need not be associated with pre-formed polymer nanoparticles (not all molecules of the active ingredient in the sample must be associated with polymer nanoparticles in the formulation). Likewise, in formulations comprising nanoparticles of polymer-associated active ingredient, the entire fraction of pre-formed polymer nanoparticles in the formulation need not be associated with active ingredient (not all of nanoparticle molecules in the sample must be associated with the active ingredient in the formulation).

In some embodiments, the nanoparticles are prepared using a polymer that is a polyelectrolyte. Polyelectrolytes are polymers that contain monomer units of ionized or ionizable functional groups. They can be linear, branched, hyperbranched or dendrimeric, and they can be synthetic or naturally occurring. Ionizable functional groups are functional groups that can be rendered charged by adjusting solution conditions, while ionized functional group refers to chemical functional groups that are charged regardless of solution conditions. The ionized or ionizable functional group can be cationic or anionic, and can be continuous along the entire polymer chain (e.g., in a homopolymer), or can have different functional groups dispersed along the polymer chain, as in the case of a co-polymer (e.g., a random co-polymer).

In some embodiments, the polymer can be made up of monomer units that contain functional groups that are either anionic, cationic, both anionic and cationic, and can also include other monomer units that impart a specific desirable property to the polymer.

In some embodiments, the polyelectrolyte is a homopolymer. Non limiting examples of homopolymer polyelectrolytes include: poly(acrylic acid), poly(methacrylic acid), poly(styrene sulfonate), poly(ethyleneimine), chitosan, poly(dimethylammonium chloride), poly(allylamine hydrochloride), and carboxymethyl cellulose.

In some embodiments, the polyelectrolyte is a co-polymer. Non limiting examples of co-polymer polyelectrolytes include: poly(methacrylic acid-co-ethyl acrylate); poly(methacrylic acid-co-styrene); poly(methacrylic acid-co-butylmethacrylate); poly[acrylic acid-co-poly(ethylene glycol) methyl ether methacrylate].

In some embodiments, the polyelectrolyte can be made from one or more monomer units to form homopolymers, copolymers or graft copolymers of: ethylene; ethylene glycol; ethylene oxide; carboxylic acids including acrylic acid, methacrylic acid, itaconic acid, and maleic acid; polyoxyethylenes or polyethyleneoxide; and unsaturated ethylenic mono or dicarboxylic acids; lactic acids; amino acids; amines including dimethlyammonium chloride, allylamine hydrochloride; methacrylic acid; ethyleneimine; acrylates including methyl acrylate, ethyl acrylate, propyl acrylate, n-butyl acrylate (“BA”), isobutyl acrylate, 2-ethyl acrylate, and t-butyl acrylate; methacrylates including ethyl methacrylate, n-butyl methacrylate, and isobutyl methacrylate; acrylonitriles; methacrylonitrile; vinyls including vinyl acetate, vinylversatate, vinylpropionate, vinylformamide, vinylacetamide, vinylpyridines, and vinyllimidazole; vinylnapthalene, vinylnaphthalene sulfonate, vinylpyrrolidone, vinyl alcohol; aminoalkyls including aminoalkylacrylates, aminoalkylsmethacrylates, and aminoalkyl(meth)acrylamides; styrenes including styrene sulfonate; d-glucosamine; glucaronic acid-N-acetylglucosamine; N-isopropylacrylamide; vinyl amine. In some embodiments, the polyelectrolyte polymer can include groups derived from polysaccharides such as dextran, gums, cellulose, or carboxymethyl cellulose.

In some embodiments, the polyelectrolyte comprises poly(methacrylic acid-co-ethyl acrylate) polymer. In some embodiments, the mass ratio of methacrylic acid to ethyl acrylate in the poly(methacrylic acid-co-ethyl acrylate) polymer is between about 50:50 and about 95:5. In some embodiments, the mass ratio of methacrylic acid to ethyl acrylate in the poly(methacrylic acid-co-ethyl acrylate) polymer is between about 70:30 and about 95:5. In some embodiments, the mass ratio of methacrylic acid to ethyl acrylate in the poly(methacrylic acid-co-ethyl acrylate) polymer is between about 80:20 and about 95:5. In some embodiments, the mass ratio of methacrylic acid to ethyl acrylate in the poly(methacrylic acid-co-ethyl acrylate) polymer is between about 85:15 and about 95:5. In some embodiments, the mass ratio of methacrylic acid to ethyl acrylate in the poly(methacrylic acid-co-ethyl acrylate) polymer is between about 60:40 and about 80:20.

In some embodiments, the polyelectrolyte comprises poly(methacrylic acid-co-styrene) polymer. In some embodiments, the mass ratio of methacrylic acid to styrene in the poly(methacrylic acid-co-styrene) polymer is between about 50:50 and about 95:5. In some embodiments, the mass ratio of methacrylic acid to styrene in the poly(methacrylic acid-co-styrene) polymer is between about 70:30 and about 95:5. In some embodiments, the mass ratio of methacrylic acid to styrene in the poly(methacrylic acid-co-styrene) polymer is between about 80:20 and about 95:5. In some embodiments, the mass ratio of methacrylic acid to styrene in the poly(methacrylic acid-co-styrene) polymer is between about 85:15 and about 95:5. In some embodiments, the mass ratio of methacrylic acid to styrene in the poly(methacrylic acid-co-styrene) polymer is between about 60:40 and about 80:20.

In some embodiments, the mass ratio of methacrylic acid to butyl methacrylate in the poly(methacrylic acid-co-butylmethacrylate) polymer is between about 50:50 and about 95:5. In some embodiments, the mass ratio of methacrylic acid to butyl methacrylate in the poly(methacrylic acid-co-butylmethacrylate) polymer is between about 70:30 and about 95:5. In some embodiments, the mass ratio of methacrylic acid to butyl methacrylate in the poly(methacrylic acid-co-butylmethacrylate) polymer is between about 80:20 and about 95:5. In some embodiments, the mass ratio of methacrylic acid to butyl methacrylate in the poly(methacrylic acid-co-butylmethacrylate) polymer is between about 85:15 and about 95:5. In some embodiments, the mass ratio of methacrylic acid to butyl methacrylate in the poly(methacrylic acid-co-butylmethacrylate) polymer is between about 60:40 and about 80:20.

In some embodiments, the homo or co-polymer is water soluble at pH 7. In some embodiments, the polymer has solubility in water above about 1 weight %. In some embodiments, the polymer has solubility in water above about 2 weight %. In some embodiments, the polymer has solubility in water above about 3 weight %. In some embodiments, the polymer has solubility in water above about 4 weight %. In some embodiments, the polymer has solubility in water above about 5 weight %. In some embodiments, the polymer has solubility in water above about 10 weight %. In some embodiments, the polymer has solubility in water above about 20 weight %. In some embodiments, the polymer has solubility in water above about 30 weight %. In some embodiments, the polymer has solubility in water between about 1 and about 30 weight %. In some embodiments, the polymer has solubility in water between about 1 and about 10 weight %. In some embodiments, the polymer has solubility in water between about 5 and about 10 weight %. In some embodiments, the polymer has solubility in water between about 10 and about 30 weight %. In some embodiments the solubility of the polymer in water can also be adjusted by adjusting pH or other solution conditions in water.

In some embodiments, the polyelectrolyte polymer has a weight average (M_{w}) molecular weight between about 5,000 and about 4,000,000 Daltons. In some embodiments, the polyelectrolyte polymer has a weight average molecular weight between about 100,000 and about 2,000,000 Daltons. In some embodiments, the polyelectrolyte polymer has a weight average molecular weight between about 100,000 and about 1,000,000 Daltons. In some embodiments, the polyelectrolyte polymer has a weight average molecular weight between about 100,000 and about 750,000 Daltons. In some embodiments, the polyelectrolyte polymer has a weight average molecular weight between about 100,000 and about 500,000 Daltons. In some embodiments, the polyelectrolyte polymer has a weight average molecular weight between about 100,000 and about 200,000 Daltons. In some embodiments, the polyelectrolyte polymer has a weight average molecular weight between about 200,000 and about 2,000,000 Daltons. In some embodiments, the polyelectrolyte polymer has a weight average molecular weight between about 200,000 and about 1,000,000 Daltons. In some embodiments, the polyelectrolyte polymer has a weight average molecular weight between about 200,000 and about 500,000 Daltons. In some embodiments, the polyelectrolyte polymer has a weight average molecular weight between about 300,000 and about 2,000,000 Daltons. In some embodiments, the polyelectrolyte polymer has a weight average molecular weight between about 300,000 and about 1,000,000 Daltons. In some embodiments, the polyelectrolyte polymer has a weight average molecular weight between about 300,000 and about 500,000 Daltons. In some embodiments, the polyelectrolyte polymer has a weight average molecular weight between about 5,000 and about 250,000 Daltons. In some embodiments, the polyelectrolyte polymer has a weight average molecular weight between about 5,000 and about 50,000 Daltons. In some embodiments, the polyelectrolyte polymer has a weight average molecular weight between about 5,000 and about 100,000 Daltons. In some embodiments, the polyelectrolyte polymer has a weight average molecular weight between about 5,000 and about 250,000 Daltons. In some embodiments, the polyelectrolyte polymer has a weight average molecular weight between about 50,000 and about 250,000 Daltons.

In some embodiments, the apparent molecular weight of the polyelectrolyte polymer (e.g., the molecular weight determined via certain analytical measurements such as size exclusion chromatography or DLS) is lower than the actual molecular weight of a polymer due to crosslinking within the polymer. In some embodiments, a crosslinked polyelectrolyte polymer of the present disclosure might have a higher actual molecular weight than the experimentally determined apparent molecular weight. In some embodiments, a crosslinked polyelectrolyte polymer of the present disclosure might be a high molecular weight polymer despite having a low apparent molecular weight.

Nanoparticles of polymer-associated active ingredients and/or aggregates of these nanoparticles can be part of a formulation in different amounts. The final amount will depend on many factors including the type of formulation (e.g., liquid or solid, granule or powder, concentrated or not, etc.). In some instances the nanoparticles (including both the polymer and active ingredient components) make up between about 1 and about 98 weight % of the total formulation. In some embodiments, the nanoparticles make up between about 1 and about 90 weight % of the total formulation. In some embodiments, the nanoparticles make up between about 1 and about 75 weight % of the total formulation. In some embodiments, the nanoparticles make up between about 1 and about 50 weight % of the total formulation. In some embodiments, the nanoparticles make up between about 1 and about 30 weight % of the total formulation. In some embodiments, the nanoparticles make up between about 1 and about 25 weight % of the total formulation. In some embodiments, the nanoparticles make up between about 1 and about 10 weight % of the total formulation. In some embodiments, the nanoparticles make up between about 5 and about 15 weight % of the total formulation. In some embodiments, the nanoparticles make up between about 5 and about 25 weight % of the total formulation. In some embodiments, the nanoparticles make up between about 10 and about 25 weight % of the total formulation. In some embodiments, the nanoparticles make up between about 10 and about 30 weight % of the total formulation. In some embodiments, the nanoparticles make up between about 10 and about 50 weight % of the total formulation. In some embodiments, the nanoparticles make up between about 10 and about 75 weight % of the total formulation. In some embodiments, the nanoparticles make up between about 10 and about 90 weight % of the total formulation. In some embodiments, the nanoparticles make up between about 10 and about 98 weight % of the total formulation. In some embodiments, the nanoparticles make up between about 25 and about 50 weight % of the total formulation. In some embodiments, the nanoparticles make up between about 25 and about 75 weight % of the total formulation. In some embodiments, the nanoparticles make up between about 25 and about 90 weight % of the total formulation. In some embodiments, the nanoparticles make up between about 30 and about 98 weight % of the total formulation. In some embodiments, the nanoparticles make up between about 50 and about 90 weight % of the total formulation. In some embodiments, the nanoparticles make up between about 50 and about 98 weight % of the total formulation. In some embodiments, the nanoparticles make up between about 75 and about 90 weight % of the total formulation. In some embodiments, the nanoparticles make up between about 75 and about 98 weight % of the total formulation.

In some embodiments, the nanoparticles of polymer-associated active ingredients are prepared according to a method disclosed in United States Patent Application Publication No. 20100210465, the entire contents of which are incorporated herein by reference. In some embodiments, polymer nanoparticles without active ingredients are made by collapse of a polyelectrolyte with a collapsing agent and then rendering the collapsed conformation permanent by intra-particle cross-linking. The active ingredient is then associated with this pre-formed polymer nanoparticle. In some embodiments, the formulation contains the same amount (by weight) of active ingredient and polymer nanoparticle, while in other embodiments the ratio of active ingredient to polymer nanoparticle (by weight) can be between about 1:10 and about 10:1, between about 1:10 and about 1:5, between about 1:5 and about 1:4, between about 1:4 and about 1:3, between about 1:3 and about 1:2, between about 1:2 and about 1:1, between about 1:5 and about 1:1, between about 5:1 and about 1:1, between about 2:1 and about 1:1, between about 3:1 and about 2:1, between about 4:1 and about 3:1, between about 5:1 and about 4:1, between about 10:1 and about 5:1, between about 1:3 and about 3:1, between about 5:1 and about 1:1, between about 1:5 and about 5:1, or between about 1:2 and about 2:1.

As noted above, in some embodiments, the associating step may involve dispersing the polymer nanoparticles in a first solvent, dispersing the active ingredient in a second solvent that is miscible or partially miscible with the first solvent, mixing the two dispersions and then either removing the second or first solvent from the final mixture.

Alternatively, in some embodiments, the associating step may involve dispersing both the pre-formed polymer nanoparticles and active ingredient in a common solvent and removing all or a portion of the common solvent from the final mixture. The final form of the nanoparticles of polymer-associated active ingredient can be either a dispersion in a common solvent or a dried solid. The common solvent is typically one that is capable of swelling the polymer nanoparticles as well as dissolving the active ingredient at a concentration of at least about 10 mg/mL, e.g., at least about 20 mg/mL. The polymer nanoparticles are typically dispersed in the common solvent at a concentration of at least about 10 mg/mL, e.g., at least about 20 mg/mL. In some embodiments, the common solvent is an alcohol (either long or short chain), preferably methanol or ethanol. In some embodiments the common solvent is selected from alkenes, alkanes, alkynes, phenols, hydrocarbons, chlorinated hydrocarbons, ketones, and ethers. In some embodiments, the common solvent is a mixture of two or more different solvents that are miscible or partially miscible with each other. Some or all of the common solvent is removed from the dispersion of pre-formed polymer nanoparticles and active ingredients by either direct evaporation or evaporation under reduced pressure. The dispersion can be dried by a range of processes known by a practitioner of the art such as lyophilization (freeze-drying), spray-drying, tray-drying, evaporation, jet drying, or other methods to obtain the nanoparticles of polymers-associated with active ingredients. In general, the amount of solvent that is removed from the dispersion described above will depend on the final type of formulation that is desired. This is illustrated further in the Examples and in the general description of specific formulations.

In some instances the solids content (including both the polymer and active ingredient components as well as other solid form formulating agents) of the formulation is between about 1 and about 98 weight % of the total formulation. In some embodiments, the solids content of the formulation is between about 1 and about 90 weight % of the total formulation. In some embodiments, the solids content of the formulation is between about 1 and about 75 weight % of the total formulation. In some embodiments, the solids content of the formulation is between about 1 and about 50 weight % of the total formulation. In some embodiments, the solids content of the formulation is between about 1 and about 30 weight % of the total formulation. In some embodiments, the solids content of the formulation is between about 1 and about 25 weight % of the total formulation. In some embodiments, the solids content of the formulation is between about 1 and about 10 weight % of the total formulation. In some embodiments, the solids content of the formulation is between about 10 and about 25 weight % of the total formulation. In some embodiments, the solids content of the formulation is between about 10 and about 30 weight % of the total formulation. In some embodiments, the solids content of the formulation is between about 10 and about 50 weight % of the total formulation. In some embodiments, the solids content of the formulation is between about 10 and about 75 weight % of the total formulation. In some embodiments, the solids content of the formulation is between about 10 and about 90 weight % of the total formulation. In some embodiments, the solids content of the formulation is between about 10 and about 98 weight % of the total formulation. In some embodiments, the solids content of the formulation is between about 25 and about 50 weight % of the total formulation. In some embodiments, the solids content of the formulation is between about 25 and about 75 weight % of the total formulation. In some embodiments, the solids content of the formulation is between about 25 and about 90 weight % of the total formulation. In some embodiments, the solids content of the formulation is between about 30 and about 98 weight % of the total formulation. In some embodiments, the solids content of the formulation is between about 50 and about 90 weight % of the total formulation. In some embodiments, the solids content of the formulation is between about 50 and about 98 weight % of the total formulation. In some embodiments, the solids content of the formulation is between about 75 and about 90 weight % of the total formulation. In some embodiments, the solids content of the formulation is between about 75 and about 98 weight % of the total formulation.

### Formulating Agents

As used herein, the term “formulating agent” refers to any other material used in the formulation other than the nanoparticles of polymer-associated active ingredient. Formulating agents can include, but are not limited to, compounds that can act as a dispersants or wetting agents, inert fillers, solvents, surfactants, anti-freezing agents, anti-settling agents or thickeners, disintegrants, and preservatives.

In some embodiments, a formulation may include a dispersant or wetting agent or both. In some embodiments the same compound may act as both a dispersant and a wetting agent. A dispersant is a compound that helps the nanoparticles (or aggregates of nanoparticles) disperse in water. Without wishing to be bound by any theory, dispersants are thought to achieve this result by absorbing on to the surface of the nanoparticles and thereby limiting re-aggregation. Wetting agents increase the spreading or penetration power of a liquid when placed onto the substrate (e.g., leaf). Without wishing to be bound by any theory, wetting agents are thought to achieve this result by reducing the interfacial tension between the liquid and the substrate surface.

In a similar manner, some formulating agents may demonstrate multiple functionality. The categories and listings of specific agents below are not mutually exclusive. For example, fumed silica, described below in the thickener/anti-settling agent and anti-caking agent sections, is typically used for these functions. In some embodiments, however, fumed silica demonstrates the functionality of a wetting agent and/or dispersant. Specific formulating agents listed below are categorized based on their primary functionality, however, it is to be understood that particular formulating agents may exhibit multiple functions. Certain formulation ingredients display multiple functionalities and synergies with other formulating agents and may demonstrate superior properties in a particular formulation but not in another formulation.

In some embodiments, a dispersant or wetting agent is selected from organosilicones (e.g., SYLGARD 309 from Dow Corning Corporation or SILWET L77 from Union Carbide Corporation) including polyalkylene oxide modified polydimethylsiloxane (SILWET L7607 from Union Carbide Corporation), methylated seed oil, and ethylated seed oil (e.g., SCOIL from Agsco or HASTEN from Wilfarm), alkylpolyoxyethylene ethers (e.g., ACTIVATOR 90), alkylarylalolates (e.g., APSA 20), alkylphenol ethoxylate and alcohol alkoxylate surfactants (e.g., products sold by Huntsman), fatty acid, fatty ester and fatty amine ethoxylates (e.g., products sold by Huntsman), products sold by Cognis such as sorbitan and ethoxylated sorbitan esters, ethoxylated vegetable oils, alkyl, glycol and glycerol esters and glycol ethers, tristyrylphenol ethoxylates, anionic surfactants such as sulfonates, such as sulfosuccinates, alkylaryl sulphonates, alkyl napthalene sulfonates (e.g., products sold by Adjuvants Unlimited), calcium alkyl benzene sulphonates, and phosphate esters (e.g., products sold by Huntsman Chemical or BASF), as salts of sodium, potassium, ammonium, magnesium, triethanolamine (TEA), etc.

Other specific examples of the above sulfates include ammonium lauryl sulfate, magnesium lauryl sulfate, sodium 2-ethyl-hexyl sulfate, sodium actyl sulfate, sodium oleyl sulfate, sodium tridecyl sulfate, triethanolamine lauryl sulfate, ammonium linear alcohol, ether sulfate ammonium nonylphenol ether sulfate, and ammonium monoxynol-4-sulfate. Other examples of dispersants and wetting agents include, sulfo succinamates, disodium N-octadecylsulfo-succinamate; tetrasodium N-(1,2-dicarboxyethyl)-N-octadecylsulfo-succinamate; diamyl ester of sodium sulfosuccinic acid; dihexyl ester of sodium sulfosuccinic acid; and dioctyl esters of sodium sulfosuccinic acid; dihexyl ester of sodium sulfosuccinic acid; and dioctyl esters of sodium sulfosuccinic acid; castor oil and fatty amine ethoxylates, including sodium, potassium, magnesium or ammonium salts thereof. Dispersants and wetting agents also include natural emulsifiers, such as lecithin, fatty acids (including sodium, potassium or ammonium salts thereof) and ethanolamides and glycerides of fatty acids, such as coconut diethanolamide and coconut mono- and diglycerides. Dispersants and wetting agents also include sodium polycarboxylate (commercially available as Geropon TA/72); sodium salt of naphthalene sulfonate condensate (commercially available as Morwet (D425, D809, D390, EFW); calcium naphthalene sulfonates (commercially available as DAXAD 19LCAD); sodium lignosulfonates and modified sodium lignosulfonates; aliphatic alcohol ethoxylates; ethoxylated tridecyl alcohols (commercially available as Rhodasurf (BC420, BC610, BC720, BC 840); Ethoxylated tristeryl phenols (commercially available as Soprophor BSU); sodium methyl oleyl taurate (commercially available as Geropon T-77); tristyrylphenol ethoxylates and esters; ethylene oxide-propylene oxide block copolymers; non-ionic copolymers (e.g., commercially available Atlox 4913), non-ionic block copolymers (commercially available as Atlox 4912). Examples of dispersants and wetting agents include, but are not limited to, sodium dodecylbenzene sulfonate; N-oleyl N-methyl taurate; 1,4-dioctoxy-1,4-dioxo-butane-2-sulfonic acid; sodium lauryl sulphate; sodium dioctyl sulphosuccinate; aliphatic alcohol ethoxylates; nonylphenol ethoxylates. Dispersants and wetting agents also include sodium taurates; and sodium or ammonium salts of maleic anhydride copolymers, lignosulfonic acid formulations or condensed sulfonate sodium, potassium, magnesium or ammonium salts, polyvinylpyrrolidone (available commercially as POLYPLASDONE XL-10 from International Specialty Products or as KOLLIDON C1 M-10 from BASF Corporation), polyvinyl alcohols, modified or unmodified starches, methylcellulose, hydroxyethyl or hydroxypropyl methylcellulose, carboxymethyl methylcellulose, or combinations, such as a mixture of either lignosulfonic acid formulations or condensed sulfonate sodium, potassium, magnesium or ammonium salts with polyvinylpyrrolidone (PVP).

In some embodiments, the dispersants and wetting agents can combine to make up between about 0.5 and about 30 weight % of the formulation. For example, dispersants and wetting agents can make up between about 0.5 and about 20 weight %, about 0.5 and about 10 weight %, between about 0.5 and about 5 weight %, between about 0.5 and about 3 weight %, between about 1 and about 30 weight %, between about 1 and about 20 weight %, between about 1 and about 10 weight %, between about 1 and about 5 weight %, between about 2 and about 30 weight %, between about 2 and about 20 weight %, between about 2 and about 10 weight %, between about 2 and about 5 weight %, between about 3 and about 30 weight %, between about 3 and about 20 weight %, between about 3 and about 10 weight %, between about 3 and about 5 weight %, between about 5 and about 30 weight %, between about 5 and about 20 weight %, between about 5 and about 10 weight % of the formulation. In some embodiments, dispersants or wetting agents can make up between about 0.1 and 1 weight % of the formulation, between about 0.1 and 2 weight % of the formulation between about 0.1 and 3 weight % of the formulation between about 0.1 and 5 weight % of the formulation, between about 0.1 and 10 weight % of the formulation.

In some embodiments, a formulation may include an inert filler. For example, an inert filler may be included to produce or promote cohesion in forming a wettable granule formulation. An inert filler may also be included to give the formulation a certain active loading, density, or other similar physical properties. Non limiting examples of inert fillers that may be used in a formulation include bentonite clay, carbohydrates, proteins, lipids synthetic polymers, glycolipids, glycoproteins, lipoproteins, lignin, lignin derivatives, and combinations thereof. In a preferred embodiment the inert filler is a lignin derivative and is optionally calcium lignosulfonate. In some embodiments, the inert filler is selected from the group consisting of: monosaccharides, disaccharides, oligosaccharides, polysaccharides and combinations thereof. Specific carbohydrate inert fillers illustratively include glucose, mannose, fructose, galactose, sucrose, lactose, maltose, xylose, arabinose, trehalose and mixtures thereof such as corn syrup; sugar alcohols including: sorbitol, xylitol, ribitol, mannitol, galactitol, fucitol, iditol, inositol, volemitol, isomalt, maltitol, lactitol, polyglycitol; celluloses such as carboxymethylcellulose, ethylcellulose, hydroxyethylcellulose, hydroxy-methylethylcellulose, hydroxyethylpropylcellulose, methyl hydroxyethylcellulose, methylcellulose; starches such as amylose, seagel, starch acetates, starch hydroxyethyl ethers, ionic starches, long-chain alkyl starches, dextrins, amine starches, phosphates starches, and dialdehyde starches; plant starches such as corn starch and potato starch; other carbohydrates such as pectin, amylopectin, xylan, glycogen, agar, alginic acid, phycocolloids, chitin, gum arabic, guar gum, gum karaya, gum tragacanth and locust bean gum; vegetable oils such as corn, soybean, peanut, canola, olive and cotton seed; complex organic substances such as lignin and nitrolignin; derivatives of lignin such as lignosulfonate salts illustratively including calcium lignosulfonate and sodium lignosulfonate and complex carbohydrate-based formulations containing organic and inorganic ingredients such as molasses. Suitable protein inert fillers illustratively include soy extract, zein, protamine, collagen, and casein. Inert fillers operative herein also include synthetic organic polymers capable of promoting or producing cohesion of particle components and such inert fillers illustratively include ethylene oxide polymers, polyacrylamides, polyacrylates, polyvinyl pyrrolidone, polyethylene glycol, polyvinyl alcohol, polyvinylmethyl ether, polyvinyl acrylates, polylactic acid, and latex.

In some embodiments, a formulation contains between about 1 and about 90 weight % inert filler, e.g., between about 1 and about 80 weight %, between about 1 and about 60 weight %, between about 1 and about 40 weight %, between about 1 and about 25 weight %, between about 1 and about 10 weight %, between about 10 and about 90 weight %, between about 10 and about 80 weight %, between about 10 and about 60 weight %, between about 10 and about 40 weight %, between about 10 and about 25 weight %, between about 25 and about 90 weight %, between about 25 and about 80 weight %, between about 25 and about 60 weight %, between about 25 and about 40 weight %, between about 40 and about 90 weight %, between about 40 and about 80 weight %, or between about 60 and about 90 weight %.

In some embodiments, a formulation may include a solvent or a mixture of solvents that can be used to assist in controlling the solubility of the active ingredient itself, the nanoparticles of polymer-associated active ingredients, or other components of the formulation. For example, the solvent can be chosen from water, alcohols, alkenes, alkanes, alkynes, phenols, hydrocarbons, chlorinated hydrocarbons, ketones, ethers, and mixtures thereof. In some embodiments, the formulation contains a solvent or a mixture of solvents that makes up about 0.1 to about 90 weight % of the formulation. In some embodiments, a formulation contains between about 0.1 and about 90 weight % solvent, e.g., between about 1 and about 80 weight %, between about 1 and about 60 weight %, between about 1 and about 40 weight %, between about 1 and about 25 weight %, between about 1 and about 10 weight %, between about 10 and about 90 weight %, between about 10 and about 80 weight %, between about 10 and about 60 weight %, between about 10 and about 40 weight %, between about 10 and about 25 weight %, between about 25 and about 90 weight %, between about 25 and about 80 weight %, between about 25 and about 60 weight %, between about 25 and about 40 weight %, between about 40 and about 90 weight %, between about 40 and about 80 weight %, between about 60 and about 90 weight %, between about 0.1 and about 10 weight %, between about 0.1 and about 5 weight %, between about 0.1 and about 3 weight %, between about 0.1 and about 1 weight %, between about 0.5 and about 20 weight %, 0 between about.5 and about 10 weight %, between about 0.5 and about 5 weight %, between about 0.5 and about 3 weight %, between about 0.5 and about 1 weight %, between about 1 and about 20 weight %, between about 1 and about 10 weight %, between about 1 and about 5 weight %, between about 1 and about 3 weight %, between about 5 and about 20 weight %, between about 5 and about 10 weight %, between about 10 or about 20 weight %.

In some embodiments, a formulation may include a surfactant. When included in formulations, surfactants can function as wetting agents, dispersants, emulsifying agents, solublizing agents and bioenhancing agents. Without limitation, particular surfactants may be anionic surfactants, cationic surfactants, nonionic surfactants, amphoteric surfactants, silicone surfactants (e.g., Silwet L77), and fluorosurfactants. Exemplary anionic surfactants include alkylbenzene sulfonates, olefinic sulfonate salts, alkyl sulfonates and ethoxylates, sulfosuccinates, phosphate esters, taurates, alkylnaphthalene sulfonates and polymers lignosulfonates. Exemplary nonionic surfactants include alkylphenol ethoxylates, aliphatic alcohol ethoxylates, aliphatic alkylamine ethoxylates, amine alkoxylates, sorbitan esters and their ethoxylates, castor oil ethoxylates, ethylene oxide/propylene oxide copolymers and polymeric surfactants, non-ionic copolymers (e.g., commercially available Atlox 4913), non-ionic block copolymers (commercially available as Atlox 4912). In some embodiments, surfactants can make up between about 0.1 and about 20 weight % of the formulation, e.g., between about 0.1-15 weight %, between about 0.1 and about 10 weight %, between about 0.1 and about 8 weight %, between about 0.1 and about 6 weight %, between about 0.1 and about 4 weight %, between about 1-15 weight %, between about 1 and about 10 weight %, between about 1 and about 8 weight %, between about 1 and about 6 weight %, between about 1 and about 4 weight %, between about 3 and about 20 weight %, between about 3 and about 15 weight %, between about 3 and about 10 weight %, between about 3 and about 8 weight %, between about 3 and about 6 weight %, between about 5 and about 15 weight %, between about 5 and about 10 weight %, between about 5 and about 8 weight %, or between about 10 and about 15 weight %. In some embodiments, a surfactant (e.g., a non-ionic surfactant) may be added to a formulation by the end user, e.g., in a spray tank. Indeed, when a formulation is added to the spray tank it becomes diluted and, in some embodiments, it may be advantageous to add additional surfactant in order to maintain the nanoparticles in dispersed form.

Suitable non-ionic surfactants also include alkyl polyglucosides (APGs). Alkyl polyglucosides which can be used in the adjuvant composition herein include those corresponding to the formula: R₄O(R₅O)_{b}(Z₃)ₐ wherein R₄ is a monovalent organic radical of from 6 to 30 carbon atoms; R₅ is a divalent alkylene radical of from 2 to 4 carbon atoms; Z₃ is a saccharide residue of 5 or 6 carbon atoms; a is a number ranging from 1 to 6; and, b is a number ranging from 0 to 12. More specifically R4 is a linear C6 to C12 group, b is 0, Z3 is a glucose residue, and a is 2. Some non-limiting examples of commercially available alkyl polyglucosides include, e.g., APG™, Agnique™, or Agrimul™ surfactants from Cognis Corporation (now owned by BASF), and AG™ series surfactants from Akzo Nobel Surface Chemistry, LLC.

In some embodiments, a formulation may include an anti-settling agent or thickener that can help provide stability to a liquid formulation or modify the rheology of the formulation. Examples of anti-settling agents or thickeners include, but are not limited to, guar gum; locust bean gum; xanthan gum; carrageenan; alginates; methyl cellulose; sodium carboxymethyl cellulose; hydroxyethyl cellulose; modified starches; polysaccharides and other modified polysaccharides; polyvinyl alcohol; glycerol alkyd resins such as Latron B-1956 from Rohm & Haas Co., plant oil based materials (e.g., cocodithalymide) with emulsifiers; polymeric terpenes; microcrystalline cellulose; methacrylates; poly(vinylpyrrolidone), syrups, polyethylene oxide, hydrophobic silica, hydrated silica and fumed silica (e.g., Aerosil 380). In some embodiments, anti-settling agents or thickeners can make up between about 0.05 and about 10 weight % of the formulation, e.g., about 0.05 to about 5 weight %, about 0.05 to about 3 weight %, about 0.05 to about 1 weight %, about 0.05 to about 0.5 weight %, about 0.05 to about 0.1 weight %, about 0.1 to about 5 weight %, about 0.1 to about 3 weight %, about 0.1 to about 2 weight %, about 0.1 to about 1 weight %, about 0.1 to about 0.5 weight %, about 0.5 to about 5 weight %, about 0.5 to about 3 weight %, about 0.5 to about 1 weight %, about 1 to about 10 weight %, about 1 to about 5 weight %, or about 1 to about 3 weight %. In some embodiments, it is explicitly contemplated that a formulation of the present disclosure does not include a compound whose primary function is to act as an anti-settling or thickener. In some embodiments, compounds included in a formulation may have some anti-settling or thickening functionality, in addition to other, primary functionality, so anti-settling or thickening functionality is not a necessary condition for exclusion, however, formulation agents used primarily or exclusively as anti-settling agents or thickeners may be expressly omitted from the formulations.

In some embodiments, a formulation may include one or more preservatives that prevent microbial or fungal degradation of the product during storage. Examples of preservatives include but are not limited to, tocopherol, ascorbyl palmitate, propyl gallate, butylated hydroxyanisole (BHA), butylated hydroxytoluene (BHT), propionic acid and its sodium salt; sorbic acid and its sodium or potassium salts; benzoic acid and its sodium salt; p-hydroxy benzoic acid sodium salt; methyl p-hydroxy benzoate; 1,2-benzisothiazalin-3-one, and combinations thereof. In some embodiments, preservatives can make up about 0.01 to about 0.2 weight % of the formulation, e.g., between about 0.01 and about 0.1 weight %, between about 0.01 and about 0.05 weight %, between about 0.01 and about 0.02 weight %, between about 0.02 and about 0.2 weight %, between about 0.02 and about 0.1 weight %, between about 0.02 and about 0.05 weight %, between about 0.05 and about 0.2 weight %, between about 0.05 and about 0.1 weight %, or between about 0.1 and about 0.2 weight %.

In some embodiments, a formulation may include anti-freezing agents, anti-foaming agents, and/or anti-caking agents that help stabilize the formulation against freezing during storage, foaming during use, or caking during storage. Examples of anti-freezing agents include, but are not limited to, ethylene glycol, propylene glycol, and urea. In certain embodiment a formulation may include between about 0.5 and about 10 weight % anti-freezing agents, e.g., between about 0.5 and about 5 weight %, between about 0.5 and about 3 weight %, between about 0.5 and about 2 weight %, between about 0.5 and about 1 weight %, between about 1 and about 10 weight %, between about 1 and about 5 weight %, between about 1 and about 3 weight %, between about 1 and about 2 weight %, between about 2 and about 10 weight %, between about 3 and about 10 weight %, or between about 5 and about 10 weight %.

Examples of anti-foaming agents include, but are not limited to, silicone based anti-foaming agents (e.g., aqueous emulsions of dimethyl polysiloxane, FG-10 from Dow-Corning®, Trans 10A from Trans-Chemo Inc.), and non-silicone based anti-foaming agents such as octanol, nonanol, and silica. In some embodiments a formulation may include between about 0.05 and about 5 weight % of anti-foaming agents, e.g., between about 0.05 and about 0.5 weight %, between about 0.05 and about 1 weight %, between about 0.05 and about 0.2 weight %, between about 0.1 and about 0.2 weight %, between about 0.1 and about 0.5 weight %, between about 0.1 and about 1 weight %, or between about 0.2 and about 1 weight %.

Examples of anti-caking agents include sodium or ammonium phosphates, sodium carbonate or bicarbonate, sodium acetate, sodium metasilicate, magnesium or zinc sulfates, magnesium hydroxide (all optionally as hydrates), sodium alkylsulfosuccinates, silicious compounds, magnesium compounds, C10 -C22 fatty acid polyvalent metal salt compounds, and the like. Illustrative of anti-caking ingredients are attapulgite clay, kieselguhr, silica aerogel, silica xerogel, perlite, talc, vermiculite, sodium aluminosilicate, aluminosilicate clays (e.g., Montmorillonite, Attapulgite, etc.,) zirconium oxychloride, starch, sodium or potassium phthalate, calcium silicate, calcium phosphate, calcium nitride, aluminum nitride, copper oxide, magnesium aluminum silicate, magnesium carbonate, magnesium silicate, magnesium nitride, magnesium phosphate, magnesium oxide, magnesium nitrate, magnesium sulfate, magnesium chloride, and the magnesium and aluminum salts of C10 -C22 fatty acids such as palmitic acid, stearic acid and oleic acid. Anti-caking agents also include refined kaolin clay, amorphous precipitated silica dioxide, such as HI SIL 233 available from PPG Industries, refined clay, such as HUBERSIL available from Huber Chemical Company, or fumed silica (e.g., Aerosil 380) In some embodiments, a formulation may include between about 0.05 and about 10 weight % anti-caking agents, e.g., between about 0.05 to 5 weight %, between about 0.05 and about 3 weight %, between about 0.05 and about 2 weight %, between about 0.05 and about 1 weight %, between about 0.05 and about 0.5 weight %, between about 0.05 and about 0.1 weight %, between about 0.1 and about 5 weight %, between about 0.1 and about 3 weight %, between about 0.1 and about 2 weight %, between about 0.1 and about 1 weight %, between about 0.1 and about 0.5 weight %, between about 0.5 and about 5 weight %, between about 0.5 and about 3 weight %, between about 0.5 and about 2 weight %, between about 0.5 and about 1 weight %, between about 1 to 3 weight %, between about 1 to 10 weight %, or between about 1 and about 5 weight %.

In some embodiments, a formulation may include a UV-blocking compound that can help protect the active ingredient from degradation due to UV irradiation. Examples of UV-blocking compounds include ingredients commonly found in sunscreens such as benzophenones, benzotriazoles, homosalates, alkyl cinnamates, salicylates such as octyl salicylate, dibenzoylmethanes, anthranilates, methylbenzylidenes, octyl triazones, 2-phenylbenzimidazole-5-sulfonic acid, octocrylene, triazines, cinnamates, cyanoacrylates, dicyano ethylenes, etocrilene, drometrizole trisiloxane, bisethylhexyloxyphenol methoxyphenol triazine, drometrizole, dioctyl butamido triazone, terephthalylidene dicamphor sulfonic acid and para-aminobenzoates as well as ester derivatives thereof, UV-absorbing metal oxides such as titanium dioxide, zinc oxide, and cerium oxide, and nickel organic compounds such as nickel bis (octylphenol) sulfide, etc. Additional examples of each of these classes of UV-blockers may be found in Kirk-Othmer, Encyclopedia of Chemical Technology. In some embodiments, a formulation may include between about 0.01 and about 2 weight % UV-blockers, e.g., between about 0.01 and about 1 weight %, between about 0.01 and about 0.5 weight %, between about 0.01 and about 0.2 weight %, between about 0.01 and about 0.1 weight %, between about 0.01 and about 0.05 weight %, between about 0.05 weight % and about 1 weight %, between about 0.05 and about 0.5 weight %, between about 0.05 and about 0.2 weight %, between about 0.05 and about 0.1 weight %, between about 0.1 and about 1 weight %, between about 0.1 and about 0.5 weight %, between about 0.1 and about 0.2 weight %, between about 0.2 and about 1 weight %, between about 0.2 and about 0.5 weight %, or between about 0.5 and about 1 weight %. In some embodiments, it is explicitly contemplated that a formulation of the present disclosure does not include a compound whose primary function is to act as a UV-blocker. In some embodiments, compounds included in a formulation may have some UV-blocking functionality, in addition to other, primary functionality, so UV-blocking is not a necessary condition for exclusion, however, formulation agents used primarily or exclusively as UV-blockers may be expressly omitted from the formulations.

In some embodiments, a formulation may include a disintegrant that can help a solid formulation break apart when added to water. Examples of suitable disintegrants include cross-linked polyvinyl pyrrolidone, modified cellulose gum, pregelatinized starch, cornstarch, modified corn starch (e.g., STARCH 1500) and sodium carboxymethyl starch (e.g., EXPLOTAB or PRIMOJEL), microcrystalline cellulose, sodium starch glycolate, sodium carboxymethyl cellulose, carmellose, carmellose calcium, carmellose sodium, croscarmellose sodium, carmellose calcium, carboxymethylstarch sodium, low-substituted hydroxypropyl cellulose, hydroxypropyl methylcellulose, hydroxypropyl cellulose, soy polysaccharides (e.g., EMCOSOY), alkylcelullose, hydroxyalkylcellulose, alginates (e.g., SATIALGINE), dextrans and poly(alkylene oxide) and an effervescent couple (e.g., citric or ascorbic acid plus bicarbonate), lactose, anhydrous dibasic calcium phosphate, dibasic calcium phosphate, magnesium aluminometasilicate, synthesized hydrotalcite, silicic anhydride and synthesized aluminum silicate. In some embodiments disintegrants can make up between about 1 and about 20 weight % of the formulation, e.g., between about 1 and about 15 weight %, between about 1 and about 10 weight %, between about 1 and about 8 weight %, between about 1 and about 6 weight %, between about 1 and about 4 weight %, between about 3 and about 20 weight %, between about 3 and about 15 weight %, between about 3 and about 10 weight %, between about 3 and about 8 weight %, between about 3 and about 6 weight %, between about 5 and about 15 weight %, between about 5 and about 10 weight %, between about 5 and about 8 weight %, or between about 10 and about 15 weight %.

Formulations

As described above, the nanoparticles of polymer-associated active ingredient can be formulated into different types of formulations for different applications. For example, the types of formulations can include wettable granules, wettable powders, and high solid liquid suspensions. Furthermore, as discussed above, formulation agents can include, but are not limited to dispersants, wetting agents, surfactants, anti-settling agents or thickeners, preservatives, anti-freezing agents, anti-foaming agents, anti-caking agents, inert fillers, and UV-blockers.

In some embodiments, a dispersion of polymer nanoparticles and active ingredient in a common solvent is dried (e.g., spray dried) to form a solid containing nanoparticles (optionally in aggregate form) of polymer-associated active ingredients. The spray dried solid can then be used as is or incorporated into a formulation containing other formulating agents to make a wettable granule (WG), wettable powder (WP), or a high solids liquid suspension (HSLS).

In some embodiments, active ingredient is milled in the presence of pre-formed polymer nanoparticles to form a solid containing nanoparticles (optionally in aggregate form) of polymer-associated active ingredients. The solid can then be used as is or incorporated into a formulation containing other formulating agents to make a wettable granule (WG), wettable powder (WP), or a high solids liquid suspension (HSLS). In some embodiments, the milling step may be performed in the presence of one or more formulating agents. In some embodiments, the milling step may be performed in the presence of an aqueous phase.

### Wettable Powder (WP)

In some embodiments, the dried solid can be made into a formulation that is a wettable powder (WP). In some embodiments, a WP formulation comprising nanoparticles of polymer-associated active ingredients (optionally in aggregate form) can be made from a dried (e.g., spray dried, freeze dried, etc.) dispersion of polymer nanoparticles and active ingredient. In some embodiments, a WP formulation comprising nanoparticles of polymer-associated active ingredients (optionally in aggregate form) can be made from a milled solid comprising polymer nanoparticles of active ingredient. In some embodiments, a WP is made by mixing the dried solid with a dispersant and/or a wetting agent. In some embodiments, a WP is made by mixing the dried solid or milled solid with a dispersant and/or a wetting agent. In some embodiments, a WP is made by mixing the dried or milled solid with a dispersant and a wetting agent. In some embodiments, the formulation of the final WP can be (by weight): up to about 98% nanoparticles of polymer-associated active ingredients (including both the active ingredient and the polymer, optionally in aggregate form). In some embodiments, the WP formulation includes (by weight): 0-5% dispersant, 0-5% wetting agent, 5-98% nanoparticles of polymer-associated active ingredients (optionally in aggregate form), and inert filler to 100%. In some embodiments, the formulation of the final WP can be (by weight): 0.5-5% dispersant, 0.5%-5% wetting agent, 5-98% nanoparticles of polymer-associated active ingredients (optionally in aggregate form), and inert filler to 100%. As described above in the Formulating Agents and Nanoparticles of polymer-associated active ingredient sections, a wide variety of formulating agent(s) and various concentrations of nanoparticles (including aggregates), wetting agents, dispersants, fillers and other formulating agents can be used to prepare exemplary formulations, e.g. wettable granules.

In some embodiments, the formulation of the final WP can be (by weight): 0.5-5% dispersant, 0.5%-5% wetting agent, 0.1-10% thickener (e.g., fumed silica which, as noted above may serve multiple functions, and/or xanthan gum), 5-98% nanoparticles of polymer-associated active ingredients (optionally in aggregate form). As described above in the Formulating Agents section, a wide variety of formulating agent(s) and various concentrations of wetting agents, dispersants, fillers and other formulating agents can be used to prepare exemplary formulations, e.g. wettable powders.

In some exemplary embodiments, described in more detail below, a WP formulation comprising nanoparticles of polymer-associated active ingredients (optionally in aggregate form) may be made from a dispersion of polymer nanoparticles and active ingredient in a common solvent, preferably methanol. In some embodiments, a WP formulation can be made by adding the dispersion in common solvent into an aqueous solution containing a wetting agent (e.g., a surfactant such as sodium dodecylbenzene sulfonate) and/or a dispersant (e.g., a lignosulfonate such as Reax 88B, etc.) and optionally an inert filler (e.g., lactose), and then drying (e.g., freeze drying, spray drying, etc.) the resulting mixture to from a solid powder. In some embodiments, poly(vinyl alcohol) is added to the solution prior to drying. In some embodiments a WP can be made using a wetting agent (e.g., a surfactant such as sodium dodecylbenzene sulfonate or dioctyl sulfosuccinate sodium salt) and a dispersant (e.g., a lignosulfonate such as Reax 88B, etc.).

In some exemplary embodiments, the polymer nanoparticles are made from a co-polymer of methacrylic acid and ethyl acrylate at about a 90:10 mass ratio. In some embodiments, the polymer nanoparticles are dispersed in a common solvent, preferably at a concentration of about 50 mg/mL. In some embodiments, the concentration of active ingredient is in the range between about 20 mg/mL to about 100 mg/mL. In some embodiments, the common solvent contains a wetting agent and/or dispersant as well. In some embodiments, the polymer nanoparticles are made from a co-polymer of methacrylic acid and (ethylene glycol)methyl ether methacrylate at about at a mass ratio of 7:3. In some embodiments, the polymer nanoparticles are made from a polymer of acrylic acid. In some embodiments, the polymer nanoparticles are made from a co-polymer of acrylic acid and styrene at about a 90:10 mass ratio. As described above in the Nanoparticles of polymer-associated active ingredient section, many ratios of co-polymer constituents can be used.

In some embodiments, the dispersion of polymer nanoparticles and active ingredient is then slowly added into a vessel containing a second solvent, preferably water. In some embodiments, the second solvent is at least 20 times larger in volume than the common solvent containing the polymer nanoparticles and active ingredient. In some embodiments, the second solvent contains a dispersant, preferably a lignosulfonate such as Reax 88B and/or a wetting agent, preferably a surfactant such as sodium dodecylbenzene sulfonate. In some embodiments a WP can be made using a wetting agent (e.g., a surfactant such as sodium dodecylbenzene sulfonate or dioctyl sulfosuccinate sodium salt) and a dispersant (e.g., a lignosulfonate such as Reax 88B, etc.).

In some embodiments, after the dispersion of polymer nanoparticles and active ingredient in a common solvent is mixed with a second solvent containing dispersant and/or wetting agent, the final mixture is dried (e.g., freeze dried) to obtain a solid powdered formulation containing nanoparticles of polymer-associated active ingredients (optionally in aggregate form). Optionally, the pH of the final mixture can be adjusted (e.g., by addition of acid or base solutions) as needed. Further, additional formulation agents (e.g., PVA solution) can also be added to the final mixture prior to drying.

### High Solids Liquid Suspension (HSLS)

One type of formulation that can be utilized according to the disclosure is a high solids liquid suspension. As described, such a formulation is generally characterized in that it is a liquid formulation that contains at least nanoparticles of polymer nanoparticles associated with active ingredient (includes potentially aggregates of the same). HSLS formulations most closely resemble suspension concentrate (SC) formulations and can be considered a subcategory SCs incorporating polymer nanoparticles which are associated or encapsulate the active ingredient and have a smaller average particle size.

In some embodiments, the formulation of the HSLS can be (by weight): between about 1 and about 75% nanoparticles of polymer-associated active ingredients (including both polymer and active ingredient, optionally in aggregate form), 0.5 and about 5% wetting agent and/or dispersant, between about 1 and about 10% anti-freezing agent, between about 0.1 and about 10% anti-foaming agent, between about 0.01 and about 0.1% preservative, between about 0.1 and 4% surfactant, and water up to 100% As described above in the Formulating Agents and Nanoparticles of polymer-associated active ingredient sections, a wide variety of formulating agent(s) and various concentrations of nanoparticles (including aggregates), wetting agents, dispersants, fillers and other formulating agents can be used to prepare exemplary formulations, e.g., a HSLS.

In some exemplary embodiments, described in more detail below, the polymer nanoparticles are made from a co-polymer of methacrylic acid and styrene at about a 75:25 mass ratio. In some exemplary embodiments, the polymer nanoparticles are dispersed in the common solvent, preferably at a concentration of up to about 20 mg/mL. In some exemplary embodiments, the active ingredient is difenoconazole and is mixed into the nanoparticle dispersion at a concentration of up to about 20 mg/mL. As described above in the Nanoparticles of polymer-associated active ingredient section, many ratios of co-polymer constituents can be used.

In some embodiments, the dispersion of polymer nanoparticles and active ingredient in a common solvent is slowly added into a vessel containing a second solvent, preferably water. In some embodiments, the second solvent is at least 20 times larger in volume than the common solvent containing the polymer nanoparticles and active ingredient. In some embodiments, the second solvent contains a dispersant, preferably a lignosulfonate such as Reax 88B and/or a wetting agent, preferably a surfactant such as sodium dodecylbenzene sulfonate. In some embodiments a HSLS can be made using a wetting agent (e.g., a surfactant such as sodium dodecylbenzene sulfonate) and a dispersant (e.g., a lignosulfonate such as Reax 88B, etc.).

In some embodiments, the HSLS formulations of current disclosure have an active ingredient content of about 5 to about 40% by weight, e.g., about 5-about 40%, about 5-about 35%, about 5-about 30%, about 5-about 25%, about 5-about 20%, about 5-about 15%, about 5-about 10%, about 10-about 40%, about 10-about 35%, about 10-about 30%, about 10-about 25%, about 10-about 20%, about 10-about 15%, about 15-about 40%, about 15-about 35%, about 15-about 30%, about 15-about 25%, about 15-about 20%, about 20-about 40%, about 20-about 35%, about 20-about 30%, about 20-about 25%, about 25-about 40%, about 25-about 35%, about 25-about 30%, about 30-about 40% or about 35-about 40%. As described above in the Nanoparticles of polymer-associated active ingredient section, many ratios of triazole to polymer can be used.

In some embodiments the HSLS formulations of current disclosure have an active ingredient content of about 5%, about 10%, about 15%, about 20%, about 25%, about 30%, about 35% or about 40% by weight.

### Methods of Making HSLS—Generally

In some embodiments, a HSLS comprising nanoparticles of polymer-associated active ingredient (optionally in aggregate form) can be made from a dispersion of polymer nanoparticles and active ingredient in a common solvent or from a dried form of the dispersion (e.g., spray dried). In some embodiments, a HSLS formulation comprising nanoparticles of polymer-associated active ingredients (optionally in aggregate form) can be made from a milled solid comprising polymer nanoparticles of active ingredient.

### Methods of Making HSLS—Milling Methods

In some embodiments, a HSLS formulation comprising nanoparticles of polymer-associated active ingredients (optionally in aggregate form) can be prepared via milling. Several exemplary methods and the resulting HSLS formulations are described below and in the Examples. In some embodiments, a solid formulation of nanoparticles of polymer-associated active ingredient (optionally in aggregate form), prepared as described in this disclosure (e.g., via milling, spray drying etc.) may be further milled in the presence of one or more formulating agents and water. In some embodiments a HSLS can be made by milling a solid formulation nanoparticles of polymer-associated active ingredients in the presence of water and one more of an anti-freezing agent, (optionally more than one of) a wetter and/or dispersant, an antifoaming agent, a preservative, and a thickening agent. Further, in some embodiments, the active ingredient and polymer nanoparticles are milled together to produce nanoparticles of polymer-associated active ingredients, which may then be further milled according to the processes described below.

In some embodiments, the milling process is performed in separate phases (i.e., periods of time), with the optional addition of one or more formulating agent between each milling phase. One of ordinary skill in the art can adjust the length of each phase as is appropriate for a particular instance. In some embodiments, the contents of the milling vessel are cooled between one or more of milling phases (e.g., via placement of the milling jar in an ice bath). One of ordinary skill in the art can adjust the length of cooling period as is appropriate for a particular instance.

In some embodiments, a HSLS can be made by first milling a solid formulation of nanoparticles of polymer-associated active ingredients in the presence of (optionally more than one of) a wetter and/or dispersant in one milling vessel for a certain amount of time (e.g., about 30 minutes-about 1 day), then this mixture is transferred to another milling vessel containing water and optionally one or more of an anti-freezing agent, additional wetter and/or dispersant, an anti-freezing agent, an antifoaming agent, a preservative, a thickening agent, and milling the components together. As described above in the Formulating Agents section, a wide variety of additional formulating agent(s) and various concentrations of wetting agents, dispersants, fillers and other formulating agents can be used in preparation of exemplary formulations.

In some embodiments, a HSLS formulation comprising nanoparticles of polymer-associated active ingredients (optionally in aggregate form) can be prepared via milling pre-formed polymer nanoparticles and active ingredient in the presence of one or more formulating agents and water. In some embodiments, a HSLS can be made by milling preformed polymer nanoparticles and active ingredient in the presence of water and optionally one more of an anti-freezing agent, additional wetter and/or dispersant, an anti-freezing agent, an antifoaming agent, a preservative, and a thickening agent. Again, as described above in the Formulating Agents section, a wide variety of additional formulating agent(s) and various concentrations of wetting agents, dispersants, fillers and other formulating agents can be used in preparation of exemplary formulations. In some embodiments, all of the ingredients can be added together and milled together.

And as in the embodiment described above in which nanoparticles of polymer-associated active ingredients are milled in a two milling vessel procedure, such a procedure can be used in preparing a HSLS from pre-formed polymer nanoparticles. In some embodiments such an HSLS can be made by first milling a solid formulation nanoparticles of polymer-associated active ingredients in the presence of (optionally more than one of) a wetter and/or dispersant in one milling vessel for a certain amount of time (e.g., about 30 minutes-about 1 day), transferring the milled components to another milling vessel containing water and optionally one or more of an anti-freezing agent, additional wetter and/or dispersant, an anti-freezing agent, an antifoaming agent, a preservative and a thickening agent. Milling methods to produce HSLS formulations as described above may include any of those referred to in any other portion of the specification including the Examples below. Any type of mill noted in any portion of the specification may also be used to prepare HSLS formulations via milling.

### Methods of Making HSLS—Mixing & Drying Methods

In some embodiments, a HSLS formulation is prepared without milling, but instead by mixing the components of the formulation. These methods may also include drying the formulations to increase the solids content of the formulation so that it is suitable as a HSLS. All of these methods are described in more detail below and exemplary methods are shown in the Examples.

In some embodiments, a HSLS formulation comprising nanoparticles of polymer-associated active ingredients (optionally in aggregate form) can be made from the dispersion of polymer nanoparticles and active ingredient in a common solvent, (e.g., methanol). In some embodiments, the dispersion is added to an aqueous solution containing a wetting agent and a dispersant, an anti-freezing agent (and optionally an anti-settling agent or thickener and a preservative). The mixture is then concentrated by removing solvent, e.g., by drying, until the desired high solids formulation is attained.

In some exemplary embodiments, after the dispersion of polymer nanoparticles and active ingredient in a common solvent is mixed with a second solvent containing a wetting agent and/or dispersant and an anti-freezing agent (optionally with an anti-settling agent or thickener and a preservative), the final mixture is concentrated by removing most of the common solvent and second solvent until a final formulation with a target solids content (e.g., at least 60% solids) is obtained. In some embodiments, the method used to concentrate the solution is vacuum evaporation. In some embodiments, a second solvent containing a wetting agent and/or dispersant and an anti-freezing agent (optionally with an anti-settling agent or thickener and a preservative) are added after the mixture has already been concentrated. As described above in the Nanoparticles of polymer-associated active ingredient section, many ranges of solids content can be achieved.

In some embodiments, the dispersion of polymer nanoparticles and active ingredient in a common solvent is added to a second solvent to form a solution of nanoparticles of polymer-associated active ingredients (optionally in aggregate form). The second solvent is typically miscible with the common solvent and is usually water, but in some embodiments, the second solvent can also be a mixture of water with a third solvent, usually an alcohol, preferably methanol or ethanol. In some embodiments, the second solvent or mixture of solvents is only partially miscible with the common solvent. In some embodiments, the second solvent or mixture of solvents is not miscible with the common solvent. In some embodiments, the HSLS formulation is stable after 1-2 months of continuous temperature cycling between −5° C. and 45° C. showing no visible signs of phase separation, remains flowable, and can easily be dispersed in water at the use rate.

In some embodiments, a HSLS is made by reconstituting the dried dispersion (e.g., freeze dried) of nanoparticles of polymer-associated active ingredients in water to obtain a formulation with a target solids content (e.g., at least 60% solids) is obtained and then adding an anti-freezing agent (and optionally a thickening agent and a preservative) to the final mixture. In some embodiments, a HSLS is made by reconstituting the milled (e.g., ball-milled) solid of nanoparticles of polymer-associated active ingredients in water to obtain a formulation with a target solids content (e.g., at least 60% solids) and then adding an anti-freezing agent (and optionally at least one thickening agent (e.g., fumed silica and/or xanthan gum), an antifoaming agent and a preservative) to the final mixture. In some embodiments, the HSLS is made by homogenizing all the components together. In some embodiments the HSLS is made by milling all the components together.

In some embodiments, a HSLS is made by mixing the dried dispersion (e.g., spray dried) with a wetting agent, preferably a surfactant such as sodium dodecylbenzene sulfonate, a solvent, preferably but not limited to water, and/or a dispersant, preferably, but not limited to a lignosulfonate such as Reax 88B, and an anti-freezing agent, preferably but not limited to ethylene glycol, in a high sheer mixer until a stable HSLS is obtained. In some embodiments a wetting agent, preferably a surfactant such as sodium dodecylbenzene sulfonate, a solvent, preferably but not limited to water, and a dispersant, preferably, but not limited to a lignosulfonate such as Reax 88B are included. In some embodiments, a preservative, preferably propionic acid and an anti-settling agent or thickener, preferably but not limited to fumed silica and/or a water dispersible agent like xanthan gum are also included.

### Efficacy and Application

### General Applications and Efficacy

As noted previously and in the Examples, in some embodiments, the disclosure provides formulations of triazole compounds that have either improved curative, translocation and/or systemic fungicidal properties. In some embodiments, the triazole formulations of the present disclosure demonstrate improved preventative activity compared to commercial formulations of the same active ingredient, which suggests that they may be applied at lower effective rates in preventative applications. In some embodiments, the triazole formulations of the present disclosure demonstrate enhanced curative properties compared to commercial formulations of the same active ingredient, which suggests that they may be applied at lower effective rates in curative applications. Without wishing to be limited by any theory, it is thought that the enhanced curative properties are due to increased foliar penetration or translocation of triazoles formulated according to the present disclosure compared to triazoles of commercially available formulations. In some embodiments, the triazole formulations of the current disclosure can be applied at lower effective rates than commercial formulations for the control of fungal plant disease. In some embodiments, the triazole is difenoconazole.

In general, different triazoles are typically applied at different effective rates between 10-400 gram of active ingredient (e.g. triazole) per hectare depending on the efficacy of the triazole (e.g., absolute potency of the active and retention at the site of activity), as well as conditions related to the crop being treated, leaf type, environmental conditions, the species infesting the crop, infestation levels, and other factors. As discussed above, improvements in the formulation according to the current disclosure, such as increased UV stability, physical retention at the site of action, residual activity, systemic absorption, or enhanced curative activity can reduce the user rates. Some embodiments demonstrate improvements over typical commercial formulation, which suggests that lower rates of effective application could be used. In some embodiments, rates may range from between about 0.1 and about 400 g/hectare, preferably between about 0.1 and about 200 g/hectare, more preferably between about 0.1 and about 100 g/hectare, more preferably between about 0.1 and about 10g/hectare or more preferably between about 0.1 and about 1g/hectare. In some embodiments, rates may range from between about 1 g and about 400 g/hectare, preferably between about 1 and about 200 g/hectare, more preferably between about 1 and about 100 g/hectare, or more preferably between about 1 and about 10 g/hectare. In some embodiments, rates may be any of the rates or ranges of rates noted in any other portion of the specification.

### General Application & Comparison to Current Commercial Formulations

In some embodiments, the disclosure provides methods of using formulations of nanoparticles of polymer-associated triazoles. In some embodiments, the formulations are used to inoculate a target area of a plant. In some embodiments, the formulations are used to inoculate a part or several parts of the plant, e.g., the leaves, stem, roots, flowers, bark, buds, shoots, and/or sprouts.

In some embodiments, a formulation comprising nanoparticles of polymer-associated active ingredients and other formulating agents is added to water (e.g., in a spray tank) to make a dispersion that is about 10 to about 2,000 ppm in active ingredient. In some embodiments, the dispersion is about 10 to about 1,000 ppm, about 10 to about 500 ppm, about 10 to about 300 ppm, about 10 to about 200 ppm, about 10 to about 100 ppm, about 10 to about 50 ppm, about 10 to about 20 ppm, about 20 to about 2,000 ppm, about 20 to about 1,000 ppm, about 20 to about 500 ppm, about 20 to about 300 ppm, about 20 to about 200 ppm, about 20 to about 100 ppm, about 20 to about 50 ppm, about 50 to about 2,000 ppm, about 50 to about 1,000 ppm, about 50 to about 500 ppm, about 50 to about 300 ppm, about 50 to about 200 ppm, about 50 to about 100 ppm, about 100 to about 2,000 ppm, about 100 to about 1,000 ppm, about 100 to about 500 ppm, about 100 to about 300 ppm, about 100 to about 200 ppm, about 200 to about 2,000 ppm, about 200 to about 1,000 ppm, about 200 to about 500 ppm, about 200 to about 300 ppm, about 300 to about 2,000 ppm, about 300 to about 1,000 ppm, about 300 to about 500 ppm, about 500 to about 2,000 ppm, about 500 to about 1,000 ppm, about 1000 to about 2,000 ppm.

As used in the specification, inoculation of a plant with a formulation of the current disclosure may, in some embodiments, refer to inoculation of a plant with a dispersion (e.g., in water or an aqueous medium optionally further comprising other additive such as adjuvants, surfactants etc.) prepared from a formulation of the present disclosure as described above. It is to be understood that the term formulation may also encompass dispersions for applications as described (e.g., inoculation of a plant). It should also be understood that methods that describe the use of triazole formulations of the present disclosure e.g., “use of formulations of the present disclosure to inoculate a plant,” “use of the formulations of the present disclosure to control fungal diseases” and the like, encompass the preparation of a dispersion of the active ingredient in water or an aqueous medium (optionally further comprising other additives such as adjuvants, surfactants etc.) for the purpose of inoculating a plant.

In some embodiments, a dispersion is produced and used to inoculate a plant with active ingredient at less than about 75% of a use rate listed on a label of a currently available commercial product of the same active ingredient. In some embodiments, a dispersion is produced to inoculate a plant with active ingredient at less than about 60% of a use rate listed on the label of a currently available commercial product of the same active ingredient. In some embodiments, a dispersion is produced to inoculate a plant with active ingredient at less than about 50% of a use rate listed on the label of a currently available commercial product of the same active ingredient. In some embodiments, a dispersion is produced to inoculate a plant with active ingredient at less than 40% of a use rate listed on the label of a currently available commercial product of the same active ingredient. In some embodiments, a dispersion is produced to inoculate a plant with active ingredient at less than 30% of a use rate listed on the label of a currently available commercial product of the same active ingredient. In some embodiments, a dispersion is produced to inoculate a plant with active ingredient at less than 25% of a use rate listed on the label of a currently available commercial product of the same active ingredient. In some embodiments, a dispersion is produced to inoculate a plant with active ingredient at less than 20% of a use rate listed on the label of a currently available commercial product of the same active ingredient. In some embodiments, a dispersion is produced to inoculate a plant with active ingredient at less than 10% of a use rate listed on the labels of a currently available commercial product of the same active ingredient. In some embodiments, a dispersion is produced to inoculate a plant with active ingredient at less than 5% of the use rate listed on a label of a currently available commercial product of the same active ingredient. In some embodiments, the triazole formulations of the present disclosure are used to inoculate a plant at an active ingredient use rate that is about 75%, about 60%, about 50%, about 40%, about 30%, about 25%, about 20% or about 10% of a use rate listed on the labels of currently available fungicide products. Fungicide labels can be referenced from commercial suppliers and are readily accessible and available.

In preferred embodiments, the formulations of the current disclosure may be used to control fungal disease at an active ingredient use rate that is lower than the minimum rate of a range of rates listed on the label of a commercially available product. In some embodiments, formulations of the current disclosure may be used to control fungal disease at an active ingredient use rate that is less than about 75%, less than about 60%, less than about 50%, less than about 40%, less than about 30%, less than about 25%, less than about 20% or less than about 10% of the minimum use rate of a range of rates listed on the label of a commercially available product.

### Low Concentration Application

In some cases, a triazole formulation is applied to the plant at a concentration below the triazole's solubility limit in water. Although the active ingredient is soluble in water at these low concentrations, the triazole's activity is still affected by the way it is formulated. This is surprising as it demonstrates that the triazole is still associated with the polymer particle even when applied below its solubility limit. At concentrations below the solubility limits it is expected that the triazoles would behave the same, or at least in a very similar fashion, regardless of the formulations, especially with respect to biological functions described above. This is because the triazoles are still hydrophobic and thus, thought to still have low soil mobility, lack systemic effects and display the traits of traditional triazole and traditional triazole formulations.

In some embodiments, however, a formulation with nanoparticles or aggregates of nanoparticles of polymer associated triazole compound is shown to be more active (e.g., have systemic or curative effects) than commercially available suspension concentrates of a triazole when applied at a use rate below the solubility limit. Comparative example is described below in the Examples section. In some embodiments, the triazole is difenoconazole. In some embodiments, the polymer nanoparticles associated with the triazole compound is made from a copolymer of methacrylic acid and styrene at a mole ratio of ˜75:25 (MAA:S) though other ratios and monomers, as described above, are applicable. In some embodiments, the formulation includes a wetter, dispersant and filler.

### Hard Water/Fertilizer Applications

As described below, most traditional formulations produce solid particles (floc) or a precipitate when mixed in with high salt, hard water or fertilizer solutions. Surprisingly, a dispersed solid formulation of a triazole (e.g., difenoconazole) of the current disclosure was stable (e.g., components, difenoconazole and the salt, remained disperse, i.e., no visible sedimentation or floc) when mixed with a concentrated/high salt solution (e.g., hard water, buffer, concentrated fertilizer formulation) for at least 3 hours. This was true even for waters with ionic strength as high as 8000 ppm Mg²⁺ (a.k.a. CIPAC “G” hard water). It is important to note that for such a mixture to be useful for the end user, the mixture should remain stable (i.e., no formation of sediments and/or flocs) within at least about 30-40 minutes—which is typically the time it takes for the mixture to be applied to the plant. It is surprising that the formulations of the present disclosure are stable in such high-salt conditions. Because the polymers that are used in the nanoparticles of the present disclosure are negatively charged, a practitioner of the art would expect the formulations of the present disclosure to flocculate when mixed with such a high amount of divalent salt. Without being limited by theory, it is believed that the increased stability of the formulations of the present disclosure arises from the use of nanoparticulate polymers as the delivery system and that if standard non-nanoparticle polymers were used then flocculation would occur

Traditional solid or liquid formulations are not stable under conditions of high ionic (i.e., a high salt solution) strength. Sources of increased ionic strength can include, for example, mineral ions that are present in the water that a formulation is dispersed in. For example, in many cases the water that is available to a farmer is taken from a high-salt (“hard water”) source such as a well or aquifer. Water that a grower uses can be variably hard and is normally measured as Ca²⁺ equivalents. Ranges of water salinity can be from ˜0 ppm Ca²⁺ equivalent (deionized water) to 8000 ppm Ca²⁺ or more.

Other sources of increased ionic strength can include, for example, other chemicals or materials that dispersed in the spray tank water before or after the addition of the fungicide formulation. Examples of this include mineral additives such as micronutrients (which can include e.g., B, Cu, Mn, Fe, Cl, Mo, Zn, S) or traditional N—P—K fertilizers where the nitrogen, phosphorus, or potassium source is in an ionic form as well as other agro-chemicals (e.g., pesticides, herbicides, etc.). In some embodiments, the fertilizer can be, for example, 10-34-0 (N—P—K), optionally including one or more of sulfur, boron and another micronutrient. In some cases, the nitrogen source is in the form of urea or an agriculturally acceptable urea salt. The fertilizer can include e.g., ammonium phosphate or ammonium thiosulphate.

In some embodiments described below in the Examples, the formulations of the current disclosure were mixed with a concentrated/high salt solution. Though the specifics of the hard test are described in Examples below, generally, the exemplary procedure is as follows: Formulations described herein were mixed with different hard water standards, each with a different degree of hardness (e.g., CIPAC H standard water (in the example below: 634 ppm hardness, pH 6.0-7.0, Ca²⁺:Mg²⁺=2.5:1), CIPAC J standard water (6.34 ppm hardness, pH 6.0-7.0, Ca²⁺:Mg²⁺=2.5:1) and CIPAC G standard water (8000 ppm hardness, pH 6.0-7.0, Mg²⁺)) at an active ingredient concentration of 200 ppm. In some embodiments, the formulations dispersed well and were stable for at least an hour, with no signs of the formation of flocs or sediments.

In some cases, the formulations of the present disclosure can be applied simultaneously with a high-salt solution or suspension such as a micronutrient solution, a fertilizer, pesticide, herbicide solution, or suspension (e.g., in furrow application). The ability to mix and apply triazoles with other agricultural ingredients such as liquid fertilizers is very useful to growers, as it reduces the number of required trips across crop fields and the expenditure of resources for application. In some cases, the formulations of the present disclosure may be mixed with liquid fertilizers of high ionic strength. In some cases the fertilizer is a 10-34-0 fertilizer, optionally including one or more of sulfur, boron and another micronutrient. In some cases, the nitrogen source is in the form of urea or an agriculturally acceptable urea salt. In some embodiments, the liquid fertilizer comprises a glyphosate or an agriculturally acceptable salt of glyphosate (e.g., ammonium, isopropylamine, dimethylamine or potassium salt). In some embodiments, the liquid fertilizer may be in the form of a solution or a suspension. In some embodiments, formulations of the present disclosure are stable when mixed with liquid fertilizers of increased or high ionic strength (e.g., at any of the ionic strengths described below). In some embodiments, when mixed with liquid fertilizers formulations of the current disclosure show no signs of sedimentation or flocculation. In some embodiments, the triazole is difenoconazole.

Other potential additives that might be added into a spray tank that are charged and can decrease the stability of an agrochemical formulation include charged surfactants or polymers, inert ingredients such as urea, or other similar ingredients.

In some embodiments, the present disclosure provides compositions of a formulation of nanoparticles of polymer-associated active ingredients that are redispersible in solutions with high ionic strength. In some embodiments, the present disclosure also provides compositions of a formulation of nanoparticles of polymer-associated active ingredients that can be redispersed in water and then have a high salt solution or solid salt added and maintain their stability. In some embodiments, the formulations of the present disclosure are stable when dispersed in or dispersed in water and then mixed with solutions with ionic strength corresponding to Ca²⁺ equivalents of about 0 to about 1 ppm, about 0 to about 10 ppm, about 0 to about 100 ppm, about 0 to about 342 ppm, about 0 to about 500 ppm, about 0 to about 1000 ppm, about 0 to about 5000 ppm, about 0 to about 8000 ppm, about 0 to about 10000 ppm, about 1 to about 10 ppm, about 1 to about 100 ppm, about 1 to about 342 ppm, about 1 to about 500 ppm, about 1 to about 1000 ppm, about 1 to about 5000 ppm, about 1 to about 8000 ppm, about 1 to about 10000 ppm, about 10 to about 100 ppm, about 10 to about 342 ppm, about 10 to about 500 ppm, about 10 to about 1000 ppm, about 10 to about 5000 ppm, about 10 to about 8000 ppm, about 10 to about 10000 ppm, about 100 to about 342 ppm, about 100 to about 500 ppm, about 100 to about 1000 ppm, about 100 to about 5000 ppm, about 100 to about 8000 ppm, about 100 to about 10000 ppm, about 342 to about 500 ppm, about 342 to about 1000 ppm, about 342 to about 5000 ppm, about 342 to about 8000 ppm, about 342 to about 10000 ppm, about 500 to about 1000 ppm, about 500 to about 5000 ppm, about 500 to about 8000 ppm, about 500 to about 10000 ppm, about 1000 to about 5000 ppm, about 1000 to about 8000 ppm, about 1000 to about 10000 ppm, about 5000 to about 8000 ppm, about 5000 to about 10000 ppm, about 8000 to about 10000 ppm.

### Plant Health Applications

In some embodiments, the present disclosure provides formulations of triazoles that have both protective and curative activity. These formulations can be used as protective fungicides, curative fungicides, or as fungicides in both protective and curative applications. These formulations can be used at concentrations and use rates that correspond to any of the values or ranges of values noted above or in other portions of the Efficacy and Application Section.

In some embodiments, application of formulations of the present disclosure to plants (e.g., crop plants) of the present disclosure results in a yield increase (e.g., increased crop yield). In some embodiments, there is a yield increase compared to untreated crops. In some embodiments, there is an increase compared to crops that have been treated with a commercial formulation of the same active ingredient. In some embodiments, there is yield increase of about 2 to about 100%, e.g., 2-3%, 2-5%, 2-10%, 2-30%, 2-50%, 2-100%, 5-7%, 5-10%, 5-20%, 5-30%, 5-40%, 5-50%, 5-60%, 5-70%, 5-80%, 5-90%, 5-100%, 10-20%, 10-30%, 10-40%, 10-50%, 10-60%, 10-70%, 10-80%, 10-90%, 20-40%, 20-60%, 20-80%, 20-100%, 30-50%, 30-60%, 30-80%, 30-100%, 40-60%, 40-80%, 40-100%, 50-80%, 50-100%, 60-80%, 60-100%, 70-90%, 70-100% or 80-100%

In some embodiments, the use of the triazole formulations of the present disclosure results in a yield increase of about 2%, about 3%, about 4%, about 5%, about 6%, about 7%, about 10%, about 20% , about 30%, about 40%, about 50%, about 60%, about 70%, about 80%, about 90% or about 100% . In some embodiments, there is yield increase of greater than about 2%, greater than about 5%, greater than about 10%, greater than about 20%, greater than about 30%, greater than about 40%, greater than about 50%, greater than about 60%, greater than about 70%, greater than about 80%, greater than about 90% or greater than about 100%. In some embodiments, the use of the triazole formulations of the present disclosure in plant health applications results in a yield increase of greater than about 10%, greater than about 20%, greater than about 30%, about 40%, about 50%, about 60%, about 70%, about 80%, about 90% or about 100%. In some embodiments, there is an increase in yield of greater than about 10%, greater than about 20%, greater than about 30%, greater than about 40%, greater than about 50%, greater than about 60%, greater than about 70%, greater than about 80% , greater than about 90% or greater than about 100%. Yield increases may be relative to untreated control plants (e.g., plants that have not been treated with formulations of the present disclosure), or plants treated with currently available commercial products.

In some embodiments, inoculation of plants with formulations of the present disclosure provides an increased crop yield as described above, at an active ingredient use rates that are lower than the use rates listed on commercially available products of the same active ingredient. In some embodiments, the increased yield can correspond to any of the values or ranges of values noted above. In some embodiments, the increased yield is observed at an active ingredient use rate that is less than about 75%, less than 60%, less than 50%, less than 40%, less than 30%, less than 20% or less than 10% of a rate listed on the label of commercially available fungicide product of the same active ingredient. In some embodiments, the increased yield is observed at an active ingredient use rate that is about 75%, about 60%, about 50%, about 40%, about 30%, about 20% or about 10% of a rate listed on a label of a commercially available fungicide product of the same active ingredient. Labels of commercially available formulations often provide ranges of active ingredient use rates to inoculate plants. In some embodiments, inoculation of plants with a formulation of the present disclosure provides an increased crop yield at an active ingredient use rate that is lower than the minimum use rate of a range of use rates listed on the label of a commercially available product. In some embodiments inoculation of plants with a formulation of the present disclosure provides an increased crop yield at a use rate that is less than about 75%, less than about 60%, less than about 50%, less than about 40%, less than about 30%, less than about 20% or less than about 10% of the minimum use rate of a range of use rates listed on the label of a commercially available product.

Without wishing to be limited by any theory, in some embodiments, it is thought that increased yield is due enhanced plant health of plants treated with formulations of the present disclosure. As used herein, plant health refers to the overall condition of the plant, including its size, sturdiness, optimum maturity, consistency in growth pattern and reproductive activity. As mentioned above, optimizing and enhancing such factors is a goal of plant breeders. As used herein, increased or enhanced plant health can also refer to increased yield of one sample or set of crops (e.g., a crop field treated with fungicide) compared to another sample or set of the same crops (e.g., an untreated crop field).

The enhancement of plant health by applications of triazole fungicides is thought to be due to a number of factors, as discussed above. These include combating hidden and undiagnosed diseases, as well as and triggering of plant growth regulator effects. Additionally it is thought that yield increases are a result of control of soil-borne disease or pests. In some embodiments, the triazole formulations of the present disclosure can be used to enhance plant health at an active ingredient use rate that is lower than the rate listed on the labels of currently available commercial curative fungicide products of the same active ingredient.

Without wishing to be limited by any theory, in some embodiments, it is thought that the formulations of the present disclosure can be used to enhance plant health at an active ingredient use rate that is lower than the rate listed on commercially available products of the same active ingredient due to their enhanced curative properties, ability to combat soil-borne disease, hidden disease and act as a more efficient plant growth regulator. Without wishing to be limited by any theory, it is though that in some embodiments, the enhanced properties are due to enhanced foliar penetration and/or translocation. Without wishing to be limited by any theory it is thought that in some embodiments, the formulations of the present disclosure are more effective at combating hidden disease because of their enhanced residual activity, which increases the window of opportunity for successful application timing.

### Direct Soil & Seed Applications

In some embodiments, formulations of the current disclosure may be used to control fungal disease of plants (including seeds) by application to soil (inoculation of soil). The formulations of the current disclosure may be used to control fungal disease via application to the soil in which a plant is to be planted prior to planting (i.e., as pre-plant incorporated application). In some embodiments, the formulations of the present disclosure are used to control fungal disease via inoculation of the seed and soil at the time of seed planting (e.g., via an in-furrow application or T-banded application). The formulations of the current disclosure may also be applied to soil after planting but prior to emergence of the plant (i.e., as a pre-emergence application). In some embodiments, soil is inoculated with a formulation of the current disclosure via an aerosol spray or pouring.

In some embodiments, the triazole formulations of the current disclosure may be used to control fungal diseases in the aforementioned applications at an active ingredient use rate that is lower than the use rate listed on the labels of commercially available formulations of the same active ingredient, as described above.

In some embodiments, the triazole formulations of the current disclosure can be used to control fungal disease when applied to seeds (e.g., via seed coating). In some embodiments, the formulations of the current disclosure are used to control fungal disease when applied to seeds at an active ingredient use rate that is less than the use rate of commercially available formulations of the same active ingredient. In some embodiments, a formulation of the present disclosure is used to control fungal diseases when applied to seeds at an active ingredient use rate that is less than about 75%, less than about 60%, less than about 50%, less than about 40%, less than about 30%, less than about 20% or less than about 10%, of a use rate listed on the label of a currently available commercial triazole product of the same active ingredient. In some embodiments, a formulation of the present disclosure are used to control fungal disease when applied to seeds at an active ingredient use rate that is about 75%, about 60%, about 50%, about 40%, about 30%, about 20% or about 10%, of a rate listed on the label of a currently available triazole product of the same active ingredient. In some embodiments, commercially available products provide ranges of active ingredient use rates to control fungal disease when applied to seeds.

### Increased Re-Application Interval

Due to their enhanced curative and preventative properties, in some embodiments, the formulations of the present disclosure can be applied at greater time intervals (i.e., the time between distinct inoculations) than currently available formulations of the same active ingredient. Inoculation intervals can be found on the labels of currently available commercial formulations and are readily accessible and available. In some embodiments, the formulations of the present disclosure are applied at an interval that is 1 day, 2 days, 3 days, 4 days, 5 days, 6 days, 7 days, 8 days, 9 days, 10 days, 11 days, 12 days, 13 days, 14 days or 15 days longer than commercial formulations of the same active ingredient. In some cases, commercial formulations are applied at intervals that correspond to a range of intervals (e.g., 7-14 days). In such cases, it is contemplated that the formulations of the present disclosure can be applied at a range of intervals whose shortest endpoint, longest endpoint, or both shortest and longest endpoint are longer than the corresponding endpoints of currently available commercial formulations by any of the values noted above. In some embodiments, the triazole formulations of the present disclosure can be applied at an intervals of 5 days, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days, 24 days, 25 days, 26 days, 27 days, 28 days, 29 days, 30 days, 31 days, 32 days, 33 days, 34 days, 35 days, 36 days, 37 days, 38 days, 39 days or 40 days. In some embodiments, the formulations of the present disclosure can be applied at a range from which the shortest and longest intervals (endpoints) are taken from any of the aforementioned values.

### Specific Application (Plant & Fungi)

In some embodiments, the inoculation method is applied to individual plants or fungi, or to large groups of plants and fungi. In some embodiments, the formulation is inoculated to the target organism by means of dipping the target organism or part of the organism into the dispersion containing the formulation. In some embodiments, the formulation is inoculated to the target species (plant or fungi) by means of an aerosol spray. In some embodiments, the formulation is inoculated to the target species (plant) by spraying the dispersion directly onto the leaves, stem, bud, shoot or flowers of the plant. In some embodiments, the formulation is inoculated to the target species (plant) by pouring the dispersion directly onto the root zone of the plant. In some embodiments, the target organism (e.g., the plant on which fungus is to be controlled or the fungus is inoculated by means of dipping the plant or a part of parts of the target plant into a dispersion of active ingredients prepared as described above. Formulations of the current invention can also be applied in conjunction with irrigation systems and via water for irrigation.

The triazole formulations of the present disclosure can be used to control fungal disease of a variety of plants. In some embodiments, the plant is selected from the classes fabaceaae, brassicaceae, rosaceae, solanaceae, convolvulaceae, poaceae, amaranthaceae, laminaceae and apiaceae.

In some embodiments, the plant is selected from plants that are grown for turf, sod, seed (e.g., grasses grown for seed), pasture or ornamentals. In some embodiments, the plant is a crop, including but not limited to cereals (e.g., wheat, maize, including field corn and sweet corn, rice, barley, oats etc.), soybean, cole crops, tobacco, oil crops, cotton, fruits (e.g., pome fruits such as but not limited to apples and pears), vine crops (e.g., cucurbits), legume vegetables, bulb vegetables, rapeseed, potatoes, greenhouse crops, and all other crops on which triazoles are known to control fungal disease. Lists of plants on which fungal diseases are controlled by specific commercially available triazole formulations can be found on their labels, which are readily accessible and available.

In some embodiments, the formulations of the current disclosure can be applied to turf, sod, seed, pasture or ornamental in combination with other pesticides (e.g., insecticides, fungicides, herbicides). In particular, fungicides with a different mode of action from the triazole may be used to mitigate resistance development in targeted fungi. Exemplary additional fungicides include strobilurins (e.g., azoxystrobin, trifloxystrobin, pyraclostrobin, fluoxastrobin), aromatic fungicides (e.g., chlorothalonil), conazoles, dicarboximides, benzimidazoles, carbamates, and others. For example, to treat the turf anthracnose (E.g., Colletotrichum spp., Colletotrichum cerealis) fosetyl-Al, several different strobilurins, mancozeb, chlorothalonil, amongst others, can be used in combination with the disclosed formulations. Combination applications are not necessarily limited to combination of two active ingredients, but tertiary, quaternary and combinations of five active ingredients are more are possible with the formulations of the current disclosure.

In some embodiments, the formulations of the current disclosure are used to control fungal diseases in turf, ornamental and non-crop applications (uses). Examples of these applications can be found on the labels of currently available triazole formulations, such as the labels referenced in other portions of the specification. Non-limiting examples of turf, ornamental and non-crop applications in which the formulations of the present disclosure can be used include the control of fungal diseases of turf (e.g., lawns and sod) in residential areas, athletic fields, parks, and recreational areas such as golf courses. Formulations of the present disclosure may also be used to control fungal diseases of ornamentals (e.g., shrubs, ornamental trees, foliage plants etc.), including ornamentals in or around any of the aforementioned areas, as well as in greenhouses (e.g., those used for growth of ornamentals). Examples of fungi that can be controlled in turf, ornamental and non-crop applications, include those listed as fungi turf, ornamental and non-crop applications in any other portion of the specification or in any of the labels of currently available triazole products used to control fungi in turf, ornamental and non-crop applications (such as the those referenced in other portions of the specification).

In some embodiments, the fungus to be controlled by the formulations of the present disclosure is selected from the classes ascomycota, basidiomycota, deuteromycota, blastocladiomycota, chytridiomycota, glomeromycota and combinations thereof.

Examples of fungal diseases that can be controlled with formulations of the current disclosure include but are not limited to various blights, spots and rusts, rots, blasts and smuts and combinations thereof.

In some embodiments, the plant (e.g., crop) on which fungal disease can be controlled by formulations of the present disclosure may depend on, among other variables, the active ingredient, inclusion of other components into the formulation, and the particular application. Common commercial formulations frequently include labels and instructions describing the compatibility of actives, inclusion of additives, tank mixes with other products (e.g., surfactants) labeled fungi, instructions and restrictions for particular applications and uses as well as other information. Such labels and instructions pertinent to the formulations of the present disclosures and their application are also contemplated as part of the present disclosures. Labels are readily accessible from manufacturers' websites, or via centralized internet databases such as Greenbook (http://www.greenbook.net/) or the Crop Data Management Systems website (www.cdms.net).

In some embodiments, the triazole of the present disclosure is difenconazole, tebuconazole, cyproconazole, epoxiconazole, flutriafol, ipconazole, metconazole, or propiconazole.

### EXAMPLES

### I: Formulations

In the following formulation examples (1, 8 -10), particle sizes were measured by DLS using a Malvern Zetasizer ZS, except Examples 19 and 20.

### Example 1

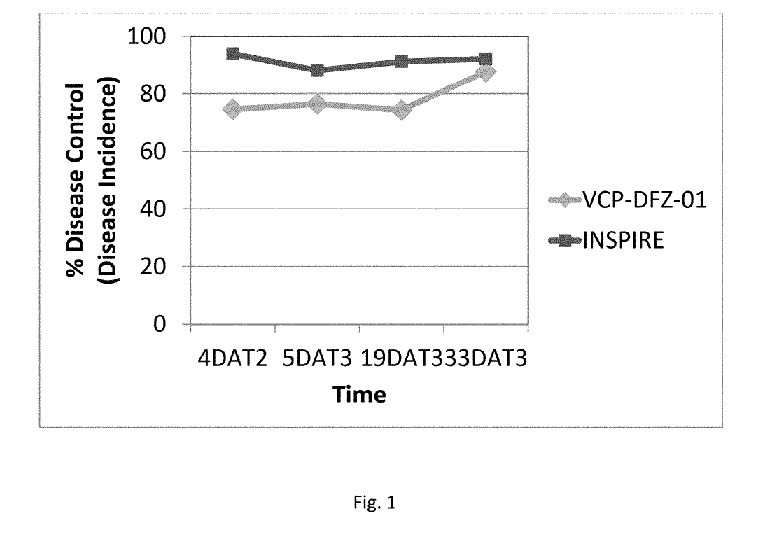

### Preparation of a HSLS Formulation of Nanoparticles or Aggregates of Nanoparticles of Polymer-Associated Difenoconazole via Ball-Milling [Nanoparticles Derived from p(MAA-co-S) poly(methacrylic acid-co-styrene); 3:1 Ratio of Difenoconazole:Nanoparticles] Field Trial Code: VCP-DFZ-01 in Example 3-Example 7 Below and FIGS. 1-10

136.7 g of technical grade difenoconazole (Pacific Agriscience, 95% purity), 43.33 g of nanoparticles derived from poly(MAA-co-S) [MAA:S ratio=approximately 75:25 by weight], 14.44 g of Geropon T-77, 21.67 g of Geropon TA/72, 2.18 g of Aerosil™ 380 (fumed silica), 7.22 g of Atlox™ 4913, 48.39 g of propylene glycol, 28.89 g Trans-10A (Trans-Chemco, Inc., 10% active anti-foam silicone emulsion), 1.87 g of Proxel™ BD-20 (biocide, Industrial Microbiostat, 19.3% active biocide ingredient, Arch Chemicals Inc.) and 424.24 g of RO water were added to a container and mixed for ˜1 day with an overhead stirrer. After stirring, the mixture was distributed into 30 mL vials. To each of the vials were added stainless steel shots (20-30 mesh) to ˜⅓-½ of the volume of the vial. Each of the vials was secured to a vortex and shaken for 5 days. The sample was then ball-milled in batches according to the following procedure. To an 80 mL stainless steel milling jar (EQ-MJ-3-80SS, MTI Corporation, Richmond Calif., USA) was added ˜40-50 mL of the mixture as well as an approximately equivalent volume of 2 mm stainless steel shots (shots were added until they were just below the surface of the liquid). The jar was sealed and milled on a desk top high speed vibrating ball mill (MSK-SFM-3, MTI Corporation, Richmond Calif., USA) for 5 minutes, then cooled on an ice bath for ˜5 minutes. Three additional milling/cooling cycles were performed (total of 4 cycles). The milled formulation was filtered through a 150 μm sieve. Viscosity: 22.5 cP at 24.1° C.; assayed difenoconazole content: 17% (w/w); Z-ave particle size (at 200 ppm difenoconazole in CIPAC D water): 279 nm, polydispersity index: 0.26.

### Example 2

### Preparation of an HSLS Formulation of Nanoparticles or Aggregates of Nanoparticles of Polymer-Associated Difenoconazole via Ball-Milling [Nanoparticles Derived from p(MAA-co-S) poly(methacrylic acid-co-styrene); 3:1 Ratio of Difenoconazole:Nanoparticles] (“VCP-05”)

1321.9 g of technical grade difenoconazole (Pacific Agriscience, 95% purity), 130 g of Geropon T-77, 195 g of Geropon TA/72, 19.5 g of Aerosil® 380 (fumed silica), and 2586.5 g of RO water were added to a container, mixed, and placed in an ice bath under homogenization. The homogenizer was run at 6000 rpm. With the homogenizer running at the aforementioned speed, the following were added in sequence: 435.5 g of propylene glycol; a slurry containing 418.6 g of nanoparticles derived from poly(MAA-co-S) [MAA:S ratio=approximately 75:25 by weight]; 16.25 g of Proxel™ BD-20 (biocide, Industrial Microbiostat, 19.3% active biocide ingredient, Arch Chemicals Inc.); 26.0 g Trans-10A (Trans-Chemco, Inc., 10% active anti-foam silicone emulsion,); and 65 g of AtIox™ 4913. After the addition of these five components the homogenizer speed was increased to 8000 rpm, giving a tip speed of 2823 ft/min, The mixture was homogenized at this speed until the diameter of at least 99% of the particles (D(v, 0.9)) was less than 80 p.m as measured on a Mastersizer, and the average particle size was between 20-25 μm This was accomplished after 80 minutes of homogenization.

After homogenization was complete, the mixture was transferred to a Dyno-Mill (Model KDL). The mixture was milled at 3000 rpm, resulting in a tip speed of 2,000 ft./min. The mixture was milled with beads having a diameter between 0.6 and 0.8 mm made of cerium stabilized zirconium oxide. The temperature of the milling chamber was maintained at 40° C. or less. Milling was completed when the average particle size was less than 0.3 μm. This was achieved after 120 minutes of milling, when the average particle size measured 0.274 μm.

Samples were taken and evaluated for particle size, viscosity, density, and an HPLC assay of active ingredient content. The average particle size of the final formulation was 339 nm, an increase over the final measurement during mill due to possible post-milling aggregation of the polymer-associated active ingredient nanoparticles. The formulation had a density of 1.103 g/mL, a viscosity of 71.9 cP at 25.1 C, a pH of 5.92 and contained 20.4% active ingredient. This formulation is commonly referred to as VCP-05 in the Examples below and in the Figures.

### II: Formulation Testing

Several field trials were conducted to evaluate performance of difenoconazole formulations described in this disclosure, compare their performance to current commercially available formulations of difenoconazole (Inspire™), and compare their performance of commonly used fungicidal treatments for specific pest/crop applications. A variety of crops and diseases were tested, as described below.

### Example 3

### Treating Black Spot on Cabbage

Difenoconazole at three different application rates (75, 125 and 175 g a.i./ha) was applied to cabbage plants with Black Spot (pathogen: Alternaria brassicicola). Two formulations were tested: the first formulation was prepared according to Example 1, and the second was a commercially-available formulation (Inspire™). Both formulations were tank mixed with water and a 0.5 vol % of a non-ionic surfactant to the application rates for the trial. The non-ionic surfactant selected was Induce™ (alkylarylpolyoxyalkane ethers, fatty acids and dimethyl polysiloxane). Disease development was evaluated 4 days after a second treatment, 5, 19, and 33 days after a third treatment. Both formulations demonstrated control across the range of application rates. Rates of disease control (averaged across the three application rates) are illustrated in FIG. 1, though disease incidence among the untreated controls was low and the severity of infection of the untreated control as low as well.

### Example 4

### Treating Powdery Mildew on Cucurbit (Cantaloupes, Squash)

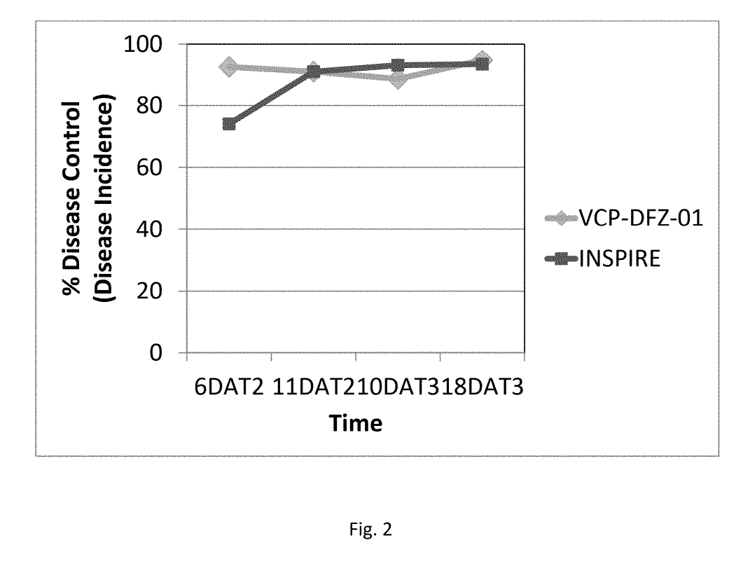

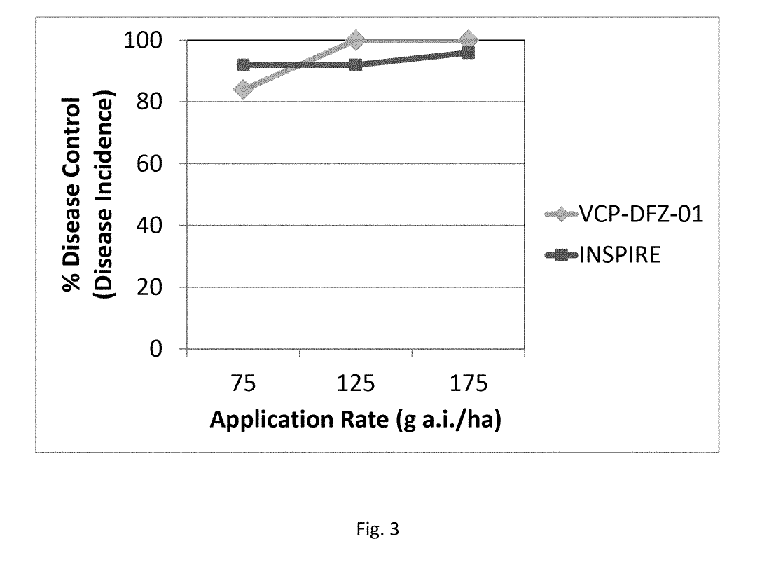

Difenoconazole at three different application rates (75, 125 and 175 g a.i./ha) was applied to cantaloupe plants with powdery mildew (pathogen: Golovinomyces cichoracearum). Two formulations were tested: the first formulation was prepared according to Example 1 and the second was a commercially-available formulation (Inspire™). Both formulations were tank mixed with water and a 0.1 vol % of a non-ionic surfactant to the application rates for the trial. The non-ionic surfactant selected was Dyne-Amic™ (methyl esters of C16-C18 fatty acids, polyalkyleneoxide modified polydimethylsiloxane, alkylphenol ethoxylate). Disease development was evaluated 6 and 11 days after a second treatment, 10 and 18 days after a third treatment. Both formulations demonstrated control across the range of application rates. Rates of disease control are illustrated in FIG. 2 (control rates averaged across the three application rates) and FIG. 3 (control rates 18 days after third treatment for three application rates).

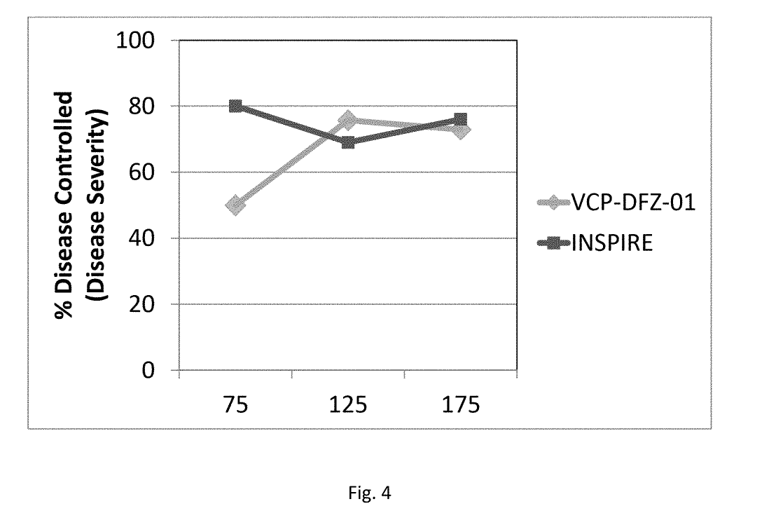

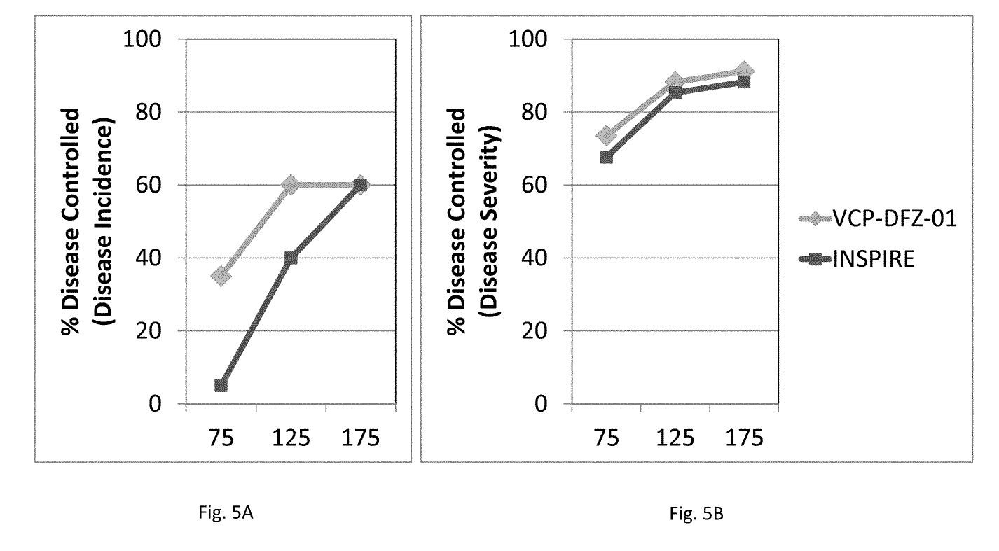

Difenoconazole at three different application rates (75, 125 and 175 g a.i./ha) was applied to squash plants with powdery mildew (pathogen: Podosphaera xanthii). Two formulations were tested, the first formulation was prepared according to Example 1 and a commercially-available formulation (Inspire™). Both formulations were tank mixed with water and a 0.25 vol % of a non-ionic surfactant to the application rates for the trial. The non-ionic surfactant selected was Dyne-Amic™. Disease development was evaluated 14 days after a second treatment. Rates of disease control 14 days after treatment are illustrated in FIG. 4. FIG. 5A and FIG. 5B shows rates of control (incidence in FIG. 5A and severity FIG. 5B) at an earlier evaluation time, 12 days after second application.

### Example 5

### Treating Early and Late Leaf Spots on Peanut Plants

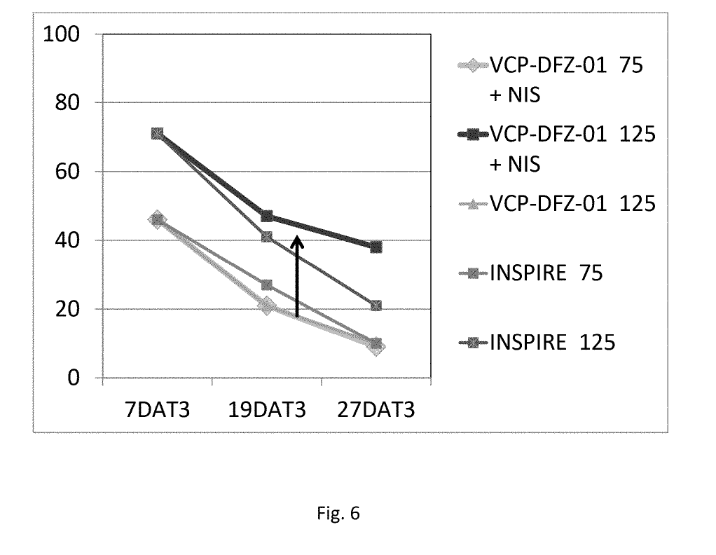

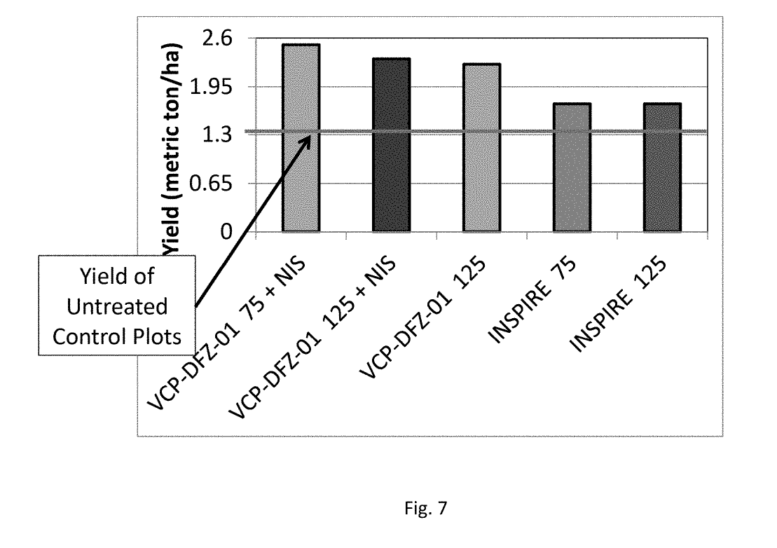

Difenoconazole at three different application rates (75, 125 and 175 g a.i./ha) was applied to peanuts with Peanut Leaf Spot (pathogen: Pseudocercospora personata). Two formulations were tested: the first formulation was prepared according to Example 1, and the second was a commercially-available formulation (Inspire™). Both formulations were tank mixed with water and a 1.0 vol % of a non-ionic surfactant to the application rates for the trial. The non-ionic surfactant selected was Scanner™(3-oxapentane-1,5-diol, propane-1,2,3-triol, alkylphenol ethoxylate, polydimethylsiloxane) Disease development was evaluated 7, 19 and 27 days after three treatments. Both formulations demonstrated reduction in defoliation and enhancement based on the use of the non-ionic surfactant. See FIG. 6. Untreated controls rates of defoliation of: 69%, 7 days after treatment; 95%, 19 days after treatment; and 100%, 27 days after treatment. Efficacy was also measured by yield rates (FIG. 7). Formulations prepared according to Example 1 showed improved reduction in defoliation and improved yield rates as compared to the commercially available formulation.

### Example 6

### Treating Frog-Eye Spot/Cercospora Leaf Spot on Soybeans

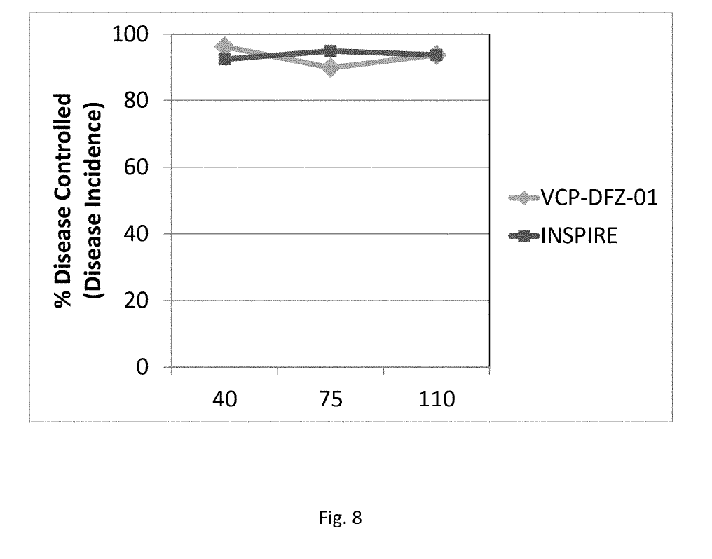

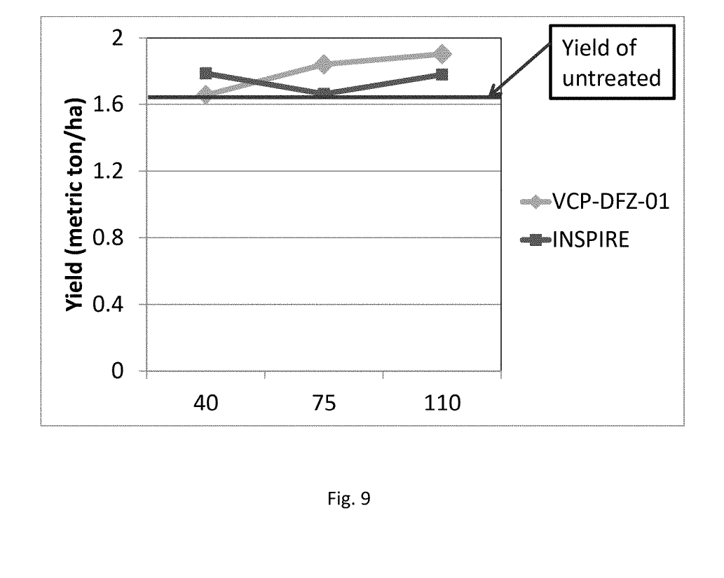

Difenoconazole at three different application rates (75, 125 and 175 g a.i./ha) was applied to soybeans with two foliar cercosporas, Frog-Eye Leaf Spot and Leaf Spot (pathogens: Cercospora sojina and Cercospora kikuchii, respectively). Two formulations were tested: the first formulation was prepared according to Example 1 and the second was a commercially-available formulation (Inspire™). Both formulations were tank mixed with water and a 1.0 vol % of a non-ionic surfactant to the application rates for the trial. The non-ionic surfactant selected was Induce™. Disease development was evaluated 14 days after treatment. Both formulations demonstrated control across the range of application rates. Efficacy was measured in several ways, including rates of disease control (FIG. 8) 14 days after application and yield rates (FIG. 9). Rates of disease control indicated equivalent control between commercially available formulations and formulations prepared according to Example 1.

### Example 7

### Treating Early Blight on Tomatoes

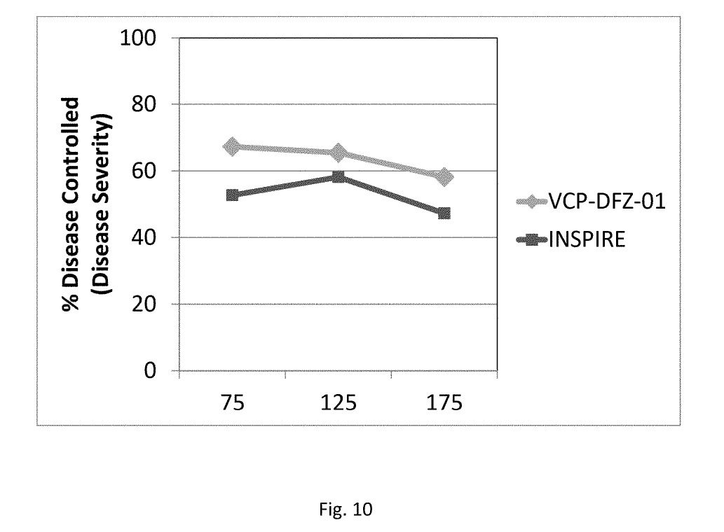

Difenoconazole at three different application rates (75, 125 and 175 g a.i./ha) was applied to tomatoes with Early Blight (pathogen: Alternaria tomatophila). Two formulations were tested: the first formulation was prepared according to Example 1 and the second was a commercially-available formulation (Inspire™). Both formulations were tank mixed with water and a 1.0 vol % of a non-ionic surfactant to the application rates for the trial. The non-ionic surfactant selected was First Choice™ Spreader Sticker (alkylarylpolyoxyethylene oxides) Disease development was evaluated 6 days after treatment. Both formulations demonstrated control across the range of application rates. Rates of disease control are illustrated in FIG. 10.

### Example 8

### Second Field Trial Treating Powdery Mildew on Cucurbit (Zucchini)

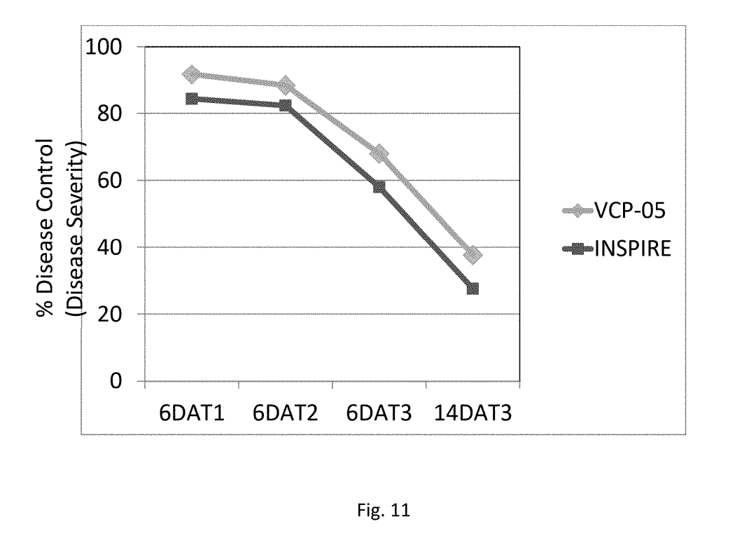

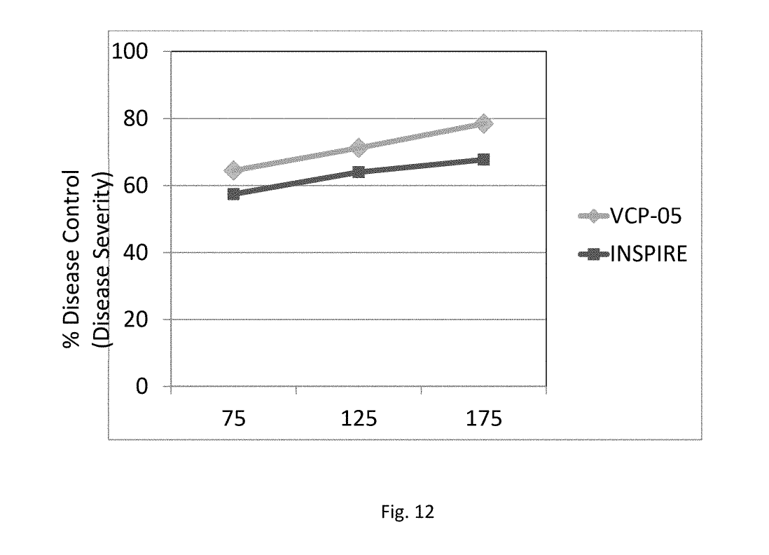

Difenoconazole at three different application rates (75, 125 and 175 g a.i./ha) was applied to zucchini plants with powdery mildew (pathogen: Golovinomyces cichoracearum). Two formulations were tested: the first formulation was prepared according to Example 2 and the second was a commercially-available emulsifiable concentrate formulation (Inspire™). Both formulations were tank mixed with water and a 0.5 vol % of a non-ionic surfactant to the application rates for the trial. The non-ionic surfactant selected was Dyne-Amic™. Disease development was evaluated 6 days after the first, second and third treatments, and 14 days after a third treatment. Both formulations demonstrated control across the range of application rates. Rates of disease control are illustrated in FIG. 11 (control rates averaged across the three application rates) and FIG. 12 (control rates during the trial with the three application rates averages). Disease severity for the untreated controls was 50% at 6 days after first treatment, and reached 100%, 6 days after the second treatment. Disease severity for the untreated controls did not decrease from 100% at the evaluation time points (6 days after the third treatment and 14 days after the third treatment).

### Example 9

### Treating Sigatoka Leaf Spot on Bananas

Difenoconazole at three different application rates (250, 417 and 667 ppm) was applied to banana plants with Sigatoka Leaf Spot (pathogens: Mycosphaerella musicol/Cercospora musae). Three formulations were tested: the first formulation was prepared according to Example 2; the second was a commercially-available emulsifiable concentrate formulation (Syngenta EC); and the third a proprietary oil in water (“EW”) formulation. All three formulations were tank mixed with water to the proper dilution (10 grams of active ingredient in 15 liters of water) with no other adjuvant or additive. Each plant in a test plot received 0.5 L of diluted fungicide formulation per treatment. Each plot contained 30 plants.

Disease development was evaluated 7 days after each of three treatments which were each applied 7 days apart. For the evaluation, disease index was calculated on the following basis: 0% indicates no disease present; 100 indicates 51% of the tested leaf surface was covered with the pest (Mycosphaerella musicol/Cercospora musae). Percent disease control was calculated based on the disease index of the untreated control at the specific time point in the treatment regimen, at the end of the treatment in this case. Zero percent disease control indicates that the test being evaluated demonstrated an equivalent disease index as the untreated control, while 100 percent disease control indicates that the pest was substantially eradicated from the leaf surface.

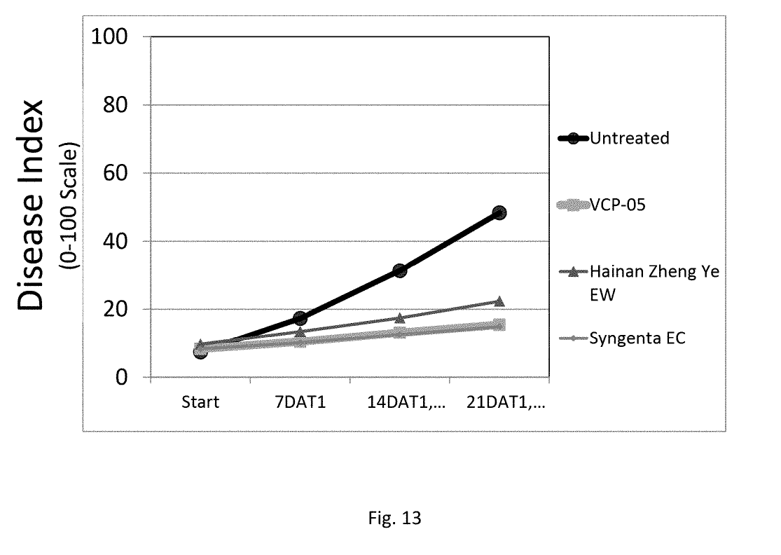

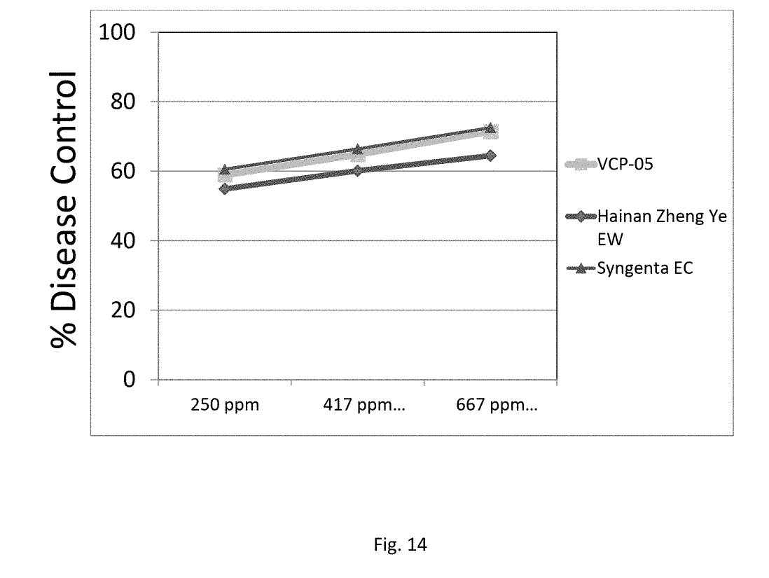

All three formulations demonstrated control across the range of application rates. Disease index, as described above, for the different formulations applied at a concentration of 667ppm is shown in FIG. 13. Final disease control assessment is shown for each formulation at different application rates 14 days after the first treatment in FIG. 14. Disease control for the untreated control, which serves as the basis for disease index and disease control calculations, is also shown in FIG. 13. The formulation prepared according to Example 2 exhibited disease control equivalent to the commercial emulsifiable concentrate formation and superior to the oil-in-water emulsion formulation.

### Example 10

### Treating Peanut Leaf Spot on Peanuts

Difenoconazole at two different application rates (75, and 125 g a.i./ha) was applied to peanuts with Peanut Leaf Spot (pathogens: Cercospora arachidicola, Mycosphaerella berkeleyi). Two formulations were tested at these application rates. The first formulation was prepared according to Example 2 and the second was a commercially-available emulsifiable concentrate formulation (Inspire™). A third formulation was also tested. The third formulation used a different triazole active ingredient, tebuconazole (Muscle™) at an application rate of 227 g a.i./ha. The formulations prepared according to Example 2 were tank mixed with water and a 0.25 vol % of a non-ionic surfactant to the application rates for the trial. The non-ionic surfactant selected was Induce™. The other formulations were tank-mixed with water to the final application concentration. The non-ionic surfactant was eliminated because the two commercial formulations were emulsifiable concentrates, which generally demonstrate increased plant phytotoxicity when mixed with additional surfactants.

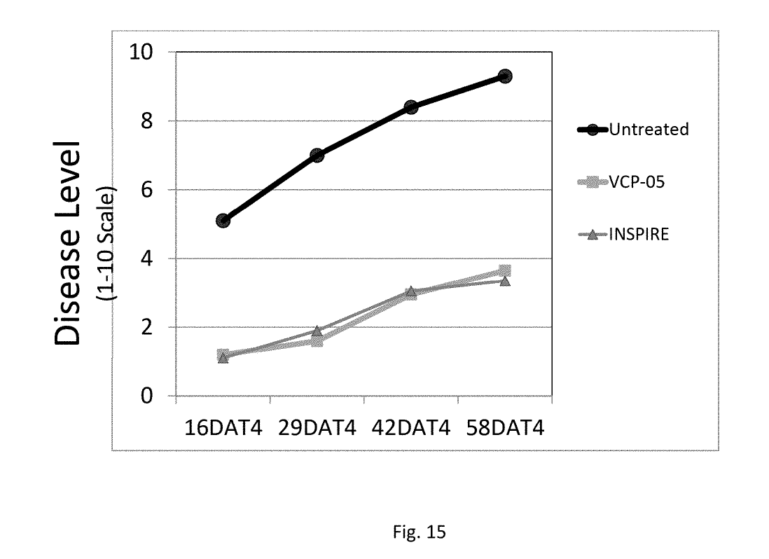

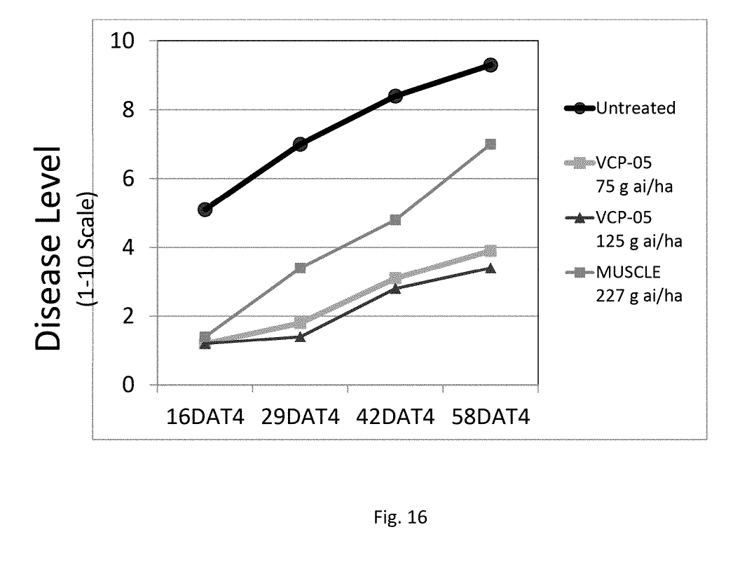

Disease development was evaluated 16, 29, 42, and 58 days after four treatments. Disease was evaluated on a scale of 1-10, where 1 indicates no disease, a score of 4 indicates noticeable defoliation and 10 indicates over 80% defoliation. Both difenoconazole formulations demonstrated reduction in defoliation and enhancement (averaged across application rates). See FIG. 15. The difenoconazole formulation prepared according to Example 2 exhibited superior disease control, even at lower application rates, see FIG. 16. Untreated controls demonstrated defoliation rates of over 80% at the end of the trial, 42 days after the fourth treatment.

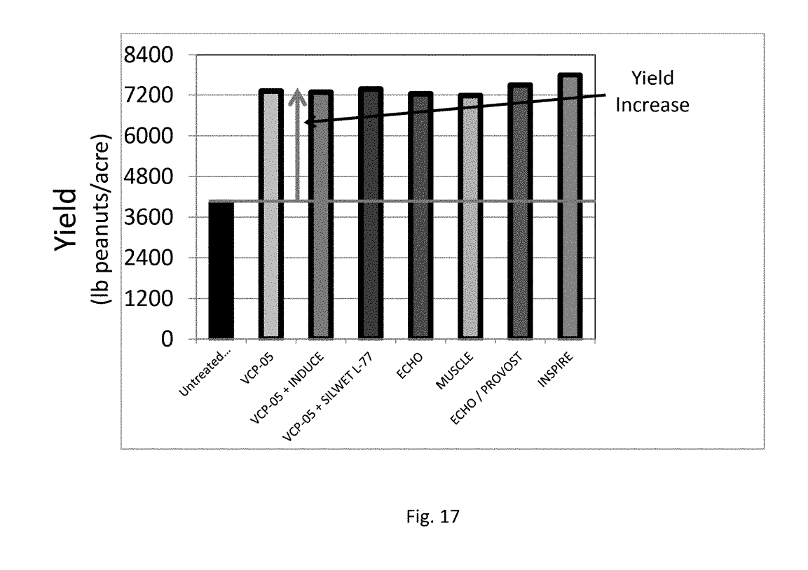

Efficacy was also measured by yield rates (FIG. 17). Formulations prepared according to Example 2 showed improved reduction in defoliation and improved yield rates as compared to the commercially available formulation. For comparison of yield, additional fungicide formulations were used in comparison (Echo™ (chlorothalonil), Echo™/Provost™ (chlorothalonil/prothioconazole) as well as an additional non-ionic-surfactant with the formulation of Example 2.

### Example 11

### Treating White Mold on Peanuts

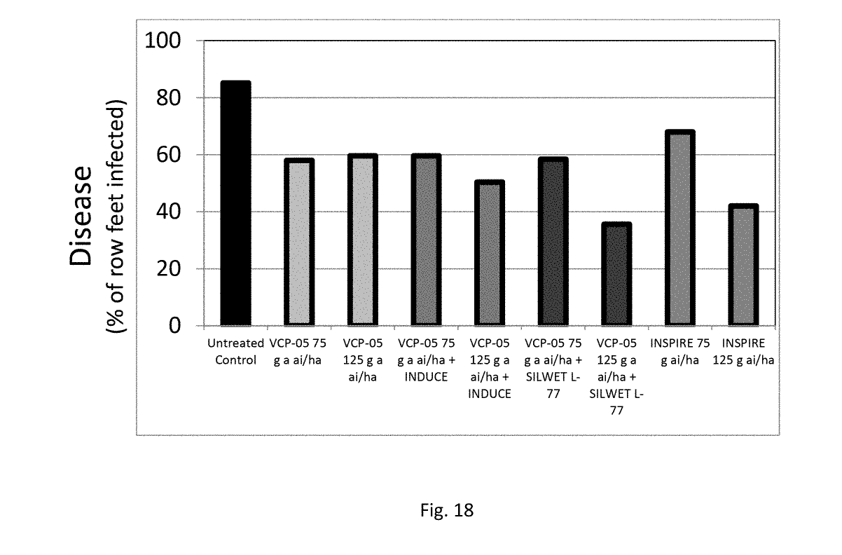

Difenoconazole at two different application rates (75, and 125 g a.i./ha) was applied to peanuts with White Mold (pathogen: Athelia rolfsii). Two formulations were tested, the first formulation was prepared according to Example 2 (“VCP-05”) and the second was a commercially available emulsifiable concentrate formulation (Inspire™). The formulation prepared according to Example 2 was tank mixed with water and/or one of two non-ionic surfactants (1.0 vol % of non-ionic surfactant) to the application rates for the trial. The non-ionic surfactant selected was Induce™or Silwet-L77™(trisiloxane ethoxylate). Inspire™ has increased phytotoxicity when mixed with a non-ionic-surfactant, and was only tank-mixed with water. Four replicates for each formulation were performed, each contained two 32 foot long rows. Disease development was evaluated at the end of the field trial. Disease control is calculated based on the percent of crop row feet infected with the pathogen. All formulations demonstrated reduction in infection under heavy disease pressure, see FIG. 18. Untreated controls demonstrated a rate of infection over 80%.

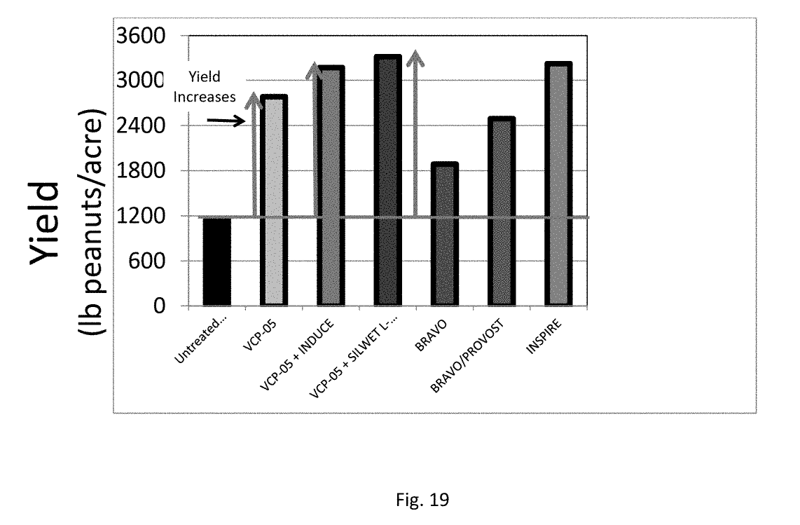

Efficacy was also measured by yield rates (see FIG. 19). Formulations prepared according to Example 2 showed improved reduction in defoliation and improved yield rates as compared to the commercially available formulation. For comparison of yield rates, additional formulations were used in comparison (Bravo™(chlorothalonil), Bravo™/Provost™(chlorothalonil/prothioconazole)) as well as an additional non-ionic-surfactant with the formulation of Example 2.

### Example 12

### Treating Dollar Spot on Creeping Bentgrass

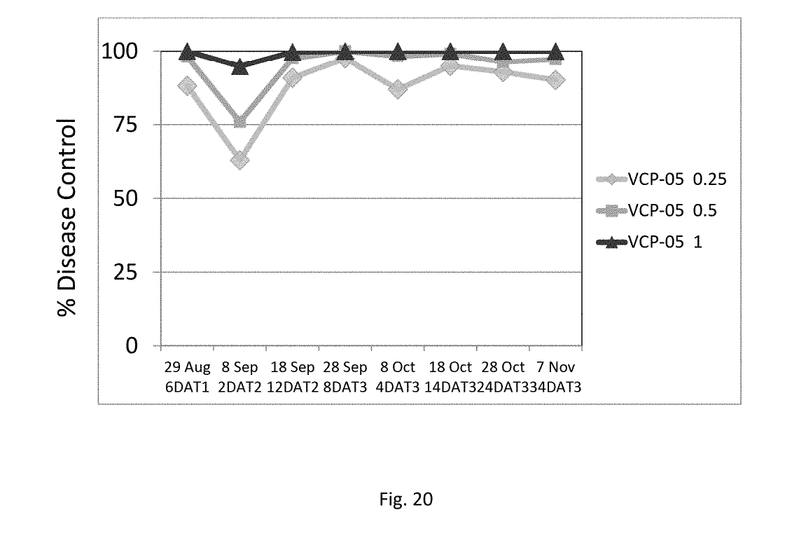

Difenoconazole at three different application rates (0.25, 0.5, and 1 fluid oz. of formulation applied per 1000 square feet of treatment area) was applied to treat dollar spot (pathogen: Sclerotinia homoeocarpa) on creeping bentgrass. The difenoconazole formulation was prepared according to Example 2. Each formulation was tank-mixed with water and a non-ionic surfactant, Pulse™(polyether modified polysiloxane) to give the proper concentration of difenoconazole for the application rate and 0.5 vol % of the non-ionic surfactant. The tank-mix solution was applied to four replicates, each a 3′ by 5′ plot. Applications of difenoconazole were repeated every 14 days and the disease control rate was evaluated at several intervals (6 days after treatment 1, 2 days after treatment 2, 12 days after treatment 2, 8 days after treatment 3, 4, 14, 24 and 34 days after treatment 4). Lesions in untreated controls were evaluated at the same times. Disease control rates are shown in FIG. 20.

Disease control rates were calculated based on the number of lesions present on untreated control plots. Zero percent control indicates an equivalent number of lesions in a particular test plot as compared to the untreated control plot. Table 3 below shows the number of lesions (i.e., disease severity) for untreated controls used as the basis for the disease control rate calculations.

TABLE 3

| Evaluation Time (Days after Treatment) | Number of Lesions |
|---|---|
| 6 days after treatment 1 | 66 |
| 2 days after treatment 2 | 82 |
| 12 days after treatment 2 | 113 |
| 8 days after treatment 3 | 59 |
| 4 days after treatment 4 | 134 |
| 14 days after treatment 4 | 215 |
| 24 days after treatment 4 | 223 |
| 34 days after treatment 4 | 222 |

### Example 13

### Additional Comparison of Mixed Fungicides (Difenoconazole/Azoxystrobin) Formulations in Treating Dollar Spot on Creeping Bentgrass

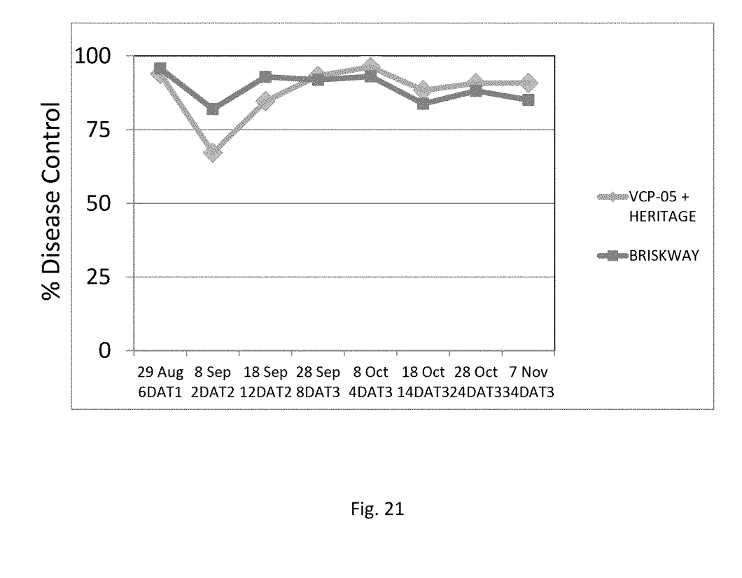

As part of the same applications to treat dollar spot in creeping bentgrass, the formulation according to Example 2 was mixed with Heritage™, a commercially available formulation of the fungicide azoxystrobin. This mixture was prepared to compare its agrochemical performance to the Briskway™ formulation, which is a commercially available formulation of the combination of difenoconazole and azoxystrobin. The difenoconazole formulation of Example 2 was applied at a rate of 0.2 fl. Oz. per 1000 sq. ft., and mixed with Heritage™ so that the Heritage™ product was applied at a rate of 0.6 fl. Oz. per 1000 sq. ft. Briskway™ was applied at a rate of 0.3 fl. Oz per 1000 sq. ft. The rates were selected so that the same amount of active ingredient for each fungicide was applied to the treatment area. As shown in FIG. 21, the two formulations provided similar rates of disease control, which were, in turn comparable to the control rates shown in FIG. 20 and Example 11.

### Example 14

### Treating Anthracnose on Annual Bluegrass

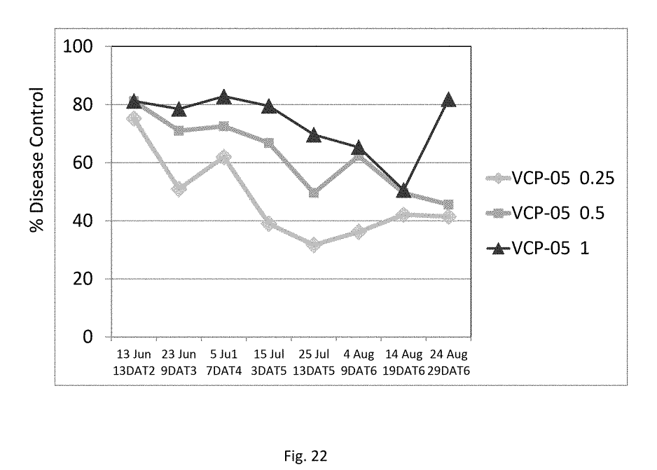

Difenoconazole at three different application rates (0.25, 0.5, and 1 fluid oz. of formulation applied per 1000 square feet of treatment area) was applied to treat anthracnose (pathogen: Colletotrichum cerealis) on annual bluegrass. The difenoconazole formulation was prepared according to Example 2. Each formulation was tank-mixed with a non-ionic surfactant, Pulse™. Applications of difenoconazole were repeated every 14 days and the disease control rate was evaluated at several intervals (13 days after treatment 2, 9 days after treatment 3, 7 days after treatment 4, and 3 days after treatment 5). Disease control rates are shown in FIG. 22.

### III: Additional Formulations

### Example 15

### Preparation of a Solid Formulation of Nanoparticles or Aggregates of Nanoparticles of Polymer-Associated Difenoconazole via Spray Drying from a Common Solvent (2:1 Ratio of Difenoconazole:Nanoparticles)

8 g of difenoconazole and 4 g of nanoparticles derived from p(MAA-co-BUMA) [ratio of MAA:BUMA=approximately 75:25 by weight] were dissolved in 80 mL of methanol and spray dried on a Yamato ADL-311S spray dryer equipped with a GAS-410 organic solvent recovery unit. Outlet temp: ˜96° C.; Inlet temp.: ˜155° C.; feed rate 17.5 mL/min; atomizing air: 0.05 MPa.

A similar procedure was used to prepare a solid formulation (2:1 ratio of difenoconazole:nanoparticles) from nanoparticles derived from poly(MAA-co-S) [ratio of MAA:S=approximately 75:25].

### Example 16

### Preparation of a HSLS Formulation from a Solid Formulation of Nanoparticles or Aggregates of Nanoparticles of Polymer-Associated Difenoconazole via Ball-Milling [Nanoparticles Derived from p(MAA-co-BUMA); 2:1 Ratio of Difenoconazole:Nanoparticles]

1.2 g of the solid formulation described in Example 15, 0.053 g of Geropon® T-77, 0.267 g of Geropon® TA/72, 0.053 g of Aerosil® 380 (fumed silica), 0.357 g of propylene glycol, 0.213 g of Trans-10A (Trans-Chemco, Inc., 10% active anti-foam silicone emulsion), 0.014 g of Proxel™BD-20 (biocide, Industrial Microbiostat, 19.3% active biocide ingredient, Arch Chemicals Inc.) and 3.176 g of RO water were added to a vial along with stainless steel shots (20-30 mesh) in an amount corresponding to about ½ of the volume of the liquid. The vial was secured to a vortex and shaken for ˜3 days. When the resulting formulation was dispersed in RO water at 200 ppm difenoconazole, the Z-ave particle size was 772 nm with a polydispersity of 0.24.

### Example 17

### Preparation of a HSLS Formulation of Nanoparticles or Aggregates of Nanoparticles of Polymer-Associated Difenoconazole via Ball-Milling [Nanoparticles Derived from p(MAA-co-BUMA) poly(methacrylic acid-co-butyl methacrylate; 2:1 Ratio of Difenoconazole: Nanoparticles]

0.267 g of Geropon® T-77, 1.33 g of Geropon® TA/72, 0.267 g of Aerosil ® 380 (fumed silica), 1.79 g of propylene glycol, 1.07 g of Trans-10A (Trans-Chemco, Inc., 10% active anti-foam silicone emulsion), 0.069 g of Proxel™ BD-20 (biocide, Industrial Microbiostat, 19.3% active biocide ingredient, Arch Chemicals Inc.) and 15.89 g of RO water were added to a vial and mixed (pH 9). The pH of was adjusted to 6.15 via the addition of about 0.3 mL of 4 M H₂SO₄ and the resulting liquid was mixed with 4.0 g of difenoconazole (technical grade) and 2.0 g of nanoparticles derived from p(MAA-co-BUMA) [ratio of MAA:BUMA=approximately 75:25 by weight. To a stainless steel milling jar (EQ-MJ-3-80SS, MTI Corporation, Richmond Calif., USA) were added the resulting mixture and 2 mm stainless steel shots (shots were added until they were just below the surface of the liquid). The jar was sealed and milled on a desk top high speed vibrating ball mill (MSK-SFM-3, MTI Corporation, Richmond Calif., USA) for 6 minutes, then cooled on an ice bath for 5 minutes. Three additional milling/cooling cycles were performed (total of 4 cycles).

When the formulation was dispersed in RO water at 200 ppm difenoconazole, the Z-ave particle size was found to be 484 nm with a polydispersity of 0.47. The formulation was stable upon heating at 45° C. or 54° C. for four days, as well after four temperature cycles between -10° C. and 45° C. in a cycling chamber.

### Example 18

### Preparation of a HSLS Formulation of Nanoparticles or Aggregates of Nanoparticles of Polymer-Associated Difenoconazole via Ball-Milling [Nanoparticles Serived from p(MAA-co-EA); 5:1 ratio of difenoconazole:nanoparticles]

1.0 g of difenoconazole (technical grade), 0.20 g of nanoparticles derived from p(MAA-co-EA) [ratio of MAA:EA=approximately 75:25 by weight], 0.15 g of Morwet® D-425, 0.025 g of Aerosil ® 380 (fumed silica), 0.335 g of propylene glycol, 0.20 g of Trans-10A (Trans-Chemco, Inc., 10% active anti-foam silicone emulsion), 0.013 g of Proxel™ BD-20 (biocide, Industrial Microbiostat, 19.3% active biocide ingredient, Arch Chemicals Inc.) and 2.98 g of RO water were added to a glass vial along with stainless steel shots (20-30 mesh) in an amount corresponding to about ½ of the volume of the mixture. The vial was secured to a vortex and shaken for about 3 days. When the resulting formulation was dispersed in RO water at 200 ppm difenoconazole, the Z-ave particle size was 528 nm with a polydispersity of 0.3. 5 mg of Xanthan gum (0.10 g of a 5% aqueous Xanthan gum solution prepared form Kelzan® M, CP Kelco U.S., Inc) was added to the formulation, which was then secured to a vortex and shaken for about 4 hours.

### Example 19

### Preparation of a HSLS Formulation of Nanoparticles or Aggregates of Nanoparticles of Polymer-Associated Azoxystrobin/Difenoconazole (1.6 ratio) via Ball Milling [Nanoparticles Derived from (PMAA-co-S; 75:25) Slurry]

4.92 g of technical grade azoxystrobin (Pacific Agrosciences), 3.08 g technical grade difenoconazole (Pacific Agriscience, 95% purity), 10.88 g of a slurry containing 14.7 wt % nanoparticles derived from poly(MAA-co-S) [MAA:S ratio=approximately 75:25 by weight] in water, 0.40 g Geropon T-77, 2.0 g Geropon TA/72, 0.40 g Atlox 4913, 2.68 g propylene glycol, 0.16 g Trans-10A solution, 0.02g Proxel™ BD-20 solution and 15.46 g deionized water were all placed in an 80 mL glass beaker and were mixed overnight with an overhead paddle stirrer at 300-500 rpm for approximately 18 hours. This mixture was then placed in a stainless steel milling jar along with stainless steel milling balls (assorted sizes, 2 mm-6 mm) and was milled for 6 minutes, and then cooled in an ice bath. This process was repeated 2 more times. The resulting composition was then filtered through a 100 mesh sieve. The filtered sample was then divided into 2 separate 30 mL vials that contained about 5-10 g of 0.6 mm stainless steel milling beads. The vials were sealed and were shaken on a vortex shaker (400 rpm) for 72 hours. The final formulation had the following properties: viscosity: 121 cP at 23.7° C.; assayed difenoconazole content: 12.7% (w/w), assayed azoxystrobin content: 7.8 (w/w); Z-ave particle size (undiluted): 248 nm by Malvern Mastersizer.

### Example 20

### Preparation of a HSLS Formulation of Nanoparticles or Aggregates of Nanoparticles of Polymer-Associated Azoxystrobin/Difenoconazole (1.6 Ratio) via Ball Milling [Nanoparticles Derived from (PMAA-co-S; 75:25) Concentrated Slurry]

4.92 g of technical grade azoxystrobin, 3.08 g technical grade difenoconazole, 5.56 g of a slurry containing 28.8 wt % nanoparticles derived from poly(MAA-co-S) [MAA:S ratio=approximately 75:25 by weight] in water, 0.40 g Geropon T-77, 2.0 g Geropon TA/72, 2.68 g propylene glycol, 0.16 g Trans-10A solution, 0.02 g Proxel™ BD-20 solution, and 21.18 g deionized water were all placed in an 80 mL glass beaker and were mixed overnight with an overhead paddle stirrer at 300-500 rpm for approximately 18 hours. This mixture was them placed in a stainless steel milling jar along with stainless steel milling balls (assorted sizes, 2 mm-6 mm) and was milled for 6 minutes, and then cooled in an ice bath. This process was repeated 2 more times. The resulting composition was then filtered through a 100 mesh sieve. The filtered sample was then divided into 2 separate 30 mL vials that contained about 5-10 g of 0.6 mm stainless steel milling beads. The vials were sealed and were shaken on a vortex shaker (400 rpm) for 72 hours. The final formulation had the following properties: assayed difenoconazole content: 13.2% (w/w), assayed azoxystrobin content: 7.9% (w/w); Z-ave particle size (undiluted): 403 nm by Malvern Mastersizer.

### Example 21

### Preparation of a HSLS Formulation of Nanoparticles or Aggregates of Nanoparticles of Polymer-Associated Azoxystrobin/Difenoconazole (1.24 Ratio) via Mixing Separate Formulations [Nanoparticles Derived from (PMAA-co-S; 75:25) Slurry]

A 15.3 wt % difenoconazole formulation was made according to Example 2. Similarly, a 19.1 wt % azoxystrobin formulation was prepared by milling: 87.6 g of azoxystrobin technical (Pacific Agrosciences), 96.7 g of a slurry containing 29.3 wt % nanoparticles derived from poly(MAA-co-S) [MAA:S ratio=approximately 75:25 by weight] in water, 15.0 g of Geropon T-77, 10.0 g of Geropon TA/72, 5.0 g Atlox 4913, 32 mL propylene glycol, 20 mL Trans 10-A antifoam solution, 1 mL Proxel™BD-10 solution and 230.6 mL of water. The mixture was homogenized for 45 min at 70,000 rpm, then milled on an Eiger mill for 135 minutes at 4000 rpm. The final azoxystrobin formulation had an average particle size of 314.6 nm (diluted to 200 ppm in CIPAC D water). The polydispersity index was 0.299. The assayed azoxystrobin content was 18.1% (w/w) and the viscosity was 229.5 cPs at 25.3 C. 25.02 g of the azoxystrobin formulation described above, and 19.54 g of the difenoconazole formulation described above were placed in a 50 mL Nalgene bottle. The bottle was capped and shaken on a vortex shaker at low setting for 12 hours. The mixed formulation had an azoxystrobin-difenoconazole ratio of 1.24.

### Example 22

### Preparation of an HSLS Formulation of Nanoparticles or Aggregates of Nanoparticles of Polymer-Associated Tebuconazole via Ball-Milling [Nanoparticles Derived from p(MAA-co-S) poly(methacrylic acid-co-styrene); 3:1 Ratio of Tebuconazole:nanoparticles]

8.358 g of technical grade tebuconazole, 18.27 g of a slurry containing 14.7 wt % nanoparticles derived from poly(MAA-co-S) [MAA:S ratio=approximately 75:25 by weight] in water, 1.24 g of Geropon TA/72, 0.8167 g of Geropon T-77, 0.4803 g of Atlox 4913, 0.2331 g of Aerosil™ 380, 2.68 g of propylene glycol, 1.7301 g of Trans-10A solution, 0.0989 g of Proxel™ BD-20 solution and 6.7386 g deionized water were all placed in a stainless steel milling jar along with ceria coated milling balls (assorted sizes, 0.6-0.8 mm. The jar was sealed and was shaken for 5 minutes by hand, followed by milling for 5 minutes, and then cooled in an ice bath. The milling and cooling steps were each repeated 5 more times. The resulting composition was then filtered through a 100 mesh sieve.

### Example 23

### Preparation of a HSLS Formulation of Nanoparticles or Aggregates of Nanoparticles of Polymer-Associated Azoxystrobin/Tebuconazole (1:1 Ratio) via Ball Milling [Nanoparticles Derived from (PMAA-co-S; 75:25) Slurry]

4.1431 g of technical grade tebuconazole, 4.1364 g technical grade azoxystrobin, 18.1961 g of a slurry containing 14.7 wt % nanoparticles derived from poly(MAA-co-S) [MAA:S ratio=approximately 75:25 by weight] in water, 1.196 g of Geropon TA/72, 0.8042 g of Geropon T-77, 0.2109 g of Aerosil 380, 2.6299 g of propylene glycol, 0.7973 g of Trans-10A, 0.1073 g of Proxel BD20 and 16.153 g of deionized water were all placed in a stainless steel milling jar along with ceria coated milling balls (assorted sizes, 0.6-0.8 mm). The jar was sealed and was shaken for 5 minutes by hand, followed by milling for 5 minutes, and then cooled in an ice bath. The milling and cooling steps were each repeated 5 more times. The resulting composition was then filtered through a 100 mesh sieve.

### Example 24

### Preparation of a HSLS Formulation of Nanoparticles or Aggregates of Nanoparticles of Polymer-Associated Azoxystrobin/Tebuconazole (1:1 Ratio) via Ball Milling [Nanoparticles Derived from (PMAA-co-S; 75:25) Slurry]

4.1328 g of technical grade tebuconazole, 4.122 g technical grade azoxystrobin, 18.1634 g of a slurry containing 14.7 wt % nanoparticles derived from poly(MAA-co-S) [MAA:S ratio=approximately 75:25 by weight] in water, 1.19966 g of Geropon TA/72, 2.0122 g of Calsoft AOS-40, 0.2115 g of Aerosil 380, 2.6622 g of propylene glycol, 0.8077 g of Trans-10A, 0.1031 g of Proxel™ BD-20 and 14.9119 g of deionized water were all placed in a stainless steel milling jar along with ceria coated milling balls (assorted sizes, 0.6-0.8 mm). The jar was sealed and was shaken for 5 minutes by hand, followed by milling for 5 minutes, and then cooled in an ice bath. The milling and cooling steps were each repeated 5 more times. The resulting composition was then filtered through a 100 mesh sieve.

1-74. (canceled)

75. A formulation comprising:
a nanoparticle comprising a polymer-associated triazole compound with an average diameter of between about 1 nm and about 500 nm; wherein the polymer is a polyelectrolyte;
between about 0.5 weight percent and about 5 weight percent of a dispersant selected from a taurate or a naphthalene sulfonate condensate;
between about 0.5 weight percent and about 5 weight percent of a wetting agent selected from a polycarboxylate salt and a sodium dodecylbenzene sulfonate;
between about 0.1 weight percent and about 1 weight percent of an anti-foaming agent;
between about 0.01 weight percent and about 0.2 weight percent of a preservative; and
water.

76. The formulation of claim 75, wherein the triazole compound comprises between about 5 and about 30 percent by weight of the formulation.

77. The formulation of claim 75, wherein the ratio of the weight percent of the triazole compound to the weight percent of the nanoparticles is between about 1:1 to 6:1.

78. The formulation of claim 75 further comprising between about 0.1 weight percent to about 5 weight percent of a thickener selected from the group consisting of hydrophobic silica, fumed silica and combinations thereof.

79. The formulation of claim 75 further comprising between about 5 weight percent to about 10 weight percent of an anti-freeze agent.

80-82. (canceled)

83. The formulation of claim 75 further comprising a fungicide.

84. The formulation of claim 83, wherein the fungicide is a strobilurin.

85. The formulation of claim 75, where the polyelectrolyte polymer is a poly(methacrylic acid-co-ethyl acrylate) polymer.

86-93. (canceled)

94. The formulation of claim 75 further comprising an additional pesticide which comprises between about 5 weight percent and about 30 weight percent of the formulation.

95. The formulation of claim 75 further comprising between about 0.1 weight percent to about 6 weight percent of a alkyl polyglucoside non-ionic surfactant.

96. The formulation of claim 75 further comprising a liquid fertilizer.

97. The formulation of claim 75, wherein the triazole compound is selected from the group consisting of azaconazole, bromuconazole, cyproconazole, diclobutrazol, difenoconazole, diniconazole, epoxiconazole, etaconazole, fenbuconazole, fluquinconazole, flusilazole, flutriafol, furconazole, hexaconazole, imibenconazole, ipconazole, metconazole, myclobutanil, penconazole, propiconazole, prothioconazole, quinconazole, simeconazole, tebuconazole, tetraconazole, triadimenfon, triadimenol, triticonazole, uniconazole, and combinations thereof
